(19) United States
(12) Patent Application Publication
(10) Pub. No.: US 2002/0194505 A1
(43) Pub. Date: Dec. 19, 2002

(54) Invisible services

(76) Inventor: Hans-Joachim Muschenborn, Walchwil (CH)

Correspondence Address: DR. HANS-GOACHIM MUSCHENBORN, BUNDESSTR. 7, CH-6304 ZUG, SWITZERLAND, CH-6304, CH

(21) Appl. No.: 10/161,722

(22) Filed: Jun. 5, 2002

(30) Foreign Application Priority Data
Jun. 18, 2001 (DE) 101 29 295.3
Aug. 1, 2001 (DE) 101 37 693.6

(51) Int. Cl. H04L 9/00

(52) U.S. Cl. 713/201

(57) ABSTRACT

The presented inventions concern communication systems with services. The services provided by the presented systems are invisible to port scans, allowing security critical data to be stored on units without any permanently open connection endpoints. Existing network systems according to the client/server-principle require the permanent provision of open connection endpoints to be accessible on a 24h base. The large number of services implies a large number of open connection endpoints, where each open connection endpoint presents a potential point-of-attack for malicious clients. The object of the present invention is to securely provide services in communication systems. The present invention overcomes the prior art by triggerable invisible services, which during normal operation do not provide any permanently open connection endpoint. Connection endpoints are only opened after prior client authentication and authorization validated by an independent logon sub-system. Connection endpoints can be opened for previously authenticated and authorized clients either on the service side during a predefined short time interval or on the client side. If opened on the client side, the invisible service is triggered to initiate the connection build-up to the open connection endpoint on the client side. Services opening temporary connection endpoints are for port scan during normal operation invisible. Services connecting to connection endpoints opened on the client side, at no time provide any open connection endpoints and are therefore for port scan absolutely invisible. In networks on the base of TCP/IP the id of an opened connection endpoint (port) may be selected pseudo or absolutely randomly. In addition, it is possible to dynamically select the service unit out of a set of multiple service units in dependence of the actual system load distribution “load balancing”, connection quality, geographical, topological or other criteria. After the establishment of a connection between an invisible service and a client, both partners may authenticate each other using random access data (tickets).

### CROSS-REFERENCES TO RELATED APPLICATIONS

This invention can be used in any information processing system according to the following related patent applications:

1. U.S. utility patent application Ser. No. 09/558,435 filed on Apr. 25, 2000 and

2. U.S. utility patent application Ser. No. 09/740,925 filed on Dec. 19, 2000.

### STATEMENT REGARDING FEDERALLY SPONSORED RESEARCH AND DEVELOPMENT

Not Applicable

### REFERENCES TO ADDITIONAL MATERIAL

DE 199 61 399 (EP1126677, U.S. Ser. No. 09/740,925)

### TECHNICAL FIELD

This invention concerns communication systems with clients and services.

### BACKGROUND OF THE INVENTION

Modern e-commerce networks frequently are faced with the problem, that certain services are on one hand required for the operation of the e-commerce infrastructure and have to be accessible by the clients on a 24h base, and on the other hand at the same time grant access to valuable economic data, which should be limited to paying customers only. Prior art e-commerce systems expose through the permanent open connection endpoints of their servers permanent points-of-attack for malicious attackers. Typical attack strategies reach from spying out user ids and passwords to denial-of-service short DOS-attacks. Depending on the quality of the hacked data the economic damages can be tolerable to threaten the existence for a compromised company.

The cause of many successful attacks is the fact, that modern network systems are build according to the traditional client/server-model with an often large number of server processes providing many open connection endpoints (sockets) running on many server units. As soon as a client connects to an open connection endpoint, prior art server in general open as fast as possible a new connection endpoint to be able to accept the following client. This means effectively, that each server almost permanently provides at least one open connection endpoint.

At the same time, each open connection endpoint of a server exposes a potential point-of-attack for malicious clients, such that the break-in risk increases with increasing number of open connection endpoints. The access to prior art services is typically protected by firewalls able to allow or prohibit, according to predefined rules, connections to open connection endpoints of defined servers. The large number of vulnerable open connection endpoints requires firewalls to check a large number of different rules for each received data packet. Since each check of each individual rule by a firewall consumes processing power, prior art networks loose a lot of their potential performance by continuous traffic supervision. In addition, the increasing number of rules a firewall has to check increases the administrative burden and the risk of manually caused firewall mis-configurations.

The security hazard in networks can be reduced significantly by a strict reduction of the number of open connection endpoints and server processes as described in DE 199 61 399.0 (EP1126677, U.S. Ser. No. 09/740,925). But it is difficult to apply the system architectures described in DE 199 61 399 (EP1126677, U.S. Ser. No. 09/740,925) to systems working according to the state-of-the-art client/server-principle with the result, that systems according to DE 199 61 399 (EP1126677, U.S. Ser. No. 09/740,925) cannot be integrated without additional means into existing client/server-architectures. In particular state-of-the-art clients cannot communicate without additional means with services according to DE 199 61 399 (EP1126677, U.S. Ser. No. 09/740,925), so that DE 199 61 399 (EP1126677, U.S. Ser. No. 09/740,925) requires a redesign of the clients.

The direct communication between prior art clients and services implies, that—on top of the normal firewall checks—additional application dependent authorization checks have to be performed and results in a two level security architecture of prior art systems:

1. firewall controlled connection build-ups, and

2. decentralized application oriented security checks.

In practice, especially decentralized organized security mechanisms cause many problems, because software updates to patch known security holes have to be applied at all locations, where the defective software version is running. Single servers can easily been overseen, leaving the security hole open. The wide spread knowledge of such security holes increases the hazard further.

Prior art logical connections are established according to the client/server principle in the following way:

A physical unit identified by a unique physical id executes a thread (called server), which provides at least one logical connection endpoint identified by a local id unique on the server executing unit and waits until another thread (called client) running on the same or another unit tries to connect to said endpoint. Supposed the units executing the server and the client are physically connected via a network, the client needs at least the physical id of the server executing unit and the locally unique id of the connection endpoint provided by the server. Both ids together are enough to uniquely identify the connection endpoint of the server in the network. After reception, the server decides to accept or deny a connection request. A connection is only established, if the server accepts the connection request, eventually after a positive result of an additional client authentication. In case of a negative client authentication, the server terminates the connection build-up and no connection is established. According to this scheme only point-to-point connections between a single server and a single client can be established. Logical connections between two clients, two servers or more than two clients and/or servers are not possible.

A connection between a client and a server can only exist for a single transaction (temporary connection) or last for longer time intervals (standing connections). After termination of all transactions one of the communication partners closes the connection whereupon the other partner closes the connection endpoint on his side.

A typical example of such networks is the Internet or internet-like intranets, which are build of several programmable and physically linked computers, each executing an operating system, the network and the application programs. Homogeneous systems contain identical or different computers controlled by the same operating system. Heterogeneous systems contain similar or different computers controlled by the same or different operating systems. The networking programs typically follow the ISO/OSI-model, use the UDP/IP- or TCP/IP-stacks and serve for the information exchange between different software components running on the same or different machines.

Physically separated networks protected against each other by firewalls or proxy-servers, control the traffic in prior art networks. In general, firewalls check only the connection build-up between clients and servers residing in different physical networks and do not offer the possibility to check individual transactions on a logical level after a connection has been established. Instead, proxy-server offer this possibility, but interact, after a positive authorization validation of an incoming request, themselves as clients to secondary (protected) servers. Both solutions have the disadvantage, that critical operative services still have to permanently provide open connection endpoints in order to be accessible at any time. These permanent open connection endpoints remain potential points-of-attack at least for internal clients.

Typical systems working according to the described client/server principle are the operating systems Unix, Windows NT, OS/2 or Netware as well as the middleware DCE, TUXEDO or CORBA.

Prior art client/server networks expose the following security hazards:

1. Each open connection endpoint of a server running on a unit connected to the network is a potential target for malicious attackers. If a unit provides multiple open connection endpoints of one or more servers, each individual connection endpoint is a potential target.

2. Prior art Internet-like networks provide their system functionality via server processes. In practice, individual units execute a huge number of servers with an equally huge number of open connection endpoints.

3. To assure permanent accessibility a server has to permanently provide at least one open connection endpoint on a 24h base, which at the same time exposes a permanent target.

4. The security of the complete system is given by the security of the weakest server and, in general, decreases with increasing number of servers.

5. A well defined coherent security standard for a complete system can only be guaranteed, if each individual server is implemented according to the same security standard.

In practice a system wide coherent security standard can be achieved only at extremely high costs, since

1. each individual server has to implement the required security mechanisms,

2. the security mechanisms of each individual server have to be tested and verified,

3. during operation, the access to each individual server has to be continuously monitored, and

4. during operation, each client transaction with a server has to be monitored and authorized.

If one or more servers are provided by independent software companies, additional problems arise especially with respect to nondisclosure of the (internal) security standards, the availability of the server source code (for modifications and/or verification) and/or the liability in case of losses.

The FTP-protocol and similar structured protocols allow a client to initially build-up a logical connection to a control-port—for FTP in general 21—and to negotiate a port number P with the FTP-server. After the port number P has been fixed, either the FTP-server or the FTP-client can provide an open connection endpoint on port P, such that the FTP-client resp. FTP-server can connect to the connection endpoint provided by the FTP-server resp. FTP-client. Since the FTP-server, and other servers working according to the same principle, are implemented as single processes running under a single- or multitasking operation system, leaving the unit, which execute the FTP-server, vulnerable to attacks against the permanently open control-port.

### OBJECT OF THIS INVENTION

The object of this invention is to protect security critical data and services in communication systems.

### SUMMARY OF THIS INVENTION

The present invention overcomes the prior art by triggerable invisible services, which during normal operation do not provide any permanently open connection endpoint. Connection endpoints are only opened after prior client authentication and authorization validated by an independent logon sub-system. During a predefined, relatively short time interval connection endpoints can be opened for previously authenticated and authorized clients either on the service or on the client side. If opened on the client side, the invisible service is triggered to initiate the connection build-up to the open connection endpoint on the client side. Services opening temporary connection endpoints are during normal operation for port scans invisible. Services connecting to connection endpoints opened on the client side, at no time provide any open connection endpoints and are therefore for port scan absolutely invisible. In networks on the base of TCP/IP the id of an opened connection endpoint (port) may be selected pseudo or absolutely randomly. In addition, it is possible to dynamically select the service unit out of a set of multiple service units in dependence of the actual system load distribution “load balancing”, connection quality, geographical, topological or other criteria. After the establishment of a connection between an invisible service and a client, both partners may authenticate each other using random access data (tickets).

### BRIEF DESCRIPTION OF FIGURES

FIG. 1: illustrates networks with communication system according to claim 1, where logon service LS and service S are running in part a) on the same unit SE and part b) on separate units LE and SE physically connected via network connection NC with client unit CE executing client C.

FIG. 2: illustrates the timing of the connection build-up between client C and service S in a network with communication system according to a) claim 1, as shown in FIG. 1, e.g. without transmission and validation of logon data and b) claim 3, as shown in FIG. 7, e.g. with transfer of logon data in message 1 from client C to logon service LS and validation of the transmitted logon data against authorization data AD by logon service LS.

FIG. 3: illustrates a network with communication system according to claim 15, where logon service LS, authorization service AS and service S are running on the same unit SE physically connected via network connection NC with client unit CE executing client C.

FIG. 4: illustrates a network with communication system according to claim 15, where logon service LS, authorization service AS and service S each are running on a separate unit LE, AE resp. SE, where unit AE is physically connected via network connections NC3 and NC4 with unit LE resp. unit SE and client unit CE executing client C is physically connected via network connection NC1 with units LE and SE.

FIG. 5: illustrates the same network with communication system according to claim 15 as shown in FIG. 4, with the differences, that units AE and CE are located in two separate network segments N and N1, units LE and SE are physically connected with both network segments N and N1 and that no message is physically routed between the two network segments N and N1.

FIG. 6: illustrates the timing of the connection build-up between client C and service S in a network with communication system according to a) claim 15, as shown in FIG. 5, e.g. without transmission and validation of logon data and b) claim 17 with transfer of logon data in message 1&2 from client C via logon service LS to authorization service AS and validation of the transmitted logon data against authorization data AD by authorization service AS.

FIG. 7: illustrates networks with communication system according to claim 3, where logon service LS has access to authorization data AD and validates logon data transmitted by client C against authorization data AD and where logon service LS and service S are running in part a) on the same unit SE and part b) on separate units LE and SE physically connected via network connection NC with client unit CE executing client C.

FIG. 8: illustrates a network with communication system according to claim 17 comparable to FIG. 5, with the difference, that authorization unit AE has access to authorization data AD and validates logon data transmitted by client C against authorization data AD.

FIG. 9 illustrates a network with communication system according to claim 6 with timing diagram for the build-up of connection VC from client C to service S (please refer to the “detailed description of this invention” for more details).

FIG. 10 illustrates a network with communication system according to claim 7 with timing diagram for the build-up of connection VC from client C to service S (please refer to the “detailed description of this invention” for more details).

FIG. 11 illustrates a network with communication system according to claim 20 with timing diagram for the build-up of connection VC from client C to service S (please refer to the “detailed description of this invention” for more details).

FIG. 12 illustrates a network with communication system according to claim 21 with timing diagram for the build-up of connection VC from client C to service S (please refer to the “detailed description of this invention” for more details).

FIG. 13 illustrates a network with communication system according to claim 22 with timing diagram for the build-up of connection VC from client C to service S (please refer to the “detailed description of this invention” for more details).

FIG. 14 illustrates a network with communication system according to claim 9 with timing diagram for the build-up of connection VC from client C to service S (please refer to the “detailed description of this invention” for more details).

FIG. 15 illustrates a network with communication system according to claim 25 with timing diagram for the build-up of connection VC from client C to service S (please refer to the “detailed description of this invention” for more details).

FIG. 16 illustrates a network with communication system according to claim 9 with timing diagram for the build-up of connection VC from client C to service S (please refer to the “detailed description of this invention” for more details).

FIG. 17 illustrates a network with communication system according to claim 25 with timing diagram for the build-up of connection VC from client C to service S (please refer to the “detailed description of this invention” for more details).

FIG. 18 illustrates a network with communication system according to claim 25 with timing diagram for the build-up of connection VC from client C to service S (please refer to the “detailed description of this invention” for more details).

FIG. 19 shows the same system as FIG. 18 with the only difference, that all authorization programs AP₁ to APₐₚ have access to the same authorization data AD, which could be realized by a NFS network.

FIG. 20 shows different possibilities to protect service S and logon service LS in networks with communication system according to one of the claims 35 and 36 by firewalls F/F′ and/or local firewalls LF, where the firewalls can be configured to allow connection build-ups between client C and logon service LS resp. service S only in the shown directions.

FIG. 21: illustrates networks with communication system according to claim 38, where logon service LS and service S are running in part a) on the same unit SE and part b) on separate units LE and SE physically connected via network connection NC with client unit CE executing client C.

FIG. 22: illustrates a network with communication system according to claim 40, where logon service LS has access to authorization data AD, logon service LS and service S are running in part a) on the same unit SE and part b) on separate units LE and SE physically connected via network connection NC with client unit CE executing client C.

FIG. 23: illustrates the timing of the connection build-up between client C and service S in a network with communication system according to a) claim 38, as shown in FIG. 21, e.g. without transmission and validation of logon data and b) claim 40, as shown in FIG. 22, with transfer of logon data in message 1 from client C to logon service LS and validation of the transmitted logon data against authorization data AD by logon service LS.

FIG. 24: illustrates a network with communication system according to claim 52, where logon service LS, authorization service AS and service S are running on a singe unit SE, where client unit CE executing client C is physically connected via network connection NC with unit SE.

FIG. 25: illustrates the same network with communication system according to claim 52 as shown in FIG. 24, with the difference, that logon service LS, authorization service AS, service S and client C each are running on a separate unit LE, AE, SE resp. CE all located in the same network segment N physically connected via network connection NC.

FIG. 26: illustrates the same network with communication system according to claim 52 as shown in FIG. 25, with the differences, that units AE and CE are located in two separate network segments N and N1, units LE and SE are physically connected with both network segments N and N1 and that no message is physically routed between the two network segments N and N1.

FIG. 27: illustrates the same network with communication system according to claim 52 as shown in FIG. 26 with the differences, that there is no direct internal network connection between logon unit LE and service unit SE and that authorization unit AE is connected via network connection NC1 with logon unit LS and via network connection NC2 with service unit SE and that no messages are physically routed between the three network segments N, N1 and N2.

FIG. 28: illustrates a network with communication system according to claim 54, where authorization service AS has access to authorization data AD stored on authorization unit AE and where units AE and CE are located in two separate network segments N and N1 and that no message is physically routed between the two network segments N and N1.

FIG. 29: illustrates the same network with communication system according to claim 54 as shown in 28 with the differences, that logon service SE and service S are located in two different external network segments N1 and N2 as well as one internal network segment N and that no messages are physically routed between the three network segments N, N1 and N2.

FIG. 30: illustrates the timing of the connection build-up between client C and service S in a network with communication system according to a) claim 52, as shown in FIGS. 24 to 27, e.g. without transmission and validation of logon data and b) claim 54, as shown in FIGS. 28 to 29, e.g. with transfer of logon data in messages 1&2 from client C via logon service LS to authorization service AS and validation of the transmitted logon data against authorization data AD by authorization service AS.

FIG. 31 illustrates a network with communication system according to claim 43 with timing diagram for the build-up of connection VC between client C and service S (please refer to the “detailed description of this invention” for more details).

FIG. 32 illustrates a network with communication system according to claim 44 with timing diagram for the build-up of connection VC between client C and service S (please refer to the “detailed description of this invention” for more details).

FIG. 33 illustrates a network with communication system according to claim 57 with timing diagram for the build-up of connection VC between client C and service S (please refer to the “detailed description of this invention” for more details).

FIG. 34 illustrates a network with communication system according to claim 58 with timing diagram for the build-up of connection VC between client C and service S (please refer to the “detailed description of this invention” for more details).

FIG. 35 illustrates a network with communication system according to claim 59 with timing diagram for the build-up of connection VC between client C and service S (please refer to the “detailed description of this invention” for more details).

FIG. 36 illustrates a network with communication system according to claim 46 with timing diagram for the build-up of connection VC between client C and service S (please refer to the “detailed description of this invention” for more details).

FIG. 37 illustrates a network with communication system according to claim 62 with timing diagram for the build-up of connection VC between client C and service S (please refer to the “detailed description of this invention” for more details).

FIG. 38 illustrates a network with communication system according to claim 46 with timing diagram for the build-up of connection VC between client C and service S (please refer to the “detailed description of this invention” for more details).

FIG. 39 illustrates a network with communication system according to claim 62 with timing diagram for the build-up of connection VC between client C and service S (please refer to the “detailed description of this invention” for more details).

FIG. 40 illustrates a network with communication system according to claim 62 with timing diagram for the build-up of connection VC between client C and service S (please refer to the “detailed description of this invention” for more details).

FIG. 41 shows the same system as FIG. 40 with the difference, that all authorization programs AP₁ to APₐₚ have access to the same authorization data AD, which could be realized by a NFS network.

FIG. 42 shows different possibilities to protect service S and logon service LS in networks with communication system according to one of the claims 72 and 73 by firewalls F/F′ and/or local firewalls LF, where the firewalls can be configured to allow connection build-ups between client C and logon service LS resp. service S only in the shown directions. The advantage of systems according to one of the claims 72 and 73 versus systems according to one of the claims 35 and 36 (shown in FIG. 20) is, that firewall F between service S and client C resp. local firewall LF on service unit SE can block all connection build-ups in direction of service unit SE resp. service S as well as all connection less and/or unsolicited messages from and to service unit SE resp. service S.

FIG. 43a illustrates the system topology and FIG. 43b the timing of one transaction in an incarnation in a network with communication system according to claim 80 (please refer to the “detailed description of this invention” for more details).

FIG. 44 illustrates the system topology and FIG. 45 the timing of the connection build-ups as well as one transaction T₁ in an incarnation of a network with communication system according to claim 87 and the same protocol as used in example of FIG. 43 (please refer to the “detailed description of this invention” for more details).

FIG. 45 illustrates the timing diagram of the system shown in FIG. 44 (please refer to the “detailed description of this invention” for more details).

FIG. 46 illustrates a network with communication system according to claim 87 and several logically in series connected authorization services (please refer to the “detailed description of this invention” for more details).

### DETAILED DESCRIPTION OF THIS INVENTION

The present patent overcomes the prior art by communication systems according to one of the claims 1, 15, 38 and 52, such that on one hand an operative service S opens connection endpoints for clients exclusively upon request A from a logon service LS (claim 1) resp. authorization service AS (claim 15) or on the other hand an operative service S provides at absolutely no time any open connection endpoint and instead builds-up only upon request A from logon service LS (claim 38) resp. authorization service AS (claim 52) a connection to a connection endpoint opened by a previously authorized client.

Systems according to one of the claims 1 and 15 in particular offer the possibility for operative service S not to provide any open connection endpoints during normal operation, once the connections between operative service S and logon service LS resp. authorization service AS have been established, and therefore are invisible for port scans during normal operation. Only after logon service LS resp. authorization service AS sent request A to operative service S, to open a new connection endpoint for client C, service S actually opens connection endpoint VEPS for client C to give client C the technical possibility to build-up a connection to service S.

Systems according to one of the claims 38 and 52 in particular offer the possibility for operative service S to initiate the build-up of connection VC to an open connection endpoint provided by client C and not to provide at any time any open connection endpoints, wherefor operative service S is absolutely invisible for port scans at any time. Only after reception of request A from logon service LS resp. authorization service AS operative service S according to one of the claims 38 and 52 builds-up connection VC to connection endpoint VEPC opened by the previously authorized client C.

Because of the state-of-the-art FTP-protocol (and similar protocols) claims 1 and 38 only claim “a reliable standing logical bidirectional inter process communication connection VS” between logon service LS and service S—in contrast to claims 15 and 52, which claim “a reliable logical bidirectional inter thread or inter process communication connection VA resp. VS” between logon service LS and authorization service AS resp. authorization service AS and service S.

The advantages of networks with invisible services according to one of the claims 1, 15, 38 and 52 versus prior art systems are:

1. During normal operation operative services according to claims 1 and 15 are most of the time invisible to port scans.

2. Operative services according to claims 38 and 52 are absolutely invisible to port scan at all times.

3. The invisibility of operative services for port scans effectively prohibits potential attackers from collecting information about operative services without previous knowledge of the system's existence and architecture.

4. Compared to state-of-the-art servers with permanent open connection endpoints, the possibility to limit the time interval during which open connection endpoints are provided either by operative services or by clients dramatically limits the time interval for a potential attack.

5. Because the time and location of a potential attack is known in advance, connection requests can be supervised with significantly less effort and potential attacks can be detected and defeated much easier and faster.

6. The complete separation between logon sub-system—i.e. logon service LS in claims 1 and 38 and additional authorization service AS in claims 15 and 52—and operative systems practically completely takes away the burden of all authorization tasks from operative services and allows to change authorization methods and policies at one central location—i.e. in the logon sub-system.

7. The indirect connection build-up between operative services and clients via an independent logon sub-system allows to select operative services dynamically in real-time in dependence of the individual rights of each client, the actual system load or other criteria, and to enable the selected service once for each authorized client, without requiring the clients to know the coordinates (i.e. physical address and local identification) of operative services in advance.

8. A failure of the logon sub-system does not directly affect operative systems in such respect, that all previously established connections between clients and service S can be served without interruption. The only potential disadvantage upon failure of the logon sub-system is, that no new client will be able to connect to an operative service S, as long as the logon sub-system does not recover (in many cases this actually is an advantage).

9. After establishment of predefined connections to operative services the logon subsystem can be shut-down on purpose, so that the operative system is completely closed and cannot accept any further clients.

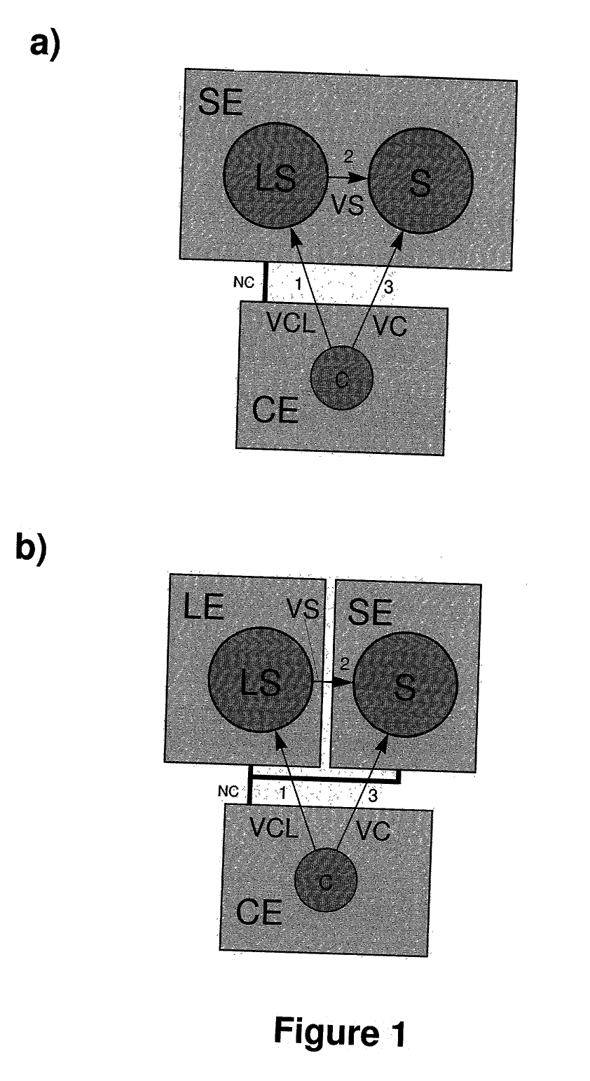

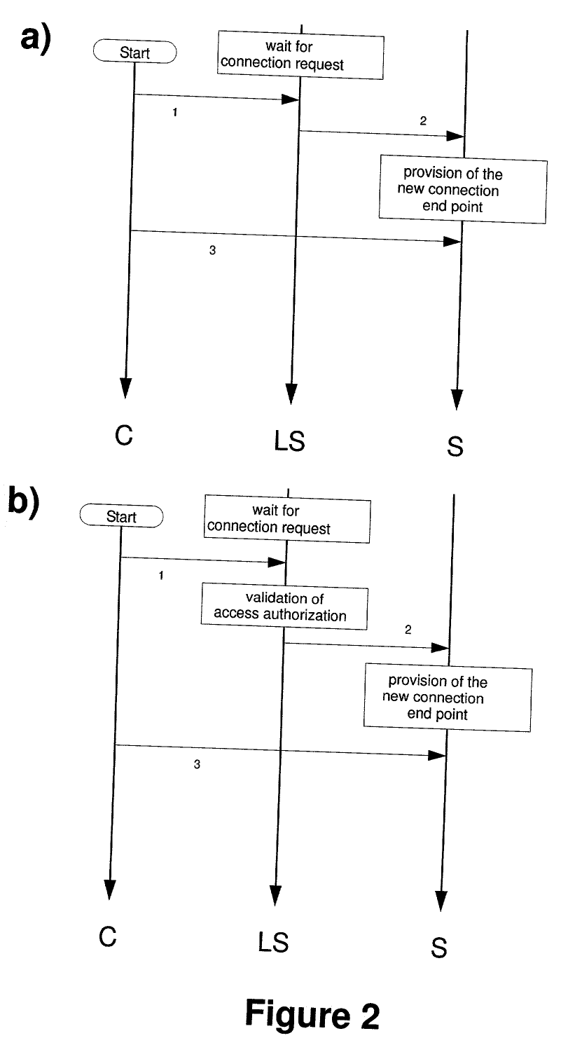

FIG. 1a illustrates a network with communication system according to claim 1 comprising a service unit SE executing logon service LS and service S, where logon service LS and service S are connected via standing logical bidirectional communication connection VS, as well as comprising client unit CE connected via physical network connection NC with service unit SE and executing client C. FIG. 2a describes the timing of a connection build-up from client C to service S in a network with communication system according to claim 1 shown in FIG. 1. After establishment of connection VS, service S does not provide under normal operation any permanently open connection endpoint, so that client C cannot directly connect to service S. Instead, logon service LS provides at least one open connection endpoint for client C, initially allowing client C—to build-up a connection to service S—only to connect in (1) to logon service LS. Once logon service LS accepted the connection request from client C, logon service LS sends in message (2) via connection VS request A, to open a new connection endpoint for client C, to service S, whereupon service S opens a new connection endpoint VEPS for client C. Thereafter client C may terminate the connection to logon service LS and build-up in (3) a connection to connection endpoint VEPS provided by service S.

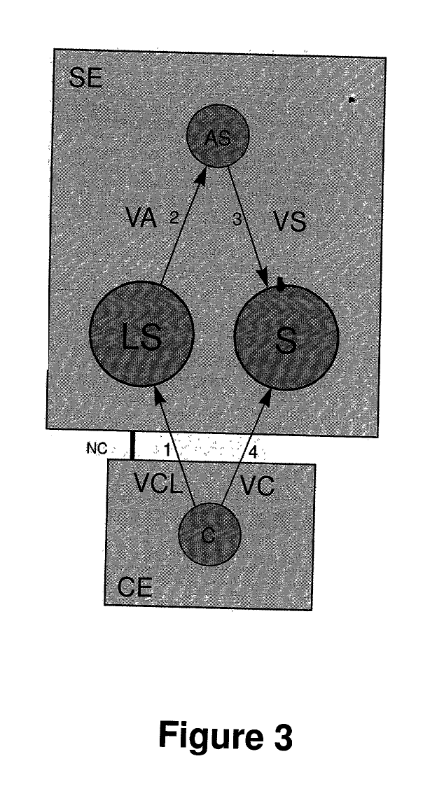

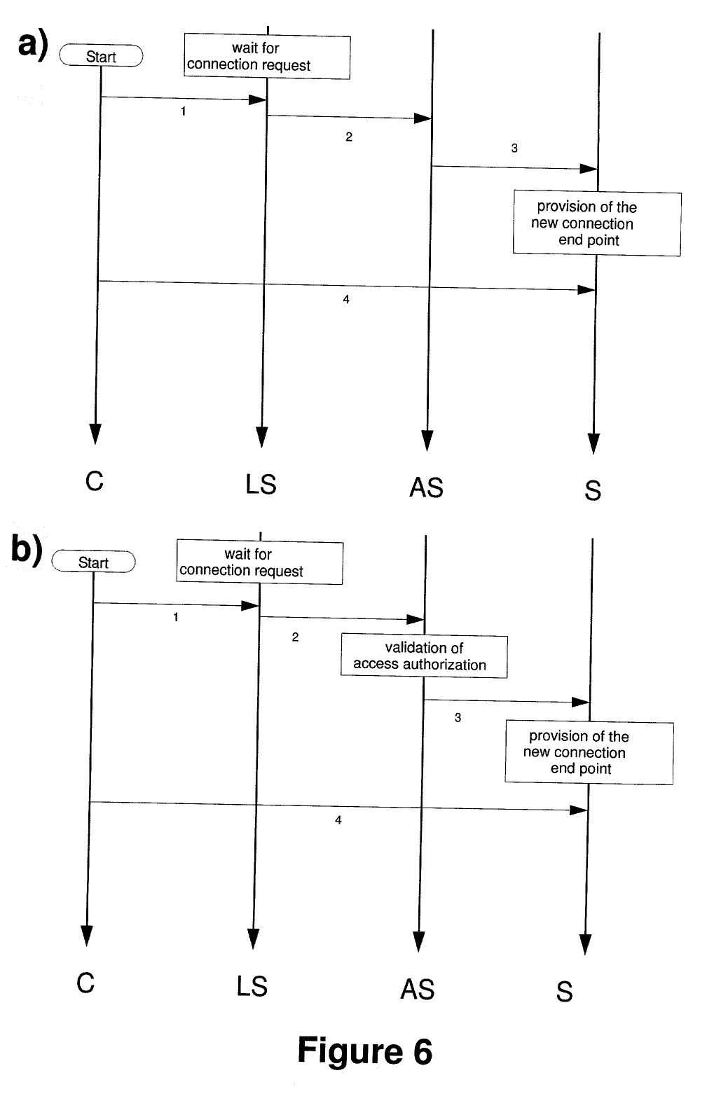

FIG. 3 illustrates a network with communication system according to claim 15 comprising a service unit SE executing logon service LS, authorization service AS and service S, where authorization service AS and service S are connected via standing logical bidirectional communication connection VS, as well as comprising client unit CE connected via physical network connection NC with service unit SE and executing client C. FIG. 6a describes the timing of a connection build-up from client C to service S in a network with communication system according to claim 15 shown in FIG. 3. After establishment of connection VS, service S does not provide under normal operation any permanently open connection endpoint, so that client C cannot directly connect to service S. Instead, logon service LS and authorization service AS are connected via reliable standing logical bidirectional inter thread or inter process communication connection VA or authorization service AS provides an open connection endpoint for logon service LS allowing logon service LS to connect to authorization service AS upon demand. In addition logon service LS provides at least one open connection endpoint VEPCL for client C, initially allowing client C—to build-up a connection to service S—only to connect to logon service LS (1). After logon service LS accepted the connection request from client C, logon service LS builds-up—if no connection VA to authorization service AS exists—connection VA to authorization service AS and informs authorization service AS via connection VA in message (2), that client C wants to connect to service S. Then authorization service AS sends via connection VS service S a request (3), to open a new open connection endpoint for client C, whereupon service S opens the new connection endpoint VEPS for client C. Finally, client C may terminate connection VCL to logon service LS and build-up connection VC to connection endpoint VEPS provided by service S (4).

It is obvious for a reader skilled in the art, that the different programs logon service LS, authorization service AS or service S can be distributed on a single or multiple units—an example is given explicitly in claims 2 resp. 16—, as long as logon service LS and service S are reachable at least from client C and at least connection VS between logon service LS and service S resp. connection VA between logon service LS and authorization service AS and connection VS between authorization service AS and service S can be established.

Claims 1 to 2 and 15 to 16 obviously also cover the cases, in which

1. logon programs LP₁, . . . , LP_{Ip} comprise more than one logon service LS₁, . . . , LS_{Is}, and/or

2. service programs SP₁, . . . , SPₛₚ comprise more than one service S₁, . . . , Sₛ, and/or

3. authorization programs AP₁, . . . , APₐₚ comprise more than one authorization service AS₁, . . . , ASₐₛ, and/or

4. client programs CP₁, . . . , CP_{cp} comprise more than one client C₁, . . . , C_{c}

and said programs LS₁, . . . , LS_{Is}, S₁, . . . , Sₛ, AS₁, . . . , ASₐₛ, C₁, . . . , C_{c} are executed on their respective units.

FIG. 1b illustrates the same network with communication system shown in FIG. 1a with the difference, that logon service LS is running on unit LE and service S on unit SE, where all units are connected via physical network connection NC.

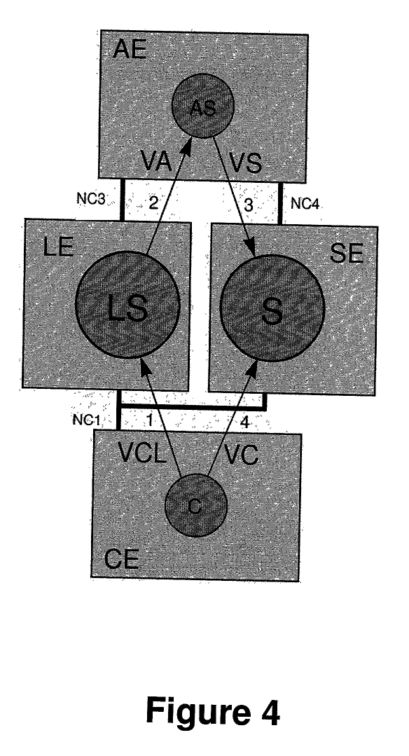

In a network with communication system according to claim 15, shown in FIG. 3, programs authorization service AS, logon service LS and service S may be running on different units, as long as logon service LS and service S can be reached from client C and the connection VA between logon service LS and authorization service AS as well as the connection VS between authorization service AS and service S can be established. FIG. 4 shows the same system as FIG. 3 with the difference, that logon service LS, authorization service AS and service S are running on different units LE, AE resp. SE, all of which are interconnected via physical network connections NC3 and NC4, and that client unit CE is connected via physical network connection NC1 with logon unit LE as well as service unit SE.

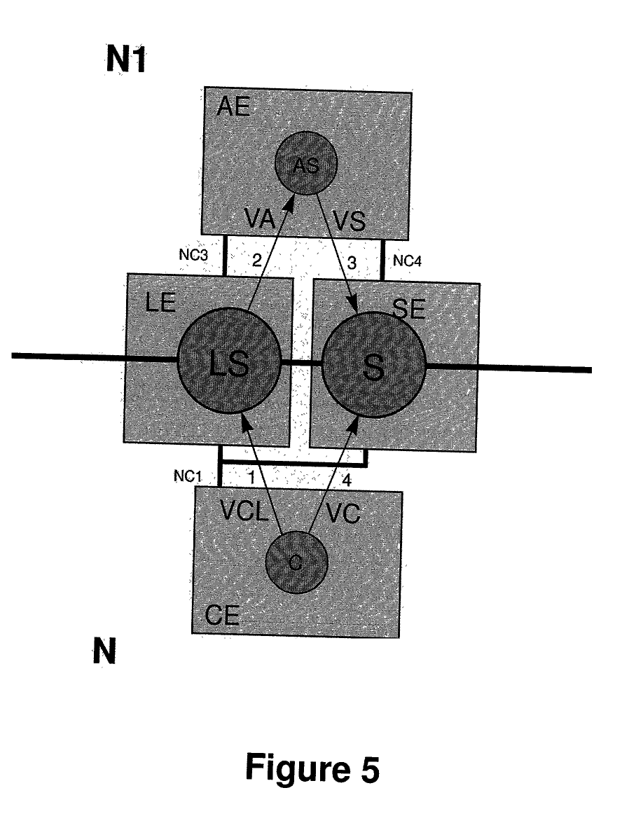

It is very advantageous to divide a network with communication system according to claim 16 into two different physical network segments N and N1 (FIG. 5), where units LE and SE each comprise at least two network interfaces, where one of each pair is connected with segment N and the other with segment N1, and where authorization unit AE is located in segment N1 and client unit CE is located in segment N, and where no messages are physically routed between network segments N1 and N. This prohibits client programs on CE to attack authorization unit AE directly.

In permanent available systems clients have to be able to reach at least logon service LS at any time, so that logon unit LE executing logon service LS can always be attacked. Therefore it is advantageous in a system according to one of the claims 2 resp. 16 to execute logon service LS on a separate logon unit LE, to guarantee, that in case of an attack on logon unit LE, neither authorization service AS nor service S are directly affected.

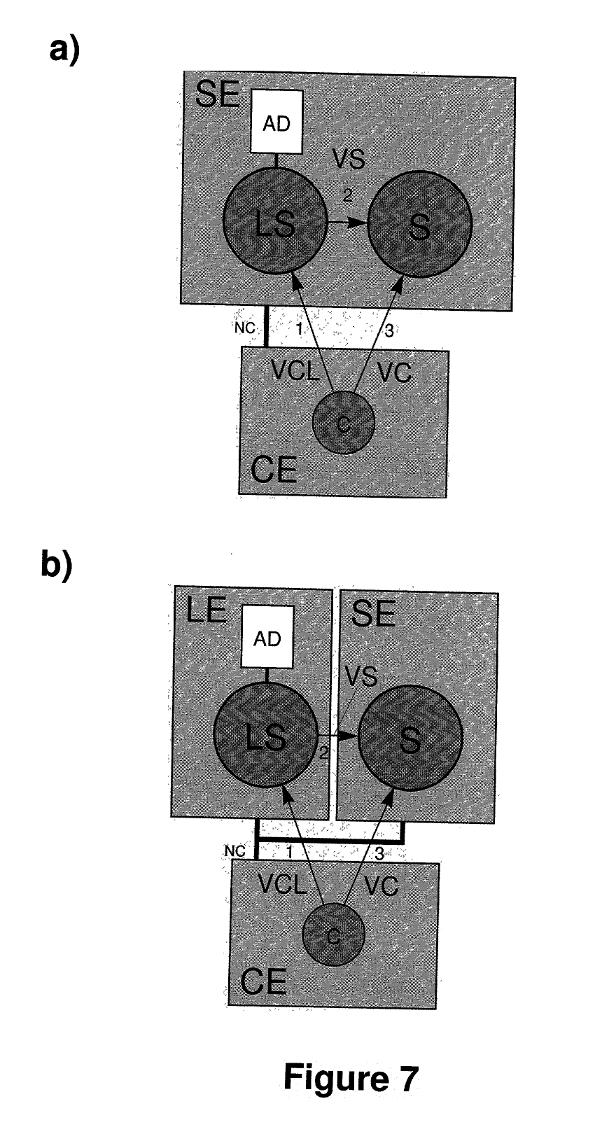

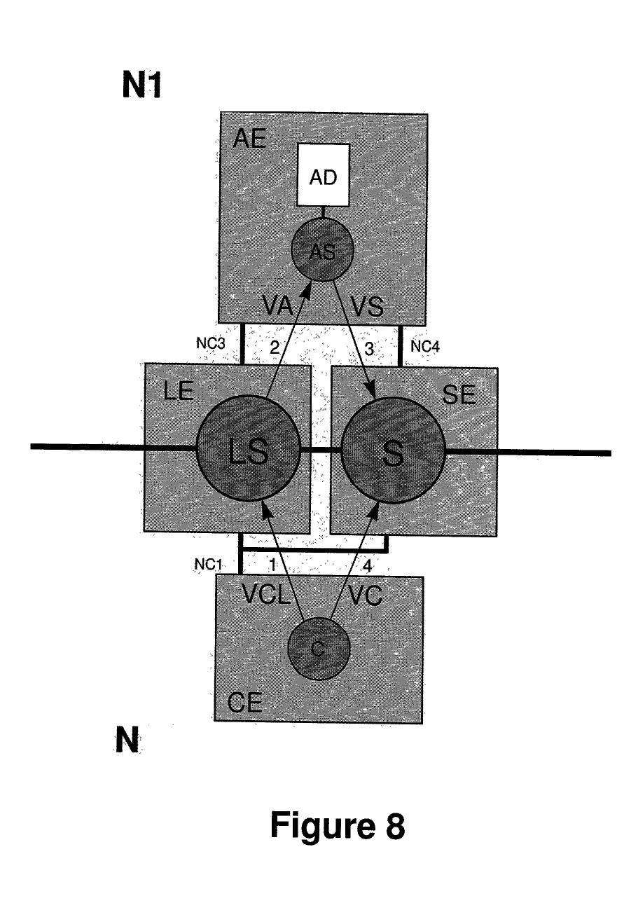

In claims 3 resp. 17 logon service LS resp. authorization service AS have access to authorization data AD, such that in claim 3 logon service LS can validate logon data AMD sent by client C in message (1) of FIG. 2b resp. FIG. 7a/b and logon service LS can issue request (2), to provide an open connection endpoint to service S, only after a positive validation of logon data AMD presented by client C versus authorization data AD, and such that in claim 17 authorization service AS can validate logon data AMD sent by client C in message (1) of FIG. 6b resp. FIG. 8 to logon service LS and forwarded by logon service LS in message (2) to authorization service AS and authorization service AS can issue request A (3), to provide an open connection endpoint to service S, only after a positive validation of logon data AMD presented by client C versus authorization data AD. In this way client C is offered no possibility to build-up a connection to service S without prior validation of his access rights, where claim 17 is to be given preference before claim 3, since authorization service AS and authorization data AD are running resp. stored on a separate unit AE, which unit AE cannot be reached from any client (FIG. 8), while authorization data AD in claim 3 has to be stored on the same unit LE, which also executes logon service LS (FIG. 7a/b).

Claims 4 and 18 cover the cases, in which at least one part of logon data AMD is transmitted in an encrypted format from client C to logon service LS and is decrypted by logon service LS (claim 4) as well as from client C via logon service LS to authorization service AS and decrypted by authorization service AS (claim 18).

In networks with communication systems according to claims 1 to 4 and 15 to 18 based on TCP/IP the access data—in particular the physical address (IP-address) of the unit executing service S as well as the local identification (port) of connection endpoint VEPS provided by service S for client C—are fix and have to be known by client C to allow client C to build-up a connection to open connection endpoint VEPS provided by service S. Such systems are at risk, that an unauthorized attacker acquires knowledge of said access data and connects to open connection endpoint VEPS provided by service S before client C actually can build-up connection VC to open connection endpoint VEPS provided by service S.

This disadvantage is removed in networks with communication systems according to claim 5 resp. 19, in which client C initially does not know access data ZD and receives ZD only during the logon procedure from logon service LS resp. authorization service AS. In systems according to claim 5 parts of the access data ZD can be created by logon service LS (claim 6), service S (claim 7), or client C (claim 8) and in systems according to claim 19 by logon service LS (claim 20), authorization service AS (claim 21), service S (claim 22) or client C (claim 23), and—if any part of access data ZD has not been created by client C—be transmitted via the existing connections VS, VA and VCL directly or indirectly to client C, and—if any part of access data ZD has not been created by service S also to service S. It is only important, that service S, before opening the new connection endpoint VEPS, as well as client C, before connecting to the new connection endpoint VEPS provided by service S, know the respectively required parts of access data ZD.

In networks with communication systems according to claim 5 resp. 19 it is of further advantage,

1. to select one of multiple service units executing at least one service according to claim 1 resp. 15 and to transmit the physical address of the selected service unit within access data ZD to client C, where the selection can be performed by a logon service (claims 9 and 24) or an authorization service (claim 25),

2. to select an arbitrary local identification LK for connection endpoint VEPS to be provided by service S for client C, and to send said local identification LK, if the selection was not performed by client C, to client C and, if the selection was not performed by service S, also to service S (claims 9 to 12 and 26 to 29).

3. to transmit at least part VTZD of access data ZD in an encrypted format from logon service LS to client C (claims 13 and 30). Of cause, in this case client C has to comprise additional means, to decrypt the encrypted part VTZD of access data ZD.

4. to transmit at least part VTZD2 of access data ZD in an encrypted format from logon service LS (claim 14) or authorization service AS (claim 31) to service S. Of cause, in this case service S has to comprise additional means, to decrypt the encrypted part VTZD2 of access data ZD.

5. to transmit an arbitrary selected key within access data ZD, if the selection was not performed by client C, to client C (claim 32) and, if the selection was not performed by service S, to service S (claim 33),

6. to create at least part TZD of access data ZD—in particular, but not exclusively, the service unit SE executing service S, the port of the open connection endpoint VEPS to be provided by service S for client C, or the key ZSS resp. ZSC—pseudo or absolutely randomly (claim 34).

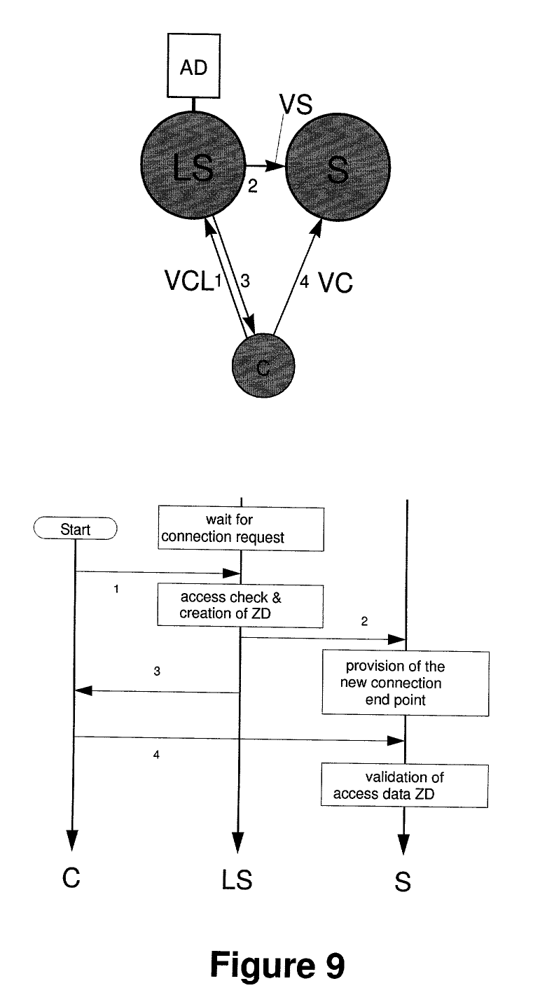

FIGS. 9 to 19 illustrate different incarnations of networks with communication systems according to claims 5 to 14 and 19 to 34 with corresponding timing diagrams of the connection build-up from client C to service S, where programs logon service LS, authorization service AS, service S and client C can be distributed arbitrarily on the underlying network units, as long as the required connections can be established and the programs can communicate as described. Therefore the underlying physical network units and connections are omitted in FIGS. 9 to 19. After establishment of connection VC client C transmits in the given examples at least part TZD of access data ZD to service S, so that service S is able to validate part TZD received from client C against access data ZD. This validation can also be performed in reverse direction, if—after establishment of connection VC service S transmits at least part TZD2 of access data ZD to client C, so that client C is able to validate part TZD2 received from service S against access data ZD. Both validations are not necessarily required, but increase the system security, because client C has to authenticate himself versus service S resp. service S has to authenticate himself versus client C to proof that client C successfully passed through the logon procedure and/or to proof the identity of service S.

FIG. 9 illustrates a network with communication system according to claim 6, in which after connection build-up between client C and logon service LS—client C sends in message (1) logon data AMD to logon service LS, logon service LS—after a positive validation of logon data AMD against authorization data AD—creates access data ZD, sends in message (2) access data ZD together with request A, to open a new connection endpoint for client C, to service S and sends in message (3) access data ZD to client C, such that service S can open in dependence of access data ZD a new connection endpoint VEPS for client C, client C can build-up connection VC to connection endpoint VEPS provided by service S and send in message (4) at least part TZD of access data ZD to service S, service S can validate part TZD of access data ZD received from client C against access data ZD received from logon service LS, and service S can leave client C connected only after a positive result of said access data validation.

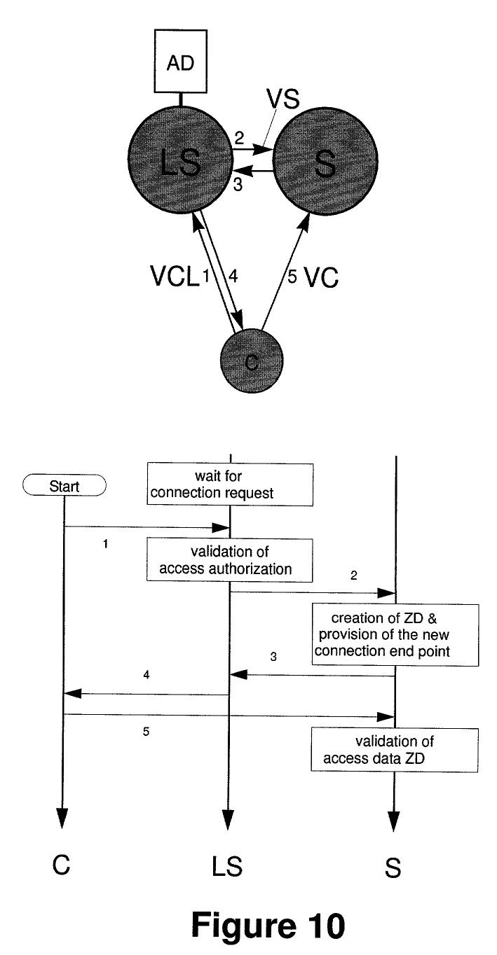

FIG. 10 illustrates a network with communication system according to claim 7, in which—after connection build-up between client C and logon service LS—client C sends in message (1) logon data AMD to logon service LS, logon service LS—after a positive validation of logon data AMD against authorization data AD—sends in message (2) request A to service S, to open a new connection endpoint for client C, service S creates access data ZD and sends in message (3) access data ZD to logon service LS, logon service LS forwards in message (4) access data ZD received from service S to client C, such that service S can open in dependence of access data ZD a new connection endpoint VEPS for client C, client C can build-up connection VC to connection endpoint VEPS provided by service S and send in message (5) at least part TZD of access data ZD to service S, service S can validate part TZD of access data ZD received from client C against the own access data ZD, and service S can leave client C connected only after a positive result of said access data validation.

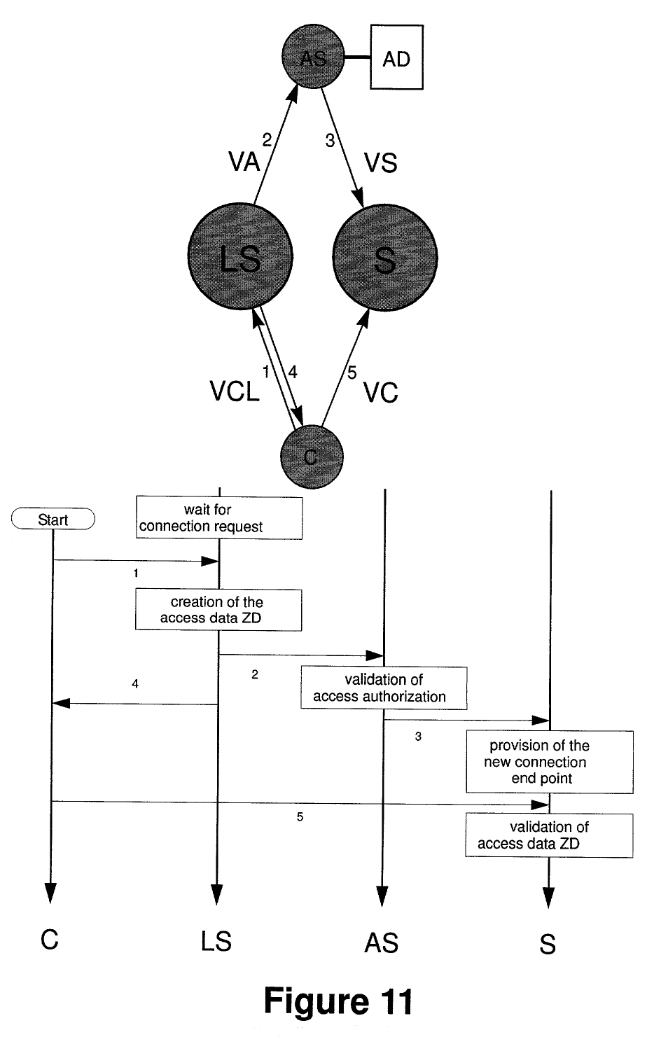

FIG. 11 illustrates a network with communication system according to claim 20, in which—after connection build-up between client C and logon service LS—client C sends in message (1) logon data AMD to logon service LS, logon service LS creates access data ZD and sends in message (2) access data ZD together with logon data AMD to authorization service AS, authorization service AS—after a positive validation of logon data AMD against authorization data AD—sends in message (3) access data ZD together with request A, to open a new connection endpoint for client C, to service S and logon service LS sends in message (4) access data ZD to client C, such that service S can open in dependence of access data ZD a new connection endpoint VEPS for client C, client C can build-up connection VC to connection endpoint VEPS provided by service S and send in message (5) at least part TZD of access data ZD to service S, service S can validate part TZD of access data ZD received from client C against access data ZD received from logon service LS via authorization service AS, and service S can leave client C connected only after a positive result of said access data validation.

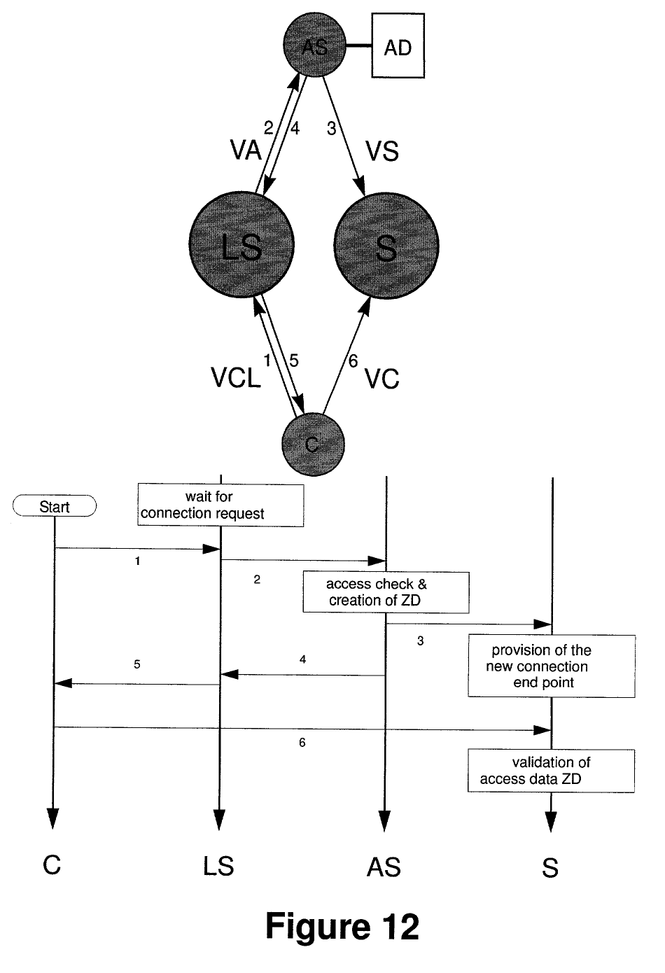

FIG. 12 illustrates a network with communication system according to claim 21, in which—after connection build-up between client C and logon service LS—client C sends in message (1) logon data AMD to logon service LS, logon service LS forwards in message (2) logon data AMD to authorization service AS, authorization service AS—after a positive validation of logon data AMD against authorization data AD—creates access data ZD and sends in message (3) access data ZD together with request A, to open a new connection endpoint for client C, to service S and sends in message (4) access data ZD to logon service LS, logon service LS forwards in message (5) access data ZD to client C, such that service S can open in dependence of access data ZD a new connection endpoint VEPS for client C, client C can build-up connection VC to connection endpoint VEPS provided by service S and send in message (6) at least part TZD of access data ZD to service S, service S can validate part TZD of access data ZD received from client C against access data ZD received from authorization service AS, and service S can leave client C connected only after a positive result of said access data validation.

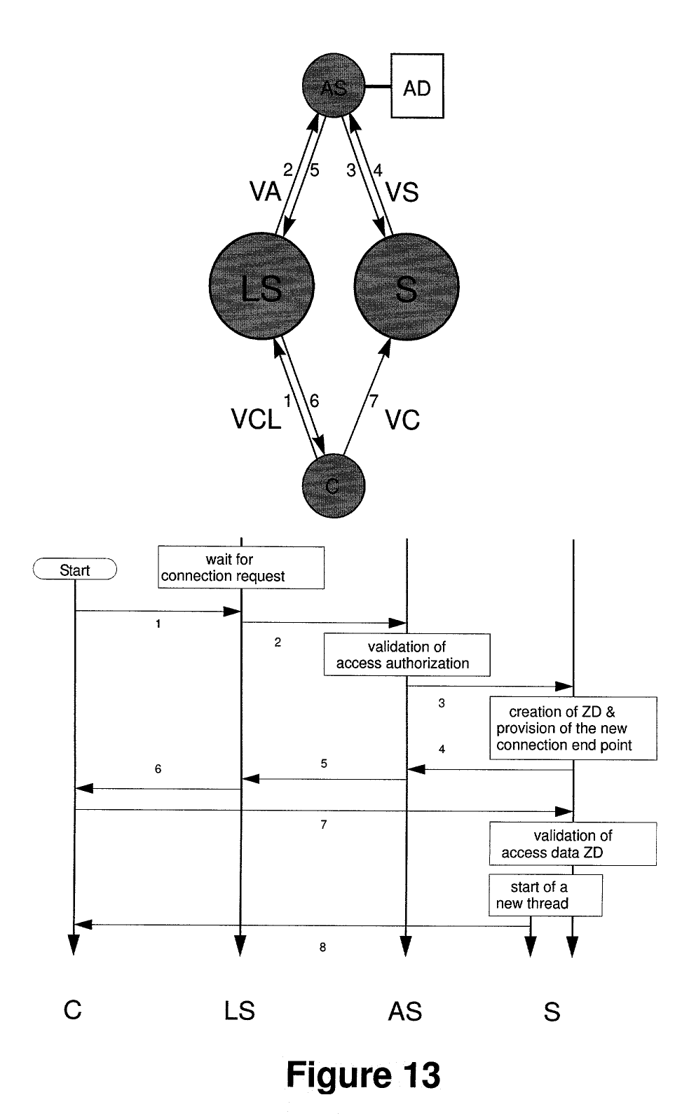

FIG. 13 illustrates a network with communication system according to claim 22, in which—after connection build-up between client C and logon service LS—client C sends in message (1) logon data AMD to logon service LS, logon service LS forwards in message (2) logon data AMD to authorization service AS, authorization service AS—after a positive validation of logon data AMD against authorization data AD—sends in message (3) request A, to open a new connection endpoint for client C, to service S, service S creates access data ZD and sends in message (4) access data ZD to authorization service AS, authorization service AS forwards in message (5) access data ZD to logon service LS and logon service LS forwards in message (6) access data ZD to client C, such that service S can open in dependence of access data ZD a new connection endpoint VEPS for client C, client C can build-up connection VC to connection endpoint VEPS provided by service S and send in message (7) at least part TZD of access data ZD to service S, service S can validate part TZD of access data ZD received from client C against the own access data ZD, and service S can leave client C connected only after a positive result of said access data validation. After a positive validation service S creates in this example a new thread to communicate with client C and acknowledges client C in message (8) the acceptance of the connection.

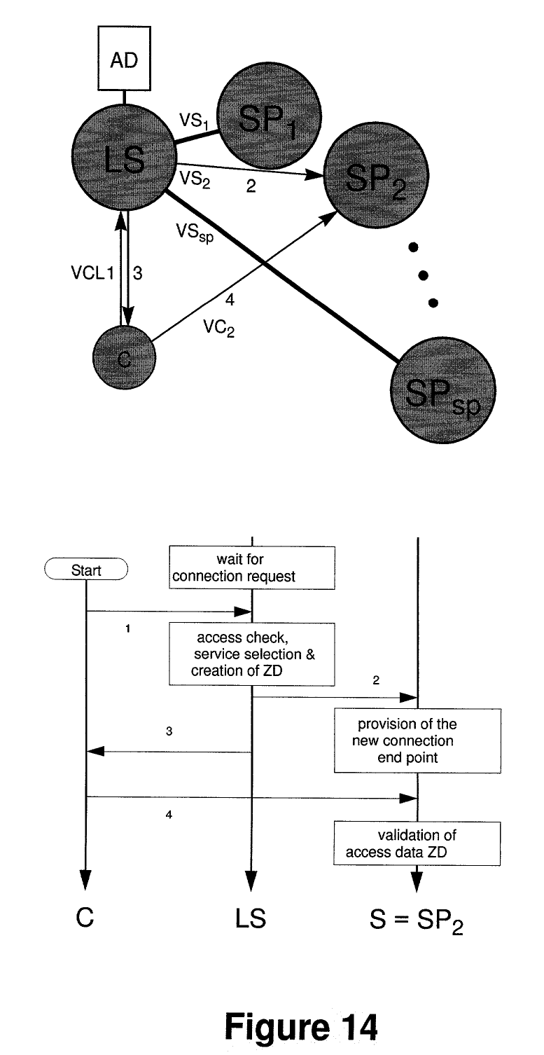

FIG. 14 illustrates a network with communication system according to claim 9 comprising a logon service LS and sp service programs SP₁ to SPₛₚ, where logon service LS is connected with each service program via an individual reliable standing logical bidirectional communication connection VS₁ to VSₛₚ and—after connection build-up between client C and logon service LS—client C sends in message (1) logon data AMD to logon service LS, logon service LS—after a positive validation of logon data AMD against authorization data AD—selects service S=SP₂ out of service programs SP₁ to SPₛₚ, creates access data ZD and sends in message (2) access data ZD together with request A to service S, to open a new connection endpoint for client C, and sends in message (3) access data ZD to client C, such that service S can open in dependence of access data ZD a new connection endpoint VEPS for client C, client C can build-up connection VC₂ to connection endpoint VEPS provided by service S, client C can send via connection VC₂ in message (4) at least part TZD of access data ZD to service S, service S can validate part TZD of access data ZD received from client C against access data ZD received from logon service LS, and service S can leave client C connected only after a positive result of said access data validation.

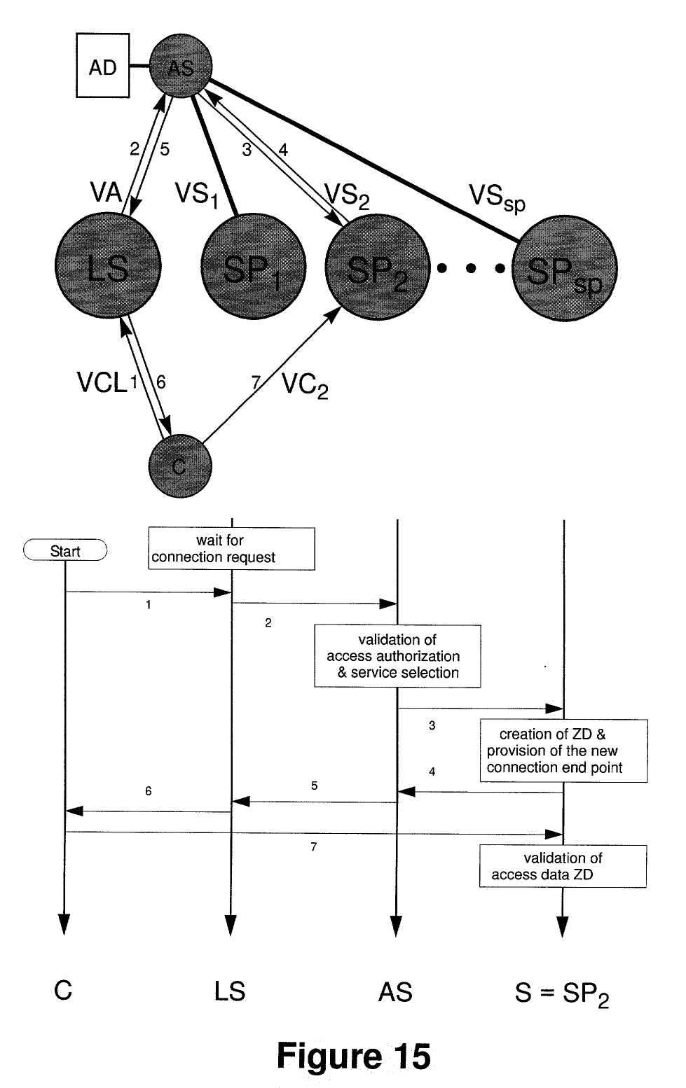

FIG. 15 illustrates a network with communication system according to claim 25 comprising a logon service LS, an authorization service AS and sp service programs SP₁ to SPₛₚ, where logon service LS is connected via reliable standing logical bidirectional communication connection VA with authorization service AS and authorization service AS is connected with each service via an individual reliable standing logical bidirectional communication connection VS₁ to VSₛₚ and—after connection build-up between client C and logon service LS—client C sends in message (1) logon data AMD to logon service LS, logon service LS forwards in message (2) logon data AMD to authorization service AS, authorization service AS—after a positive validation of logon data AMD against authorization data AD—selects service S=SP₂ out of service programs SP₁ to SPₛₚ, sends in message (3) request A to service S, to open a new connection endpoint for client C, service S creates access data ZD and sends in message (4) access data ZD to authorization service AS, authorization service AS forwards in message (5) access data ZD to logon service LS and logon service LS forwards in message (6) access data ZD to client C, such that service S can open in dependence of access data ZD a new connection endpoint VEPS for client C, client C can build-up connection VC₂ to connection endpoint VEPS provided by service S, client C can send via connection VC₂ in message (7) at least part TZD of access data ZD to service S, service S can validate part TZD of access data ZD received from client C against the own access data ZD, and service S can leave client C connected only after a positive result of said access data validation.

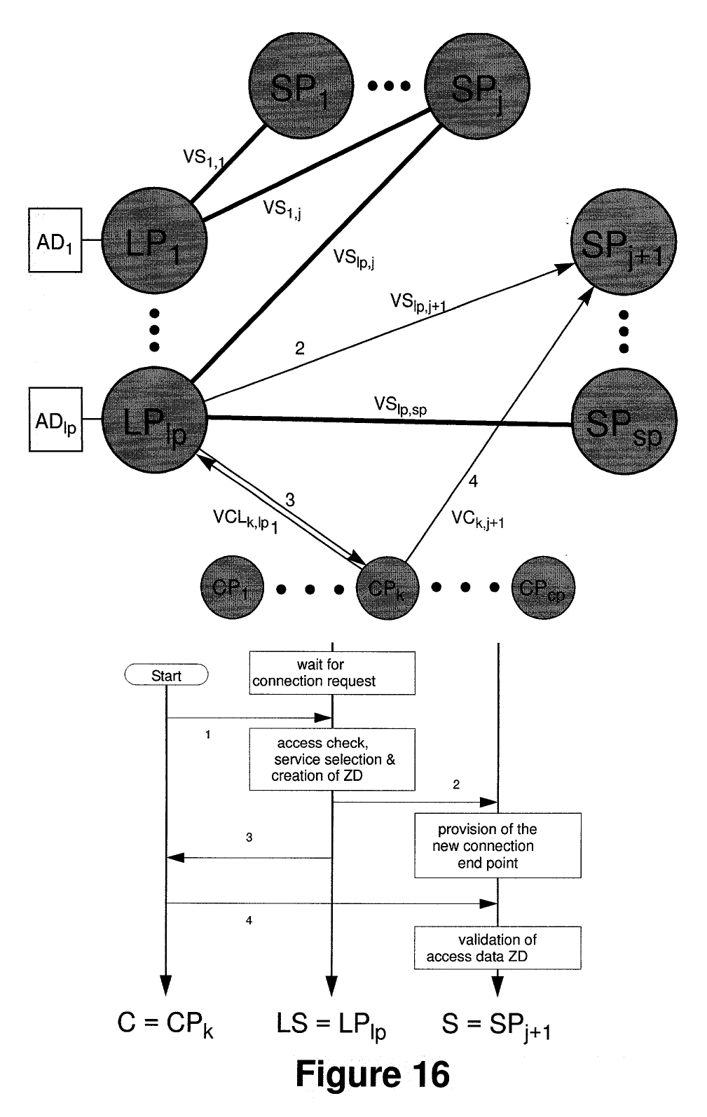

FIG. 16 illustrates a network with communication system according to claim 9 comprising Ip logon programs LP₁ to LP_{Ip}, sp service programs SP₁ to SPₛₚ and cp client programs CP₁ to CP_{cp}, where each logon program is connected with a subset of the service programs SP₁ to SPₛₚ via an individual reliable standing logical bidirectional communication connection VS_{1,1} to VS_{Ip,sp}, and—after connection build-up between client C=CPₖ and logon service LS=LP_{Ip}—client C sends in message (1) logon data AMD to logon service LS, logon service LS—after a positive validation of logon data AMD against authorization data AD—selects service S=SPⱼ₊₁ out of service programs SP₁ to SPₛₚ, creates access data ZD and sends in message (2) access data ZD together with request A, to open a new connection endpoint for client C, to service S and sends in message (3) access data ZD to client C, such that service S can open in dependence of access data ZD a new connection endpoint VEPS for client C, client C can build-up connection VC_{k,j+1} to connection endpoint VEPS provided by service S, client C can send via connection VC_{k,j+1} in message (4) at least part TZD of access data ZD to service S, service S can validate part TZD of access data ZD received from client C against access data ZD received from authorization service AS via logon service LS, and service S can leave client C connected only after a positive result of said access data validation.

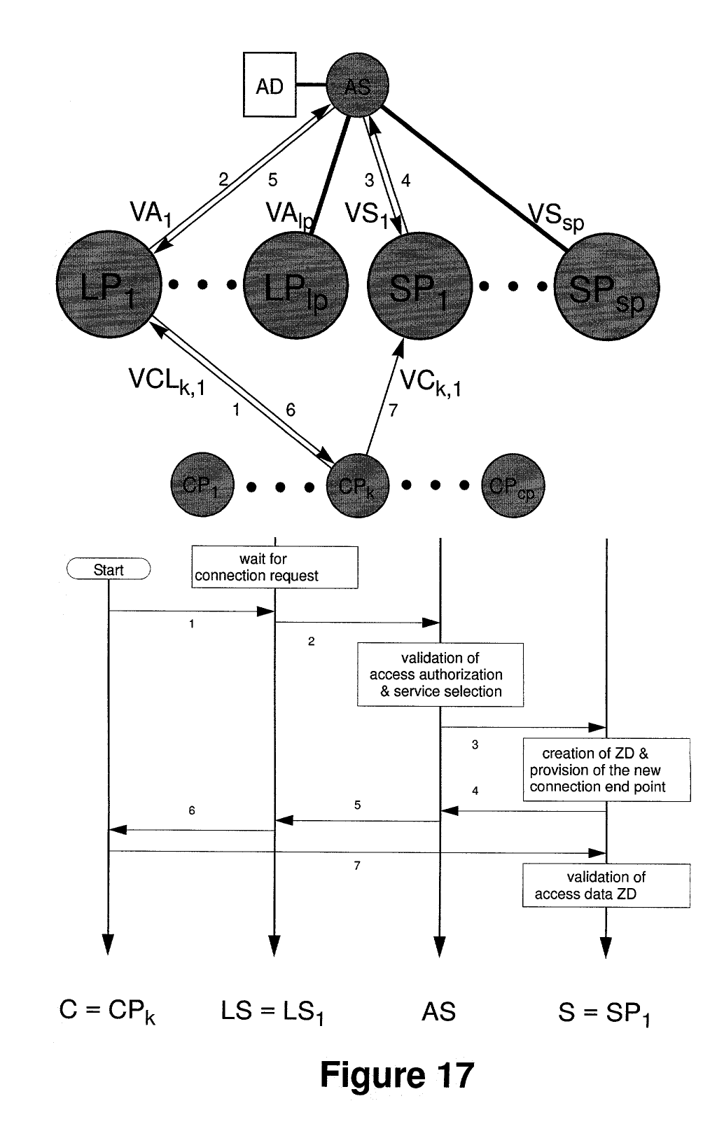

FIG. 17 illustrates a network with communication system according to claim 25 comprising Ip logon programs LP₁ to LP_{Ip}, an authorization service AS, sp service programs SP₁ to SPₛₚ and cp client programs CP₁ to CP_{cp}, where each logon program is connected with authorization service AS via an individual reliable standing logical bidirectional communication connection VA₁ to VA_{Ip}, authorization service AS is connected with each service via an individual reliable standing logical bidirectional communication connection VS₁ to VSₛₚ, and—after connection build-up between client C=CPₖ and logon service LS=LP₁—client C sends in message (1) logon data AMD to logon service LS, logon service LS forwards in message (2) logon data AMD to authorization service AS, authorization service AS—after a positive validation of logon data AMD against authorization data AD—selects service S=SP₁ out of service programs SP₁ to SPₛₚ, sends in message (3) request A to service S, to open a new connection endpoint for client C, service S creates access data ZD and sends in message (4) access data ZD to authorization service AS, authorization service AS forwards in message (5) access data ZD to logon service LS and logon service LS forwards in message (6) access data ZD to client C, such that service S can open in dependence of access data ZD a new connection endpoint VEPS for client C, client C can build-up connection VC_{k,1} to connection endpoint VEPS provided by service S, client C can send via connection VC_{k,1} in message (7) at least part TZD of access data ZD to service S, service S can validate part TZD of access data ZD received from client C against the own access data ZD, and service S can leave client C connected only after a positive result of said access data validation.

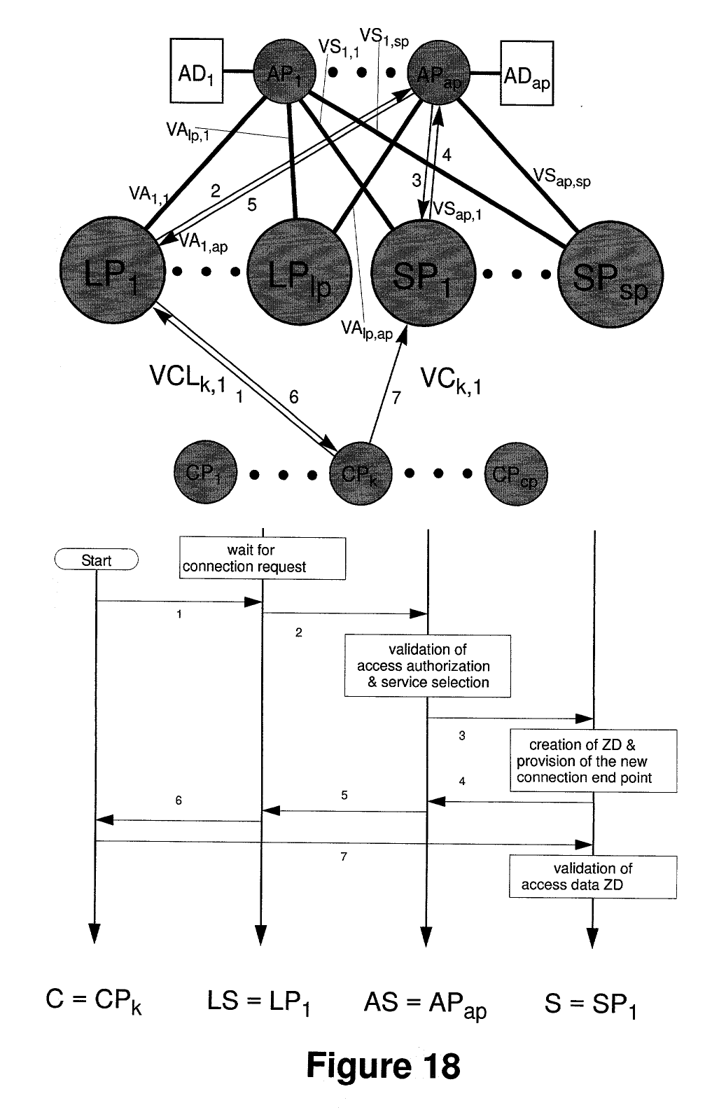

FIG. 18 illustrates a network with communication system according to claim 25 comprising Ip logon programs LP₁ to LP_{Ip}, ap authorization programs AP₁ to APₐₚ, sp service programs SP₁ to SPₛₚ and cp client programs CP₁ to CP_{cp}, where each logon program is connected with a subset of authorization programs AP₁ to APₐₚ via an individual reliable standing logical bidirectional communication connection VA_{1,1} to VA_{Ip,ap}, each authorization program is connected with a subset of service programs SP₁ to SPₛₚ via an individual standing logical bidirectional communication connection VS_{1,1} to VS_{ap,sp}, and—after connection build-up between client C=CPₖ and logon service LS=LP₁—client C sends in message (1) logon data AMD to logon service LS, logon service LS forwards in message (2) logon data AMD to authorization service AS=APₐₚ, authorization service AS—after a positive validation of logon data AMD against authorization data AD—selects service S=SP₁ out of service programs SP₁ to SPₛₚ, sends in message (3) request A to service S, to open a new connection endpoint for client C, service S creates access data ZD and sends in message (4) access data ZD to authorization service AS, authorization service AS forwards in message (5) access data ZD to logon service LS and logon service LS forwards in message (6) access data ZD to client C, such that service S can open in dependence of access data ZD a new connection endpoint VEPS for client C, client C can build-up connection VC_{k,1} to connection endpoint VEPS provided by service S, client C can send via connection VC_{k,1} in message (7) at least part TZD of access data ZD to service S, service S can validate part TZD of access data ZD received from client C against the own access data ZD, and service S can leave client C connected only after a positive result of said access data validation.

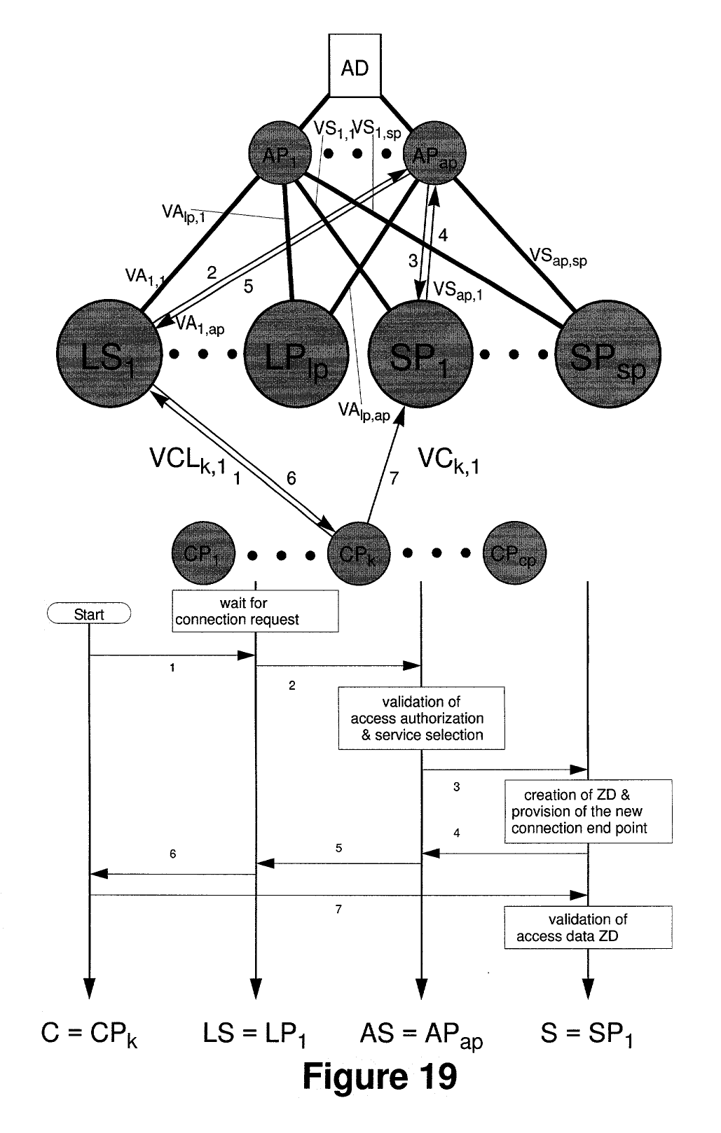

FIG. 19 shows the same system as FIG. 18 with the only difference, that all authorization programs AP₁ to APₐₚ have access to the same authorization data AD. This could be realized by a NFS network.

In all examples of FIGS. 9 to 19 is also possible, that—after establishment of connection VC—service S comprizes means to send via connection VC at least part TZD2 of access data ZD to client C, and that client C comprizes means to validate part TZD2 of access data ZD received from service S against access data ZD received from logon service LS and to leave service S connected only after a positive result of said access data validation.

After establishment of connection VC to service S, client C as well as service S can comprise means, to start a new thread for the communication with service S resp. client C and to handle all communication via connection VC asynchronously in the newly created thread.

In FIGS. 15 and 17 to 19 it is especially advantageous, to locate authorization service AS resp. authorization programs AP₁ to APₐₚ in analogy to FIGS. 5 and 8 in network segment N1, to locate all clients in network segment N completely separated from network segment N1, and not to physically route any messages between the two network segments N1 and N, such that no client has the technical possibility to get direct access to authorization data AD resp. AD₁ to ADₐₚ.

In claims 35 and 36 service S is protected by at least one local firewall LF running on service unit SE (claim 35) resp. by at least one firewall F located between the client and service units (claim 36).

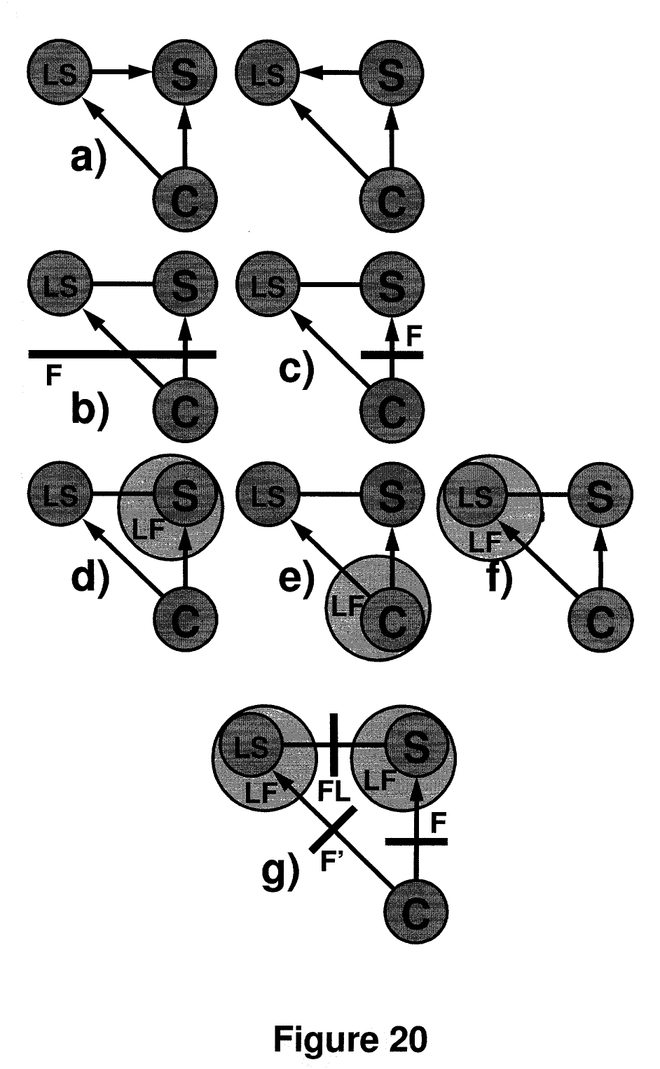

FIG. 20 illustrates different configuration possibilities to protect service S using firewalls or local firewalls in systems with direct connection between logon service LS and service S. These configurations can be easily modified to systems with indirect communication via authorization service AS between logon service and service S (not presented). Part a) summarizes the two base types, i.e. with connection build-up from logon service LS to service S as well as from service S to logon service LS. All other parts b) to g) can be applied to both base types, where it is sufficient, it local firewall LF (in parts d) to f)) resp. firewall FL (part g)) permit the build-up of connections only in the required direction(s). In part b) logon service LS and service S are running within the same network, which can be reached from client unit CE only via firewall F, where firewall F is configured in such a way, that client C can connect to logon service LS and to service S and communicate in both directions with logon service LS and service S. In part c) logon service LS and service S are running on units in different networks, such that client C can build-up connection VC to and communicate in both directions with the unprotected logon service LS and client C can reach service S only via firewall F, where firewall F is configured in such a way, that client C can build-up one connection to and communicate in both directions with service S. In part d) service S executing service unit SE also executes a local firewall LF, such that client C can build-up connection VC to and communicate in both directions with the unprotected logon service LS and client C can reach service S only via local firewall LF, where local firewall LF is configured in such a way, that client C can build-up one connection to and communicate in both directions with service S. In parts e) and f) client C resp. logon service LS are protected by local firewall LF. It is evident to a person skilled in the art, that depending on the architecture of the physical network and/or the configuration of the communication systems, other firewall configurations, than the explicitly mentioned, are also possible and covered by this patent. An example is the combination of different firewalls, as shown in part g), where logon service LS is additionally protected against client access by a separate firewall F′ and service S is additionally protected against unauthorized access from logon units by firewall FL.

If client C does not connect to the open connection endpoint VEPS provided by service S within a given time interval T, service S can close the opened connection endpoint VEPS after time interval T elapsed and reaches its previous closed state again (claim 37). The time limited provision of open connection endpoints assures, that an opened connection endpoint VEPS, by mistake, is not left permanently open and would become a permanently vulnerable point of the system.

In all systems according to claims 1 to 37 the connection build-up between client C and service S is initiated exclusively upon initiative of client C to an open connection endpoint VEPS provided by service S. Such systems have the disadvantages, that service S becomes visible for port scans during the time, in which connection endpoint VEPS is open and service S waits for the connection request from clients C, and that during this time service S could be attacked by unauthorized clients. Additional random keys serving as one-time tickets, which an authorized client has to present to service S during connection build-up, give service S the possibility to check the identity and prior authorization of a new client, but an attacker could potentially listen in and decrypt the communication to client C to obtain knowledge of said random keys/tickets. Nevertheless, the probability for such an attack to be successful is relatively low, because the attacker is left only a very short time interval before an authorized client C already connected to connection endpoint VEPS resp. service S closes connection endpoint VEPS. In systems according to claims 38 and 52 and according to claims dependent on one of the claims 38 and 52 the build-up of the connection VC between service S and client C is initiated exclusively upon initiative of service S to an open connection endpoint VEPC provided by client C. Such systems also offer the possibility for service S to initiate the connection to logon service LS resp. to authorization service AS, so that service S does not provide any open connection endpoint at any time. The differences between systems according to claim 38 and systems according to claim 52 are—in analogy to the differences between systems according to claims 1 and 15—only the direct resp. indirect via authorization service AS routed communication between logon service LS and service S.

Operative services providing at no time any open connection endpoint are at any time absolutely invisible for port scans. Systems according to one of the claims 38 and 52 guarantee, that no attacker, even with the knowledge of the physical address (like the IP-address) of service unit SE, is able to spy out at any time the existence of operative services using a port scan. In addition, systems according to one of the claims 38 and 52 offer the best possible protection against direct attacks of operative services, because it is technically impossible for any client to initiate the build-up of a direct connection to operative services and operative services control themselves, to which clients they connect.

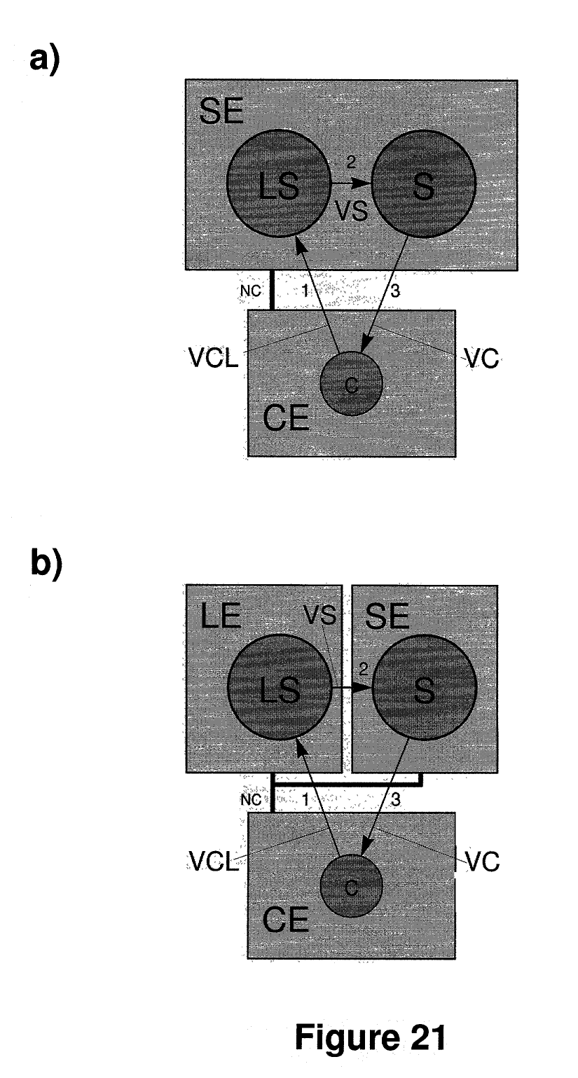

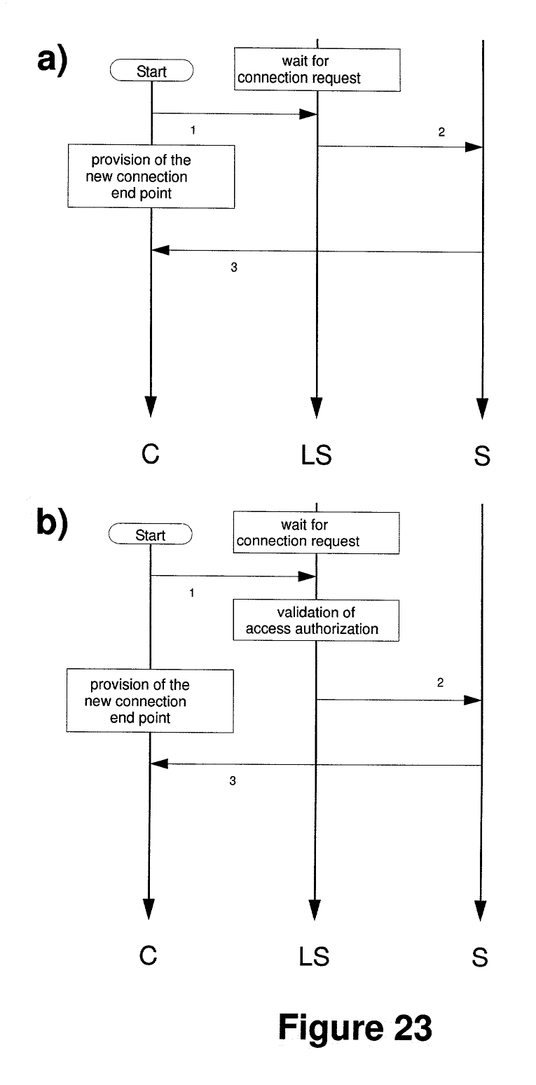

FIG. 21a illustrates a network with communication system according to claim 38 comprising a service unit SE executing logon service LS and service S, where logon service LS and service S are connected via a standing logical bidirectional connection VS, as well as comprising client unit CE connected via physical network connection NC with service unit SE and executing client C. FIG. 23a describes the timing of a connection build-up from client C to service S in the network with communication system according to claim 38, shown in FIG. 21a. Under normal operation service S does not provide any permanently open connection endpoints after establishment of connection VS, so that client C cannot directly connect to service S. Instead, logon service LS provides at least one open connection endpoint VEPCL for client C, such that client C—to build-up a connection to service S—initially is able only to connect to logon service LS and to transmit in message (1) connection parameters VP to logon service LS. Then client C opens at least one open connection endpoint VEPC for service S and can actually terminate connection VCL to logon service LS. After logon service LS accepted the connection request and received connection parameters VP from client C, logon service LS sends in message (2) via connection VS connection parameters VP together with request A, to buildup a connection to open connection endpoint VEPC provided by client C, to service S, whereupon service S receives connection parameters VP and connects in (3) to connection endpoint VEPC provided by client C.

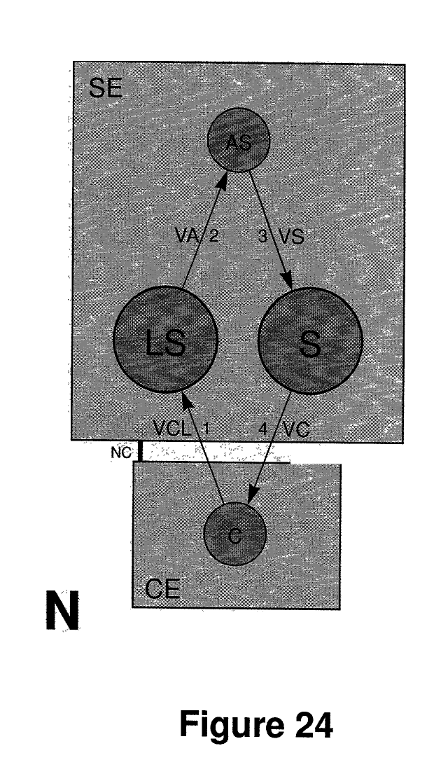

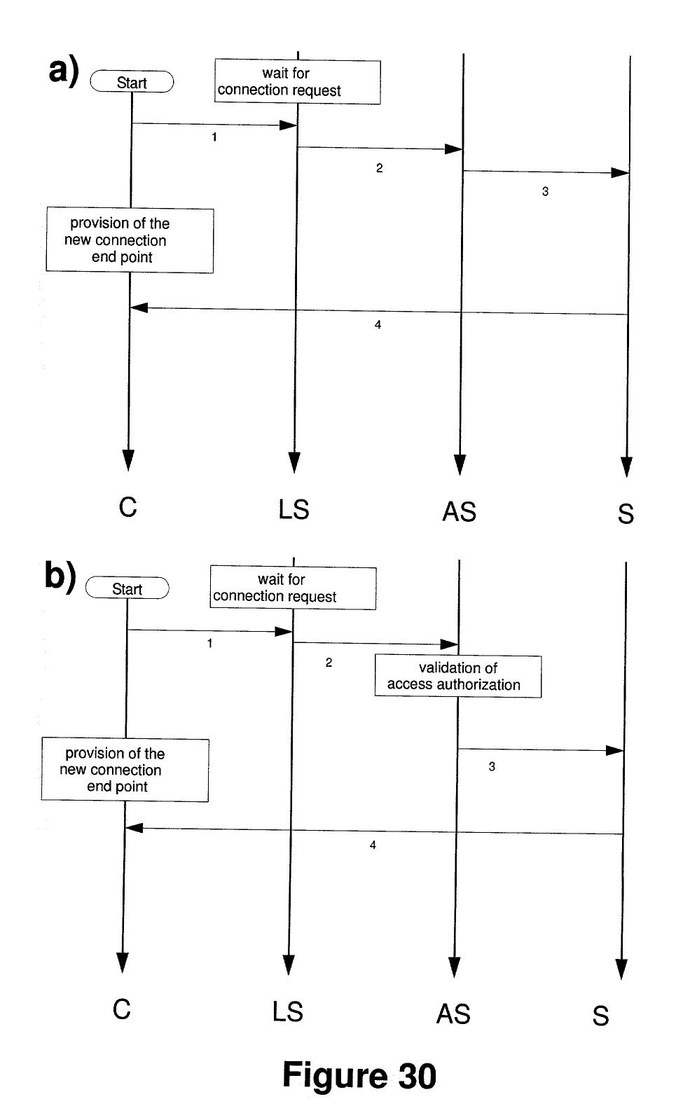

FIG. 24 illustrates a network with communication system according to claim 52 comprising a service unit SE connected via network N to a client unit CE, which service unit SE executes logon service LS, authorization service AS and service S, where authorization service AS and service S are connected via a standing logical bidirectional connection VS. FIG. 30a describes the timing of a connection build-up between client C and service S in the network with communication system according to claim 52, shown in FIG. 24. After establishment of connection VS service S does not provide under normal operation any permanently open connection endpoints, so that client C cannot directly connect to service S. Instead, logon service LS and authorization service AS are connected via reliable standing logical bidirectional communication connection VA or authorization service AS provides an open connection endpoint for logon service LS allowing logon service LS to connect to authorization service AS upon demand. In addition, logon service LS provides at least one open connection endpoint VEPCL for client C, such that client C—to build-up a connection to service S—initially is able only to connect to logon service LS and to transmit in message (1) connection parameters VP to logon service LS. Then client C opens at least one open connection endpoint VEPC for service S and can actually terminate connection VCL to logon service LS. After logon service LS accepted the connection request and received connection parameters VP from client C, logon service LS—if no connection VA to authorization service AS exists—builds-up connection VA to authorization service AS and sends in message (2) authorization service AS via connection VA connection parameters VP together with a notification, that client C requests to establish a connection to services, authorization service AS sends in message (3) via connection VS connection parameters VP together with a request, to connect to connection endpoint VEPC provided by client C, to service S, whereupon service S receives connection parameters VP and builds-up connection VC to connection endpoint VEPC provided by client C.

It is obvious for a reader skilled in the art, that the different programs logon service LS, authorization service AS and/or service S can be distributed on a single or multiple units—an example is given explicitly in claims 39 resp. 53—, as long as logon service LS and service S are reachable at least from client C and at least connection VS between logon service LS and service S resp. connection VA between logon service LS and authorization service AS and connection VS between authorization service AS and service S can be established.

Claims 38, 39, 52 and 53 obviously also cover the cases, in which

1. logon programs LP₁, . . . , LP_{Ip} comprise more than one logon service LS₁, . . . , LS_{Is}, and/or

2. service programs SP₁, . . . , SPₛₚ comprise more than one service S₁, . . . , Sₛ, and/or

3. authorization programs AP₁, . . . , APₐₚ comprise more than one authorization service AS₁, . . . , ASₐₛ, and/or

4. client programs CP₁, . . . , CPcp comprise more than one client C₁, . . . , C_{c}

and said programs LS₁, . . . , LS_{Is}, S₁, . . . , Sₛ, AS₁, . . . , ASₐₛ, C₁, . . . , C_{c} are executed on their respective units.

FIG. 21b illustrates the same network with communication system shown in FIG. 21a with the differences, that logon service LS is running on unit LE and service S is running on unit SE, and that all units are physically connected via network connection NC.

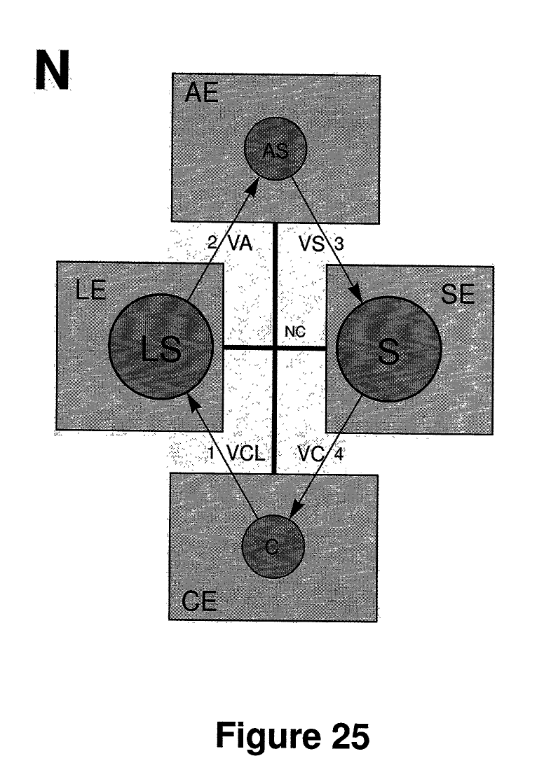

Also in a network with communication system according to claim 52, shown in FIG. 24, programs authorization service AS, logon service LS and service S may be running on different units, as long as logon service LS and service S can be reached from client C and connections VA between logon service LS and authorization service AS as well as VS between authorization service AS and service S can be established. FIG. 25 shows the same system as FIG. 24 with the difference, that logon service LS, authorization service AS and service S are running on a different unit LE, AE resp. SE, and that all units are physically connected via network connection NC.

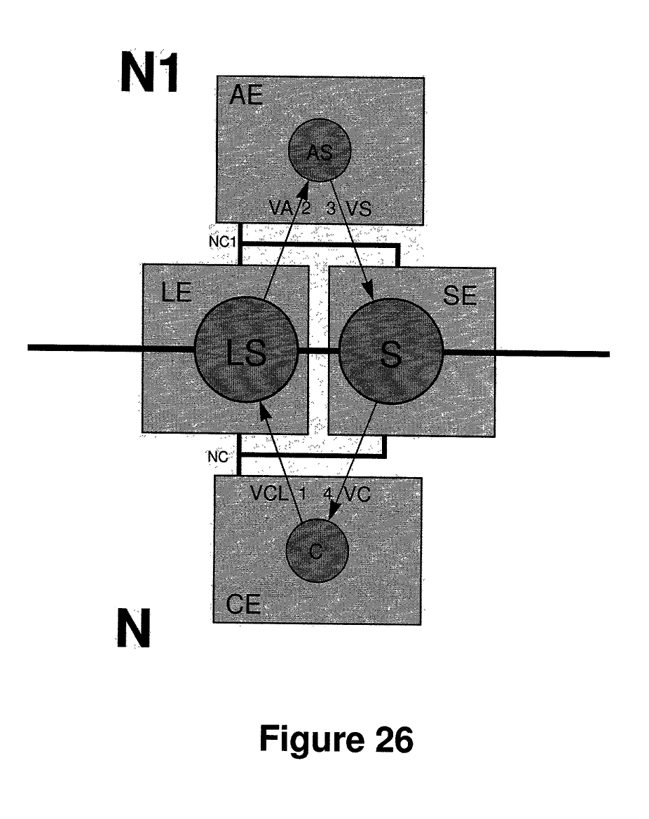

It is very advantageous to divide a network with communication system according to claim 53 into two different physical network segments N and N1 (FIG. 26), where units LE and SE each comprise at least two network interfaces, where one of each pair is connected with segment N and the other with segment N1, and where authorization unit AE is located in segment N1 and client unit CE is located in segment N, and where no messages are physically routed between network segments N1 and N. This prohibits client programs on CE to attack authorization unit AE directly.

In permanent available systems clients have to be able to reach at least logon service LS at any time, so that logon unit LE executing logon service LS can always be attacked. Therefore it is advantageous in a system according to one of the claims 39 resp. 53 to execute logon service LS on a separate logon unit LE, to guarantee, that in case of an attack on logon unit LE, neither authorization service AS nor service S are directly affected.

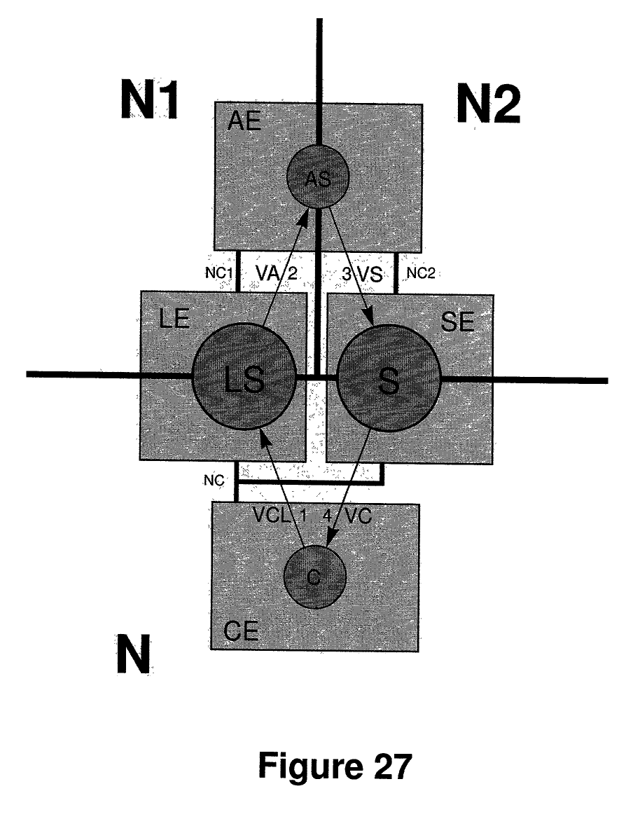

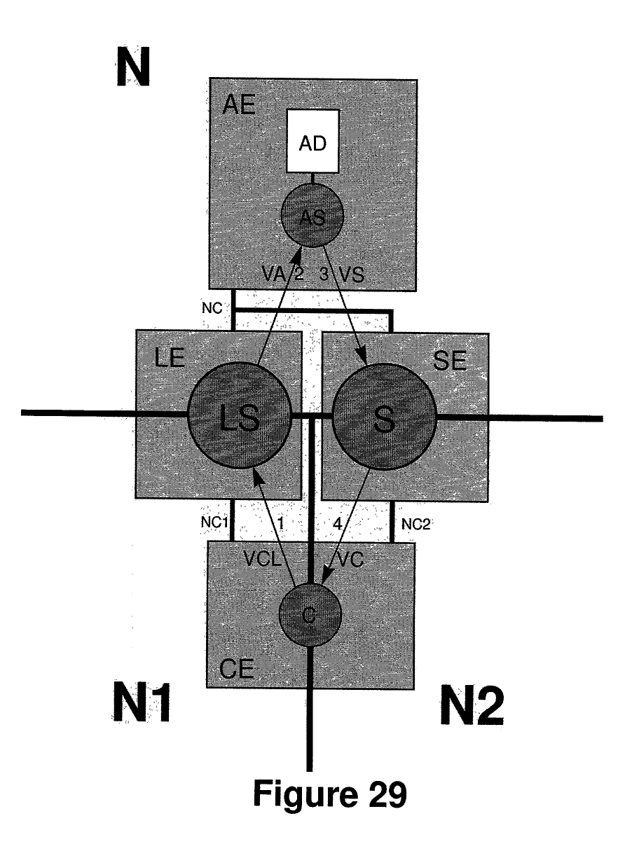

Another possibility is to connect authorization unit AE (FIG. 27) or client unit CE (FIG. 29) via at least two network interfaces with at least two different networks (N1 and N2). An advantage of a configuration according to FIG. 29 is, that the access paths from client C to service S and to logon service LS are completely independent from each other and can be protected separately—for example by two differently configured firewalls.

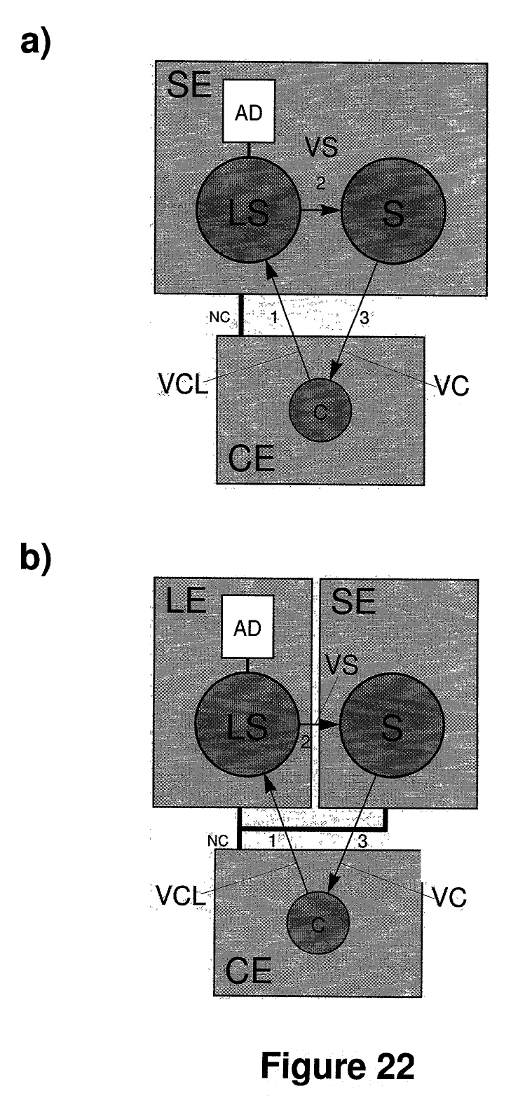

In claims 40 resp. 54 logon service LS resp. authorization service AS have access to authorization data AD, such that in claim 40 logon service LS can validate logon data AMD sent by client C in message (1) of FIG. 23b resp. FIG. 22a/b and logon service LS sends request A (2), to connect to the open connection endpoint VEPC provided by client C, to service S only after a positive validation of logon data AMD presented by client C against authorization data AD, and such that in claim 54 authorization service AS can validate logon data AMD send by client C in message (1) of FIG. 30b resp. FIGS. 26 to 29 to logon service LS and forwarded by logon service LS in message (2) to authorization service AS and authorization service AS sends request A (3), to connect to the open connection endpoint VEPC provided by client C, to service S only after a positive validation of logon data AMD presented by client C against authorization data AD. In this way client C has no possibility to establish a connection between himself and service S without prior validation of his access rights, where claim 54 is to be given preference before claim 40, since authorization service AS and authorization data AD are running resp. stored on a separate unit AE, which unit AE cannot be reached from-any client (FIGS. 26 to 29), while authorization data AD in claim 40 has to be stored on the same unit LE, which also executes logon service LS (FIG. 22a/b).

Claims 41 and 55 cover the cases, in which at least one part of logon data AMD is transmitted in an encrypted format from client C to logon service LS and is decrypted by logon service LS (claim 41), as well as from client C via logon service LS to authorization service AS and decrypted by authorization service AS (claim 55).

In networks with communication systems according to claims 38 to 41 and 52 to 55 based on TCP/IP the access data—in particular the physical address (IP-address) of the unit executing client C as well as the local identification (port) of the connection endpoint VEPC provided by client C for service S—are fix and have to be known by service S to allow service S to connect to connection endpoint VEPC provided by client C. Such systems are at risk, that an unauthorized attacker acquires knowledge of said access data and connects to connection endpoint VEPC provided by client C, before service S actually can connect to connection endpoint VEPC provided by client C.

This disadvantage is removed in networks with communication systems according to claim 42 resp. 56, in which service S initially does not know access data ZD and receives ZD only during the course of the logon procedure from logon service LS resp. authorization service AS. In systems according to claim 42 parts of the access data ZD can be created by logon service LS (claim 43), service S (claim 44) or client C (claim 45), and in systems according to claim 56 by logon service LS (claim 57), authorization service AS (claim 58), service S (claim 59) or client C (claim 60), and—if any part of access data ZD has not been created by service S—be transmitted via the existing communication connections VS, VA and VCL directly or indirectly to service S, and—if any part of access data ZD has not been created by client C—also to client C. It is only important, that client C, before opening the new connection endpoint VEPC, as well as service S, before connecting to connection endpoint VEPC provided by client C, know the respectively required part of access data ZD.

In networks with communication systems according to claim 42 resp. 56 it is of further advantage,

1. to select one of multiple service units executing at least one service according to claim 38 resp. 52 and to transmit the physical address of the selected service unit within access data ZD to client C, where the selection can be performed by a logon service (claims 46 and 61) or an authorization service (claim 62),

2. to select an arbitrary local identification LK for the connection endpoint VEPC to be provided by client C for service S, and to send local identification LK, if the selection was not performed by client C, to client C and, if the selection was not performed by service S, also to service S (claims 47 to 49 and 63 to 66).

3. to transmit at least part VTZD of access data ZD in an encrypted format from logon service LS to client C (claims 50 and 67). Of cause, in this case client C has to comprise additional means, to decrypt the encrypted part VTZD of access data ZD.

4. to transmit at least part VTZD2 of access data ZD in an encrypted format from logon service LS (claim 51) or authorization service AS (claim 68) to service S. Of cause, in this case service S has to comprise additional means, to decrypt the encrypted part VTZD2 of access data ZD.

5. to transmit an arbitrary selected key within access data ZD, if the selection was not performed by service S, to service S (claim 69) and, if the selection was not performed by client C, to client C (claim 70),

6. to create at least part TZD of access data ZD—in particular, but not exclusively, the service unit SE executing service S, the port of the open connection endpoint VEPC to be provided by client C for service S, or the key ZSS resp. ZSC—pseudo or absolutely randomly (claim 71).

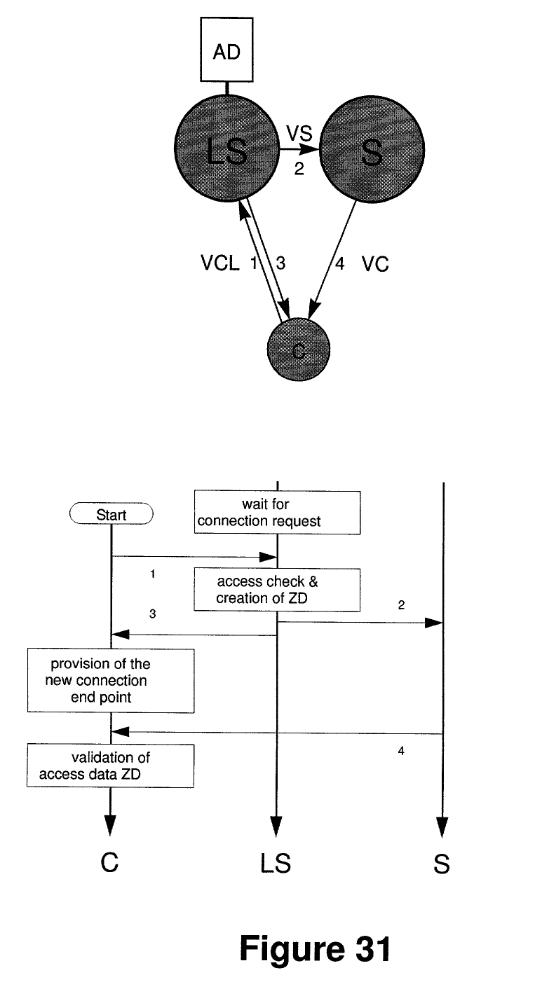

FIGS. 31 to 41 illustrate different incarnation examples of networks with communication systems according to claims 38 to 71 with corresponding timing diagrams of the connection build-up between client C and service S, where logon service LS, authorization service AS, service S and client C can be distributed arbitrarily on the underlying network units, as long as the required connections can be established and the programs can communicate as described. Therefore the underlying physical network units and connections are omitted in FIGS. 31 to 41. After establishment of connection VC service S transmits in the given examples at least one part TZD of access data ZD to client C, so that client C is able to validate part TZD of access data ZD received from service S against access data ZD. This validation can also be performed in reverse direction, if—after establishment of connection VC client C transmits at least one part TZD2 of access data ZD to service S, to that service S is able to validate part TZD2 of access data ZD received from client C against access data ZD. Both validations are not necessarily required, but increase the system security, because service S has to authenticate himself versus client C resp. client C has to authenticate himself versus service S to proof the identity of service S and that client C successfully passed through the logon procedure.

FIG. 31 illustrates a network with communication system according to claim 43, in which—after connection build-up between client C and logon service LS—client C sends in message (1) logon data AMD to logon service LS, logon service LS—after a positive validation of logon data AMD against authorization data AD—creates access data ZD, sends in message (2) access data ZD together with request A, to connect to connection endpoint VEPC provided by client C, to service S and sends in message (3) access data ZD to client C, such that client C can provide in dependence of access data ZD a new connection endpoint VEPC for service S, service S can build-up connection VC to connection endpoint VEPC provided by client C, service S can send via connection VC in message (4) at least part TZD of access data ZD to client C, client C can validate part TZD of access data ZD received from service S against access data ZD received from logon service LS, and client C can leave service S connected only after a positive result of said access data validation.

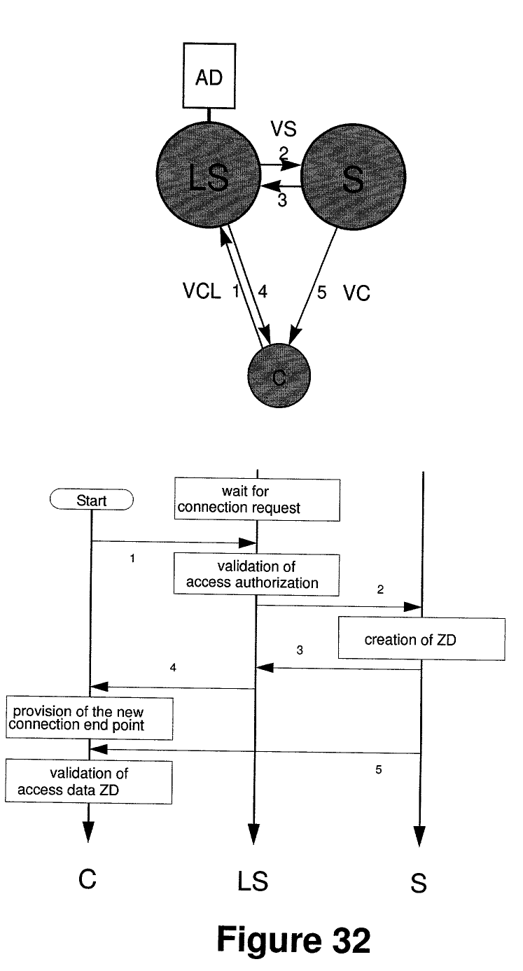

FIG. 32 illustrates a network with communication system according to claim 44, in which—after connection build-up between client C and logon service LS—client C sends in message (1) logon data AMD to logon service LS, logon service LS—after a positive validation of logon data AMD against authorization data AD—sends in message (2) request A, to connect to connection endpoint VEPC provided by client C, to service S, service S creates access data ZD and sends in message (3) access data ZD to logon service LS, logon service LS forwards in message (4) access data ZD received from service S to client C, such that client C can provide in dependence of access data ZD a new connection endpoint VEPC for service S, service S can build-up connection VC to connection endpoint VEPC provided by client C, service S can send via connection VC in message (5) at least part TZD of access data ZD to client C, client C can validate part TZD of access data ZD received directly from service S against access data ZD received from service S via logon service LS, and client C can leave service S connected only after a positive result of said access data validation.

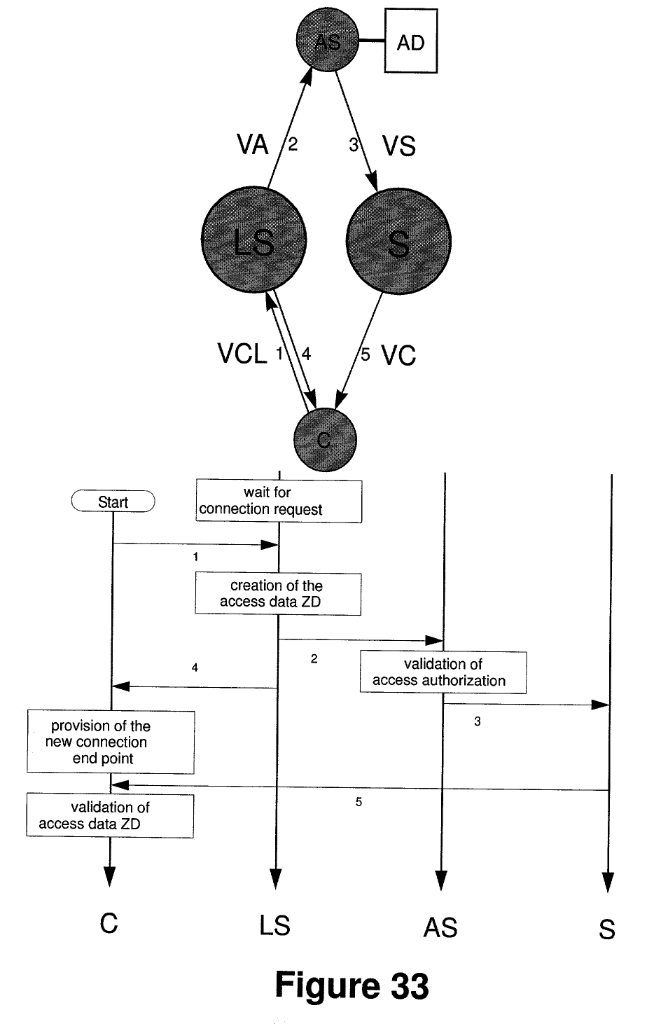

FIG. 33 illustrates a network with communication system according to claim 57, in which—after connection build-up between client C and logon service LS—client C sends in message (1) logon data AMD to logon service LS, logon service LS creates access data ZD and sends in message (2) access data ZD together with logon data AMD to authorization service AS, authorization service AS—after a positive validation of logon data AMD against authorization data AD—sends in message (3) access data ZD together with request A, to connect to connection endpoint VEPC provided by client C, to service S and logon service LS sends in message (4) access data ZD to client C, such that client C can provide in dependence of access data ZD a new connection endpoint VEPC for service S, service S can build-up connection VC to connection endpoint VEPC provided by client C, service S can send via connection VC in message (5) at least part TZD of access data ZD to client C, client C can validate part TZD of access data ZD received from service S against access data ZD received from logon service LS, and client C can leave service S connected only after a positive result of said access data validation.

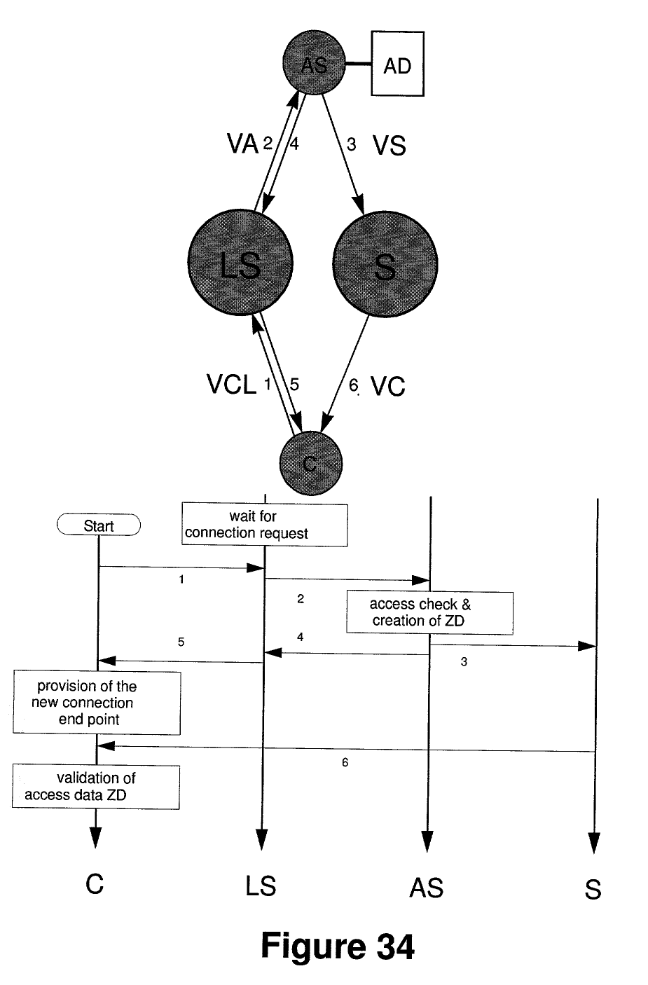

FIG. 34 illustrates a network with communication system according to claim 58, in which—after connection build-up between client C and logon service LS—client C sends in message (1) logon data AMD to logon service LS, logon service LS forwards in message (2) logon data AMD to authorization service AS, authorization service AS—after a positive validation of logon data AMD against authorization data AD—creates access data ZD and sends in message (3) access data ZD together with request A, to connect to connection endpoint VEPC provided by client C, to service S and sends in message (4) access data ZD to logon service LS, logon service LS forwards in message (5) access data ZD to client C, such that client C can provide in dependence of access data ZD a new connection endpoint VEPC for service S, service S can build-up connection VC to connection endpoint VEPC provided by client C, service S can send via connection VC in message (6) at least part TZD of access data ZD to client C, client C can validate part TZD of access data ZD received from service S against access data ZD received from authorization service AS via logon service LS, and client C can leave service S connected only after a positive result of said access data validation.

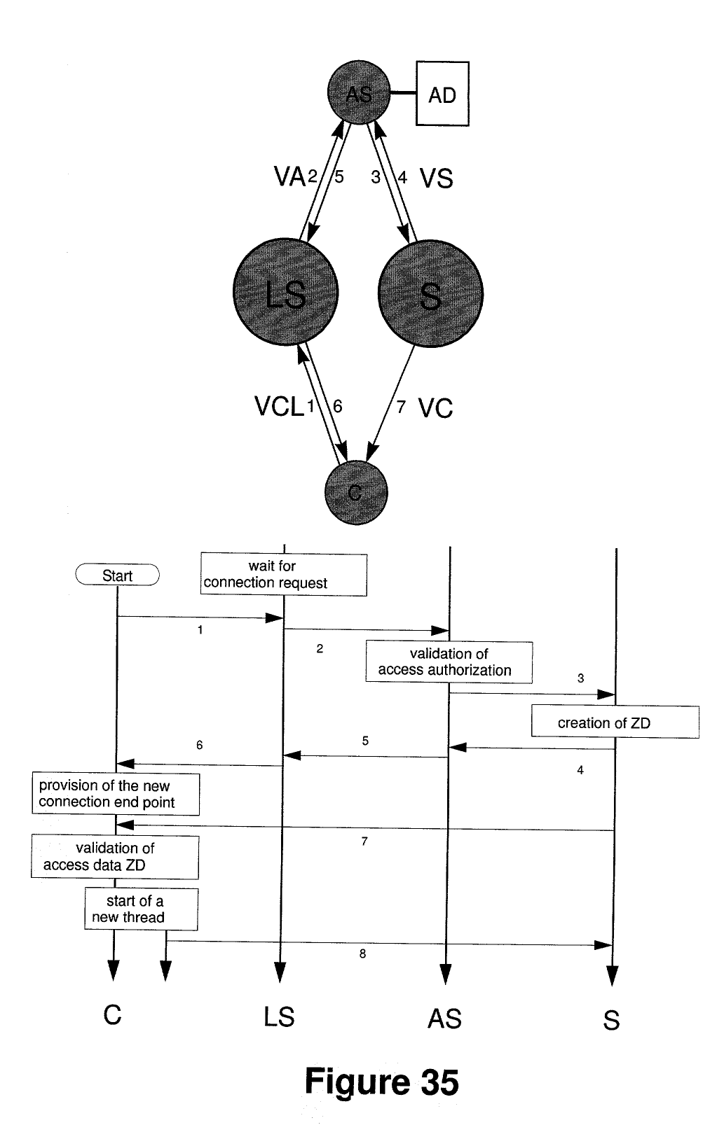

FIG. 35 illustrates a network with communication system according to claim 59, in which—after connection build-up between client C and logon service LS—client C sends in message (1) logon data AMD to logon service LS, logon service LS forwards in message (2) logon data AMD to authorization service AS, authorization service AS—after a positive validation of logon data AMD against authorization data AD—sends in message (3) request A, to connect to connection endpoint VEPC provided by client C, to service S, service S creates access data ZD and sends in message (4) access data ZD to authorization service AS, authorization service AS forwards in message (5) access data ZD to logon service LS and logon service LS forwards in message (6) access data ZD to client C, such that client C can provide in dependence of access data ZD a new connection endpoint VEPC for service S, service S can build-up connection VC to connection endpoint VEPC provided by client C, service S can send via connection VC in message (7) at least part TZD of access data ZD to client C, client C can validate part TZD of access data ZD received directly from service S against access data ZD received from service S via authorization service AS and logon service LS, and client C can leave service S connected only after a positive result of said access data validation. After a positive validation client C creates in this example a new thread to communicate with service S and acknowledges service S in message (8) the acceptance of the connection.

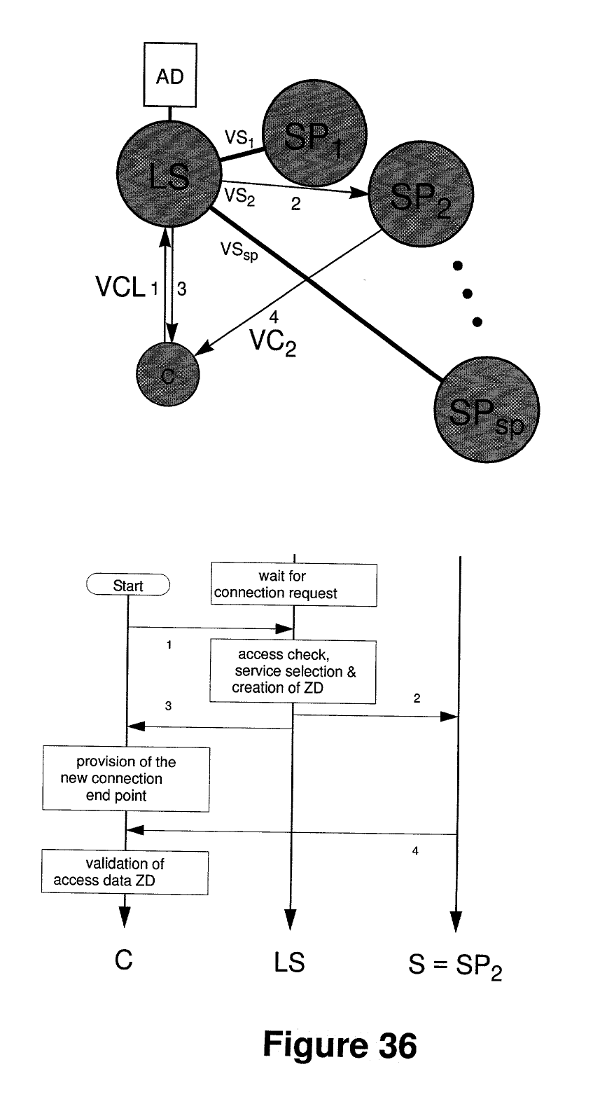

FIG. 36 illustrates a network with communication system according to claim 46 comprising a logon service LS and sp service programs SP₁ to SPₛₚ, where logon service LS is connected with each service program via an individual reliable standing logical bidirectional communication connection VS₁ to VSₛₚ and—after connection build-up between client C and logon service LS—client C sends in message (1) logon data AMD to logon service LS, logon service LS—after a positive validation of logon data AMD against authorization data AD—selects service S=SP₂ out of service programs SP₁ to SPₛₚ, creates access data ZD and sends in message (2) access data ZD together with request A, to connect to connection endpoint VEPC provided by client C, to service S, and sends in message (3) access data ZD to client C, such that client C can provide in dependence of access data ZD a new connection endpoint VEPC for service S, service S can buildup connection VC₂ to connection endpoint VEPC provided by client C, service S can send via connection VC₂ in message (4) at least part TZD of access data ZD to client C, client C can validate part TZD of access data ZD received from service S against access data ZD received from logon service LS, and client C can leave service S connected only after a positive result of said access data validation.

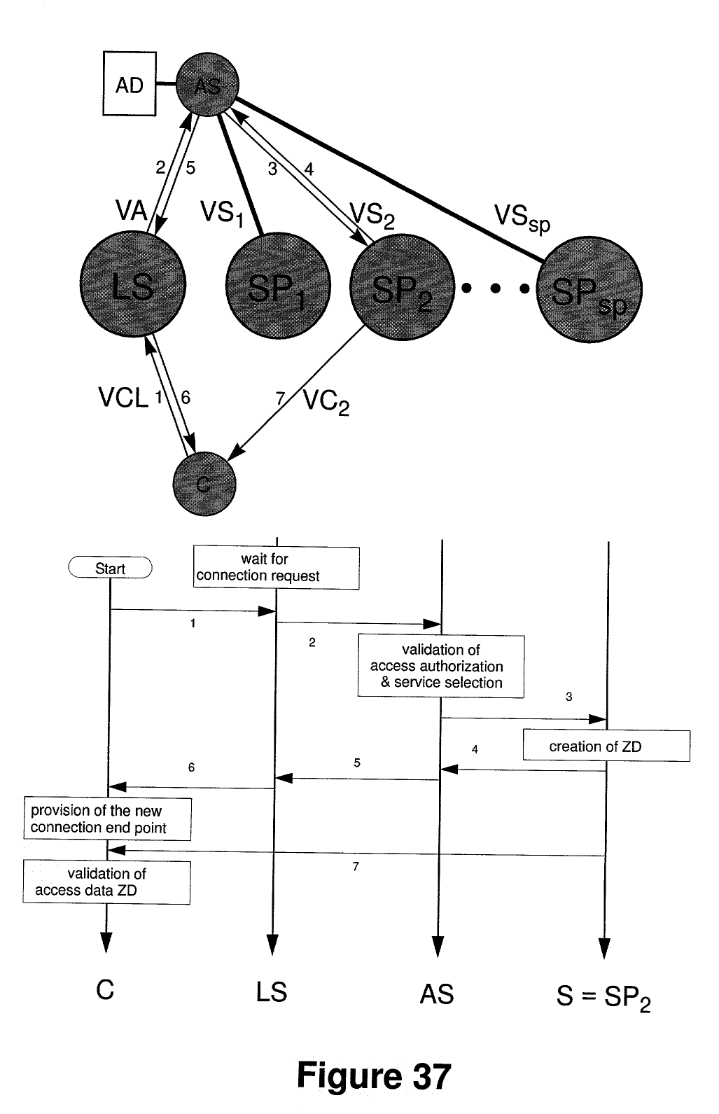

FIG. 37 illustrates a network with communication system according to claim 62 comprising a logon service LS, an authorization service AS and sp service programs SP₁ to SPₛₚ, where logon service LS is connected via reliable standing logical bidirectional communication connection VA with authorization service AS and authorization service AS is connected with each of the service programs via an individual standing logical bidirectional communication connection VS₁ to VSₛₚ and—after connection build-up between client C and logon service LS—client C sends in message (1) logon data AMD to logon service LS, logon service LS forwards in message (2) logon data AMD to authorization service AS, authorization service AS—after a positive validation of logon data AMD against authorization data AD—selects service S=SP₂ out of service programs SP₁ to SPₛₚ and sends in message (3) request A, to connect to connection endpoint VEPC provided by client C, to service S, service S creates access data ZD and sends in message (4) access data ZD to authorization service AS, authorization service AS forwards in message (5) access data ZD to logon service LS and logon service LS forwards in message (6) access data ZD to client C, such that client C can provide in dependence of access data ZD a new connection endpoint VEPC for service S, service S can buildup connection VC₂ to connection endpoint VEPC provided by client C, service S can send via connection VC₂ in message (7) at least part TZD of access data ZD to client C, client C can validate part TZD of access data ZD received directly from service S against access data ZD received from service S via authorization service AS and logon service LS, and client C can leave service S connected only after a positive result of said access data validation.

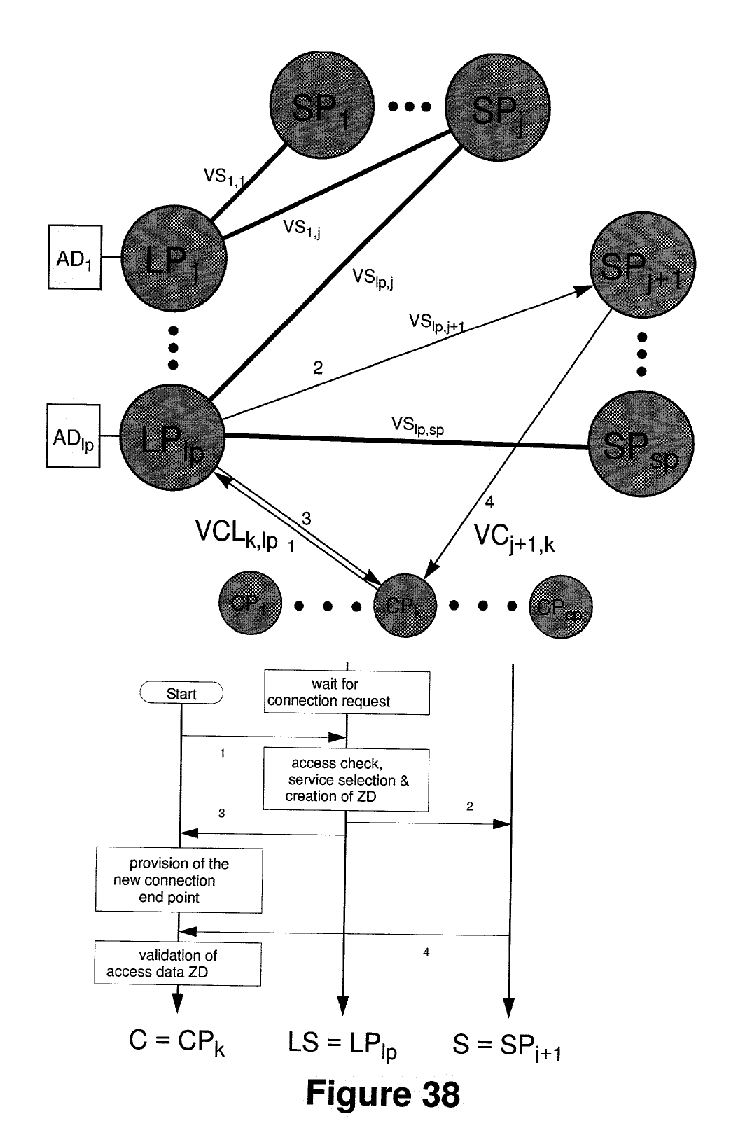

FIG. 38 illustrates a network with communication system according to claim 46 comprising cp client programs CP₁ to CP_{cp}, Ip logon programs LP₁ to LP_{Ip} and sp service programs SP₁ to SPₛₚ, where each logon program is connected with a subset of the service programs SP₁ to SPₛₚ via an individual reliable standing logical bidirectional communication connection VS_{1,1} to VS_{Ip,sp}, and—after connection build-up between client C=CPₖ and logon service LS=LP_{Ip}—client C sends in message (1) logon data AMD to logon service LS, logon service LS—after a positive validation of logon data AMD against authorization data AD—selects service S=SPⱼ₊₁ out of service programs SP₁ to SPₛₚ, creates access data ZD, sends in message (2) access data ZD together with request A, to connect to connection endpoint VEPC provided by client C, to service S, and sends in message (3) access data ZD to client C, such that client C can provide in dependence of access data ZD a new connection endpoint VEPC for service S, service S can build-up connection VC_{j+1,k} to connection endpoint VEPC provided by client C, service S can send via connection VC_{j+1,k} in message (4) at least part TZD of access data ZD to client C, client C can validate part TZD of access data ZD received from service S against access data ZD received from logon service LS, and client C can leave service S connected only after a positive result of said access data validation.

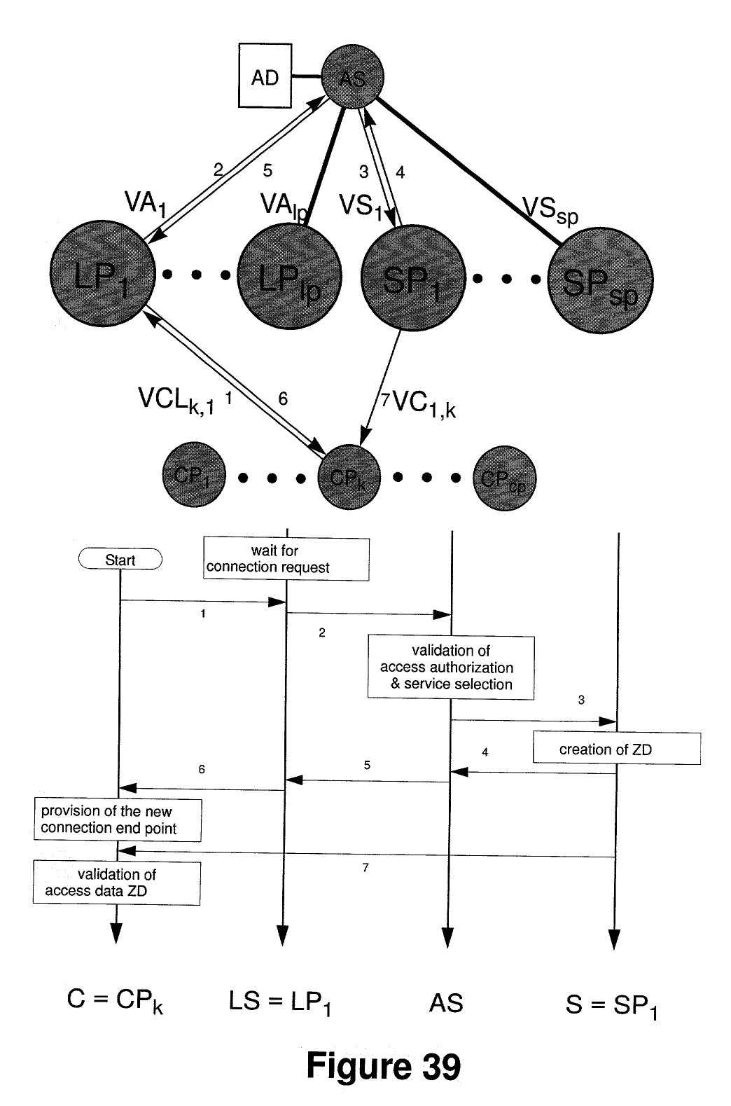

FIG. 39 illustrates a network with communication system according to claim 62 comprising cp client programs CP₁ to CP_{cp}, Ip logon programs LP₁ to LP_{Ip}, an authorization service AS and sp service programs SP₁ to SPₛₚ, where each logon program is connected with authorization service AS via an individual reliable standing logical bidirectional communication connection VA₁ to VA_{Ip}, authorization service AS is connected with each of the service programs via an individual reliable standing logical bidirectional communication connection VS₁ to VSₛₚ, and—after connection build-up between client C=CPₖ and logon service LS=LP₁—client C sends in message (1) logon data AMD to logon service LS, logon service LS forwards in message (2) logon data AMD to authorization service AS, authorization service AS—after a positive validation of logon data AMD against authorization data AD—selects service S=SP₁ out of service programs SP₁ to SPₛₚ and sends in message (3) request A, to connect to connection endpoint VEPC provided by client C, to service S, service S creates access data ZD and sends in message (4) access data ZD to authorization service AS, authorization service AS forwards in message (5) access data ZD to logon service LS and logon service LS forwards in message (6) access data ZD to client C, such that client C can provide in dependence of access data ZD a new connection endpoint VEPC for service S, service S can buildup connection VC_{1,k} to connection endpoint VEPC provided by client C, service S can send via connection VC_{1,k} in message (7) at least part TZD of access data ZD to client C, client C can validate part TZD of access data ZD received directly from service S against access data ZD received from service S via authorization service AS and logon service LS, and client C can leave service S connected only after a positive result of said access data validation.

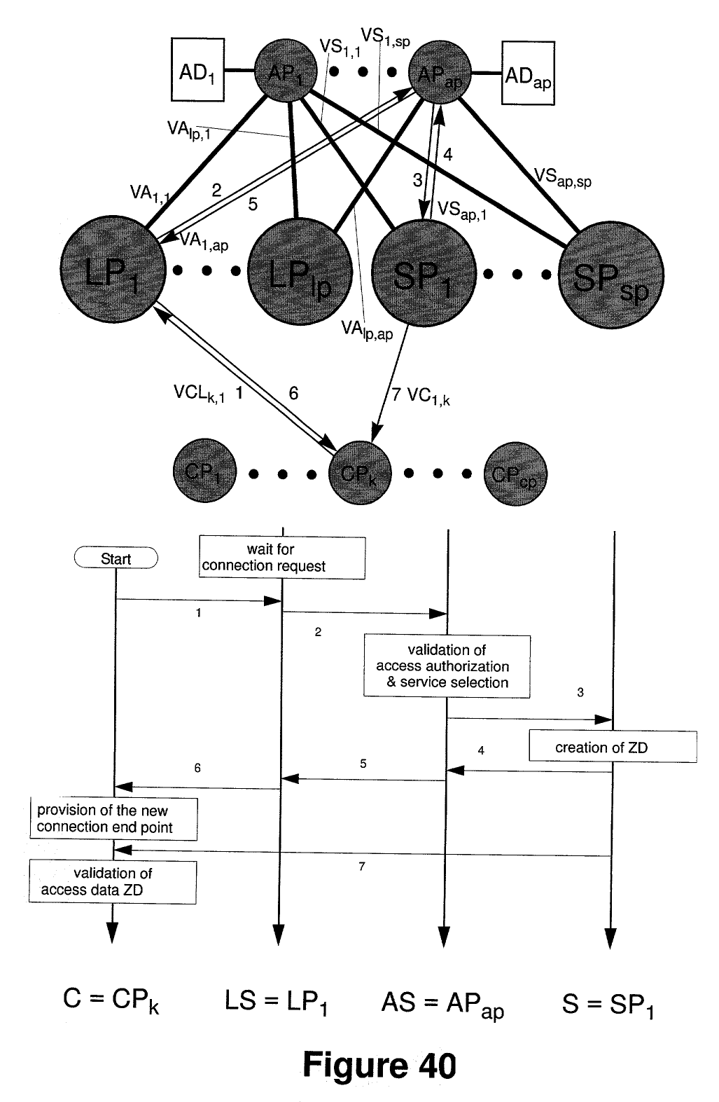

FIG. 40 illustrates a network with communication system according to claim 62 comprising cp client programs CP₁ to CP_{cp}, Ip logon programs LP₁ to LP_{Ip}, ap authorization programs AP₁ to APₐₚ and sp service programs SP₁ to SPₛₚ, where each logon program is connected with a subset of authorization programs AP₁ to APₐₚ via an individual reliable standing logical bidirectional communication connection VA_{1,1} to VA_{Ip,ap}, each authorization program is connected with a subset of service programs SP₁ to SPₛₚ via an individual reliable standing logical bidirectional communication connection VS_{1,1} to VS_{ap,sp}, and—after connection build-up between client C=CPₖ and logon service LS=LP₁—client C sends in message (1) logon data AMD to logon service LS, logon service LS forwards in message (2) logon data AMD to authorization service AS=APₐₚ, authorization service AS—after a positive validation of logon data AMD against authorization data AD—selects service S=SP₁ out of service programs SP₁ to SPₛₚ and sends in message (3) request A, to connect to connection endpoint VEPC provided by client C, to service S, service S creates access data ZD and sends in message (4) access data ZD to authorization service AS, authorization service AS forwards in message (5) access data ZD to logon service LS and logon service LS forwards in message (6) access data ZD to client C, such that client C can provide in dependence of access data ZD a new connection endpoint VEPC for service S, service S can build-up connection VC_{1,k} to connection endpoint VEPC provided by client C, service S can send via connection VC_{1,k} in message (7) at least part TZD of access data ZD to client C, and client C can validate part TZD of access data ZD received directly from service S against access data ZD received from service S via authorization service AS and logon service LS, and client C can leave service S connected only after a positive result of said access data validation.

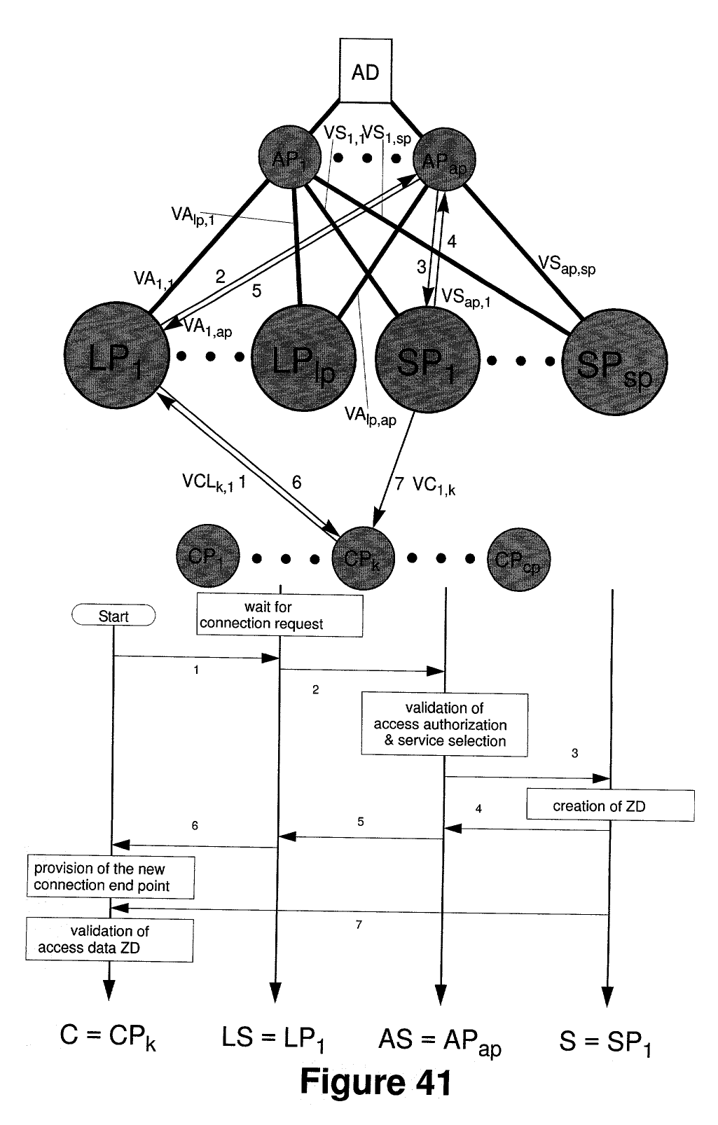

FIG. 41 shows the same system as FIG. 40 with the difference, that all authorization programs AP₁ to APₐₚ have access to the same authorization data AD. This could be realized by a NFS network.

In all examples of FIGS. 31 to 41 it is also possible, that client C—after build-up of connection VC—comprizes means to send via connection VC at least part TZD2 of access data ZD to service S, and service S comprises means to validate part TZD2 of access data ZD received from client C against access data ZD received from logon service LS and/or authorization service AS and to leave client C connected only after a positive result of said access data validation.

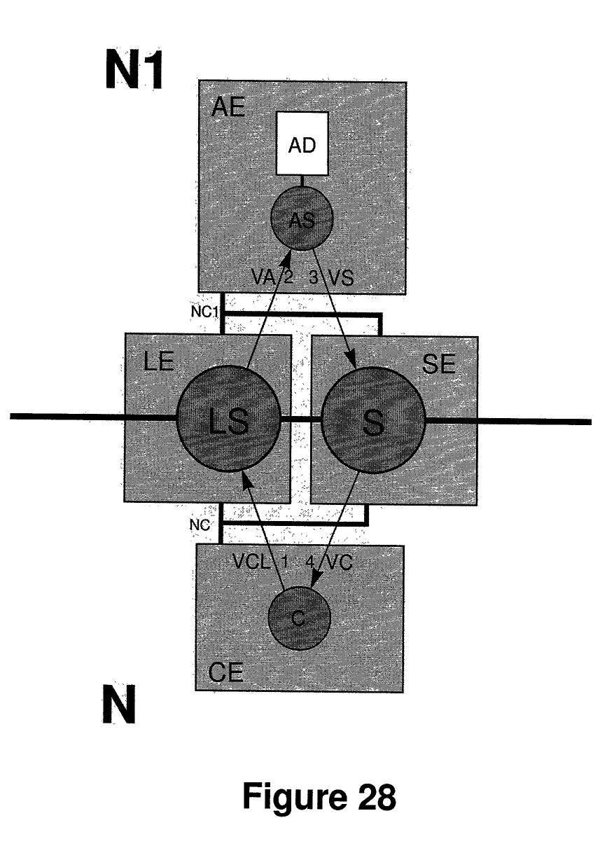

After establishment of connection VC client C as well as service S may comprise additional means to start a new thread for the communication with service S resp. client C and to handle the communication via connection VC asynchronously in the new thread. In FIGS. 37 and 39 to 41 it is especially advantageous, to locate authorization service AS resp. authorization programs AP₁ to APₐₚ in analogy to FIG. 28 in network segment N1, to locate all clients in network segment N completely separated from network segment N1, and not to physically route any messages between the two network segments N1 and N, such that no client has the technical possibility to get direct access to authorization data AD resp. AD₁ to ADₐₚ.

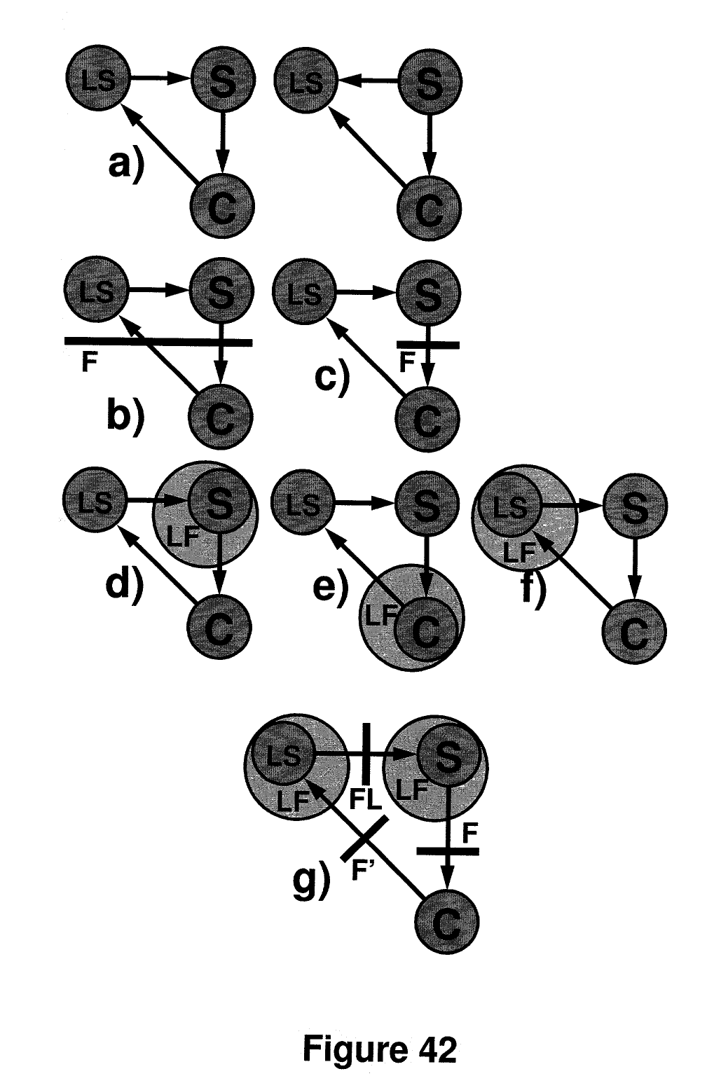

In claims 72 and 73 service S is protected by at least one local firewall LF executed on service unit SE (claim 72) resp. by at least one firewall F located between client units and service units (claim 73). FIG. 42 illustrates different configuration possibilities to protect service S using firewalls or local firewalls in systems with direct connection between logon service LS and service S. These configurations can be easily modified to systems with indirect communication via authorization service AS between logon service and service S (not presented). Part a) summarizes the two base types, i.e. with connection build-up from logon service LS to service S as well as from service S to logon service LS. All other parts b) to g) can be applied to both base types, where it is sufficient, if local firewall LF (in parts d) to f)) resp. firewall FL (part g)) permit the build-up of connections only in the required direction. In part b) logon service LS and service S are running within the same network, which can be reached from client C only via firewall F, where firewall F is configured in such a way, that client C can only build-up the connection to logon service LS, service S can build-up the connection to client C, and client C can communicate in both directions with logon service LS and service S. In part c) logon service LS and service S are running on units in different networks, where client C can build-up connection VCL directly to and communicate in both directions with the unprotected logon service LS and client C can reach service S only via firewall F, where firewall F is configured in such a way, that service S can build-up one connection to client C and both can communicate in both directions with each other. In part d) service S executing service unit SE also executes a local firewall LF, such that client C can build-up connection VCL directly to and communicate in both directions with the unprotected logon service LS and where service S is protected by the local firewall LF, where local firewall LF is configured in such a way, that only service S can build-up one connection to client C and both can communicate in both directions with each other. In parts e) and f) client C resp. logon service LS are protected by local firewall LF. It is evident to a person skilled in the art, that depending on the architecture of the physical network and/or the configuration of the communication systems other firewall configurations, than the explicitly mentioned, are also possible and covered by this patent. An example is the combination of different firewalls, as shown in part g), where logon service LS is additionally protected against client access by a separate firewall F′ and service S is additionally protected against unauthorized access from logon units by firewall FL.

The advantage of systems according to one of the claims 38 to 73 versus systems according to one of the claims 1 to 37 is, that firewall F between service S and client C resp. local firewall LF on service unit SE can block all connection build-ups in direction of service unit SE resp. service S as well as all connection less and/or unsolicited messages from and to service unit SE resp. service S.

The only weak points in systems according to one of the claims 38 to 73 are connection endpoint(s) VEPCL provided by the logon service(s) and connection endpoint(s) VEPC provided by the client(s). But since in general neither a logon unit nor a client unit stores economically valuable resp. security critical data, an attack of logon service or one of the clients are not as dangerous as an attack of the operational services providing access to economically valuable resp. security critical data.

If service S does not connect to the open connection endpoint VEPC provided by client C within a given time interval T, client C can close the opened connection endpoint VEPC after time interval T elapsed and reaches its previous closed state again (claim 74). The time limited provision of open connection endpoints assures, that an opened connection endpoint VEPC, by mistake, is not left permanently open and would become a permanently vulnerable point of the system.

If—after establishment of connection VS to resp. from service S—no program running on service unit SE provides an open connection endpoint (claim 75) or if service S builds-up connection VS to a connection endpoint provided by logon service LS and/or authorization service AS and no program running on service unit SE provides at any time an open connection endpoint (claim 76) and if a program running on service unit SE—in particular service S or a local firewall LF—comprises means to block all connection less or unsolicited messages send from any program running on service unit SE (claim 77) and to block all connection less messages send to service unit SE (claim 78), there exists no technical possibility for any authorized or unauthorized client to access data provided by service S directly bypassing service S and logon service LS, although all clients theoretically can reach service unit SE, because service S must be able to connect to authorized clients.

If the service selection in systems according to claims 9, 24, 25, 46, 61 and 62 depends on the authorization of the clients, it is possible to select and trigger different services for unauthenticated guest-users, for authenticated users, or for system administrators. The individual clients only receive information about the particular service, which they are authorized to use, such that guest-users only obtain the coordinates of guest-services and absolutely no information about services reserved for authenticated users or system administrators only. Of cause, the individual services only provide information and functionality corresponding to the respective authorization of their clients. This technique ensures very effectively, that predefined services are accessible only with special authorizations and are neither visible nor accessible for clients without the required authorization.

To distribute a large number of clients onto several identical services—“load balancing”—, the logon sub-system can select the operational service for a given client in dependence of the actual number of connected clients or the load of the operational services. Since the actual load of a service at a given time varies very much, it is especially advantageous to average the load over a given time interval and to use the gliding average load instead. Different individual criteria may be used to measure the load of a given service unit, like for example the number of active concurrent processes, the CPU-usage, the memory usage (core memory, hard-disk and/or external storage media).

The service selection may also depend on any system requirements, which the client requests himself or the logon sub-system requests for a particular client. This allows the system to select only such services, which are able to provide the requested system resources. A client could for example request a connection to a service, which offers certain information, functions or other system resources. Likewise the logon sub-system may know, that clients of a given type require certain information, functions or system resources and select only one of those services, which are actually able to offer the requested information, functions or system resources.

To optimize the system throughput is of particular importance to select the services in dependence of the geographical, the network resp. system topological location of the communication partners, or the connection quality and speed. Different connections are for example limited by the underlying transmission technique to different maximum transmission rates. The maximum transmission rate determines the minimum transmission time of individual messages and therefore the timing of the complete system. If a large system uses different transmission techniques in parallel, it is especially advantageous, to optimize individual sub-systems with respect of their underlying transmission technique. In such systems the logon sub-system can select a particular service, which is optimized for the transmission technique(s) used to reach a particular client. A typical example for such an application is the system access out of a local area network (LAN) with transmission rates larger than 10 MBit/s and out of a wide area network (WAN) per modem with transmission rates in the order of 64 kBit/s to 1 MBit/s. In such an environment it is especially advantageous to divide the system into separate sub-systems, one for each access possibility, with their own operative services and to select the services in dependence of the transmission rate to particular clients.

In most cases the maximum transmission rate of a connection between two communication partners does not only depend on the physical transmission technique(s) alone, but in addition also on their geographical locations, their network topological location, i.e. the number of intermediary physical units (routers, switches, firewalls etc.) via which a message between the two communication partners has to be routed, and their system topological location, i.e. the number of intermediary processes via which a message between the two communication partners has to forwarded within the logical system architecture. Therefore it is especially advantageous to select the services in dependence of the physical transmission techniques as well as said geographical, network and system topological criteria.

Claims 80 to 82 concern the system behavior after establishment of connection VC between service S and client C.

Systems according to one of the claims 1 to 82 have the disadvantage, that data, which service S provides to client C has, in general, to be stored on service S executing service unit SE, which theoretically could be accessed directly from clients bypassing service S.

Systems according to one of the claims 83 to 90 are protected against this theoretical threat, because economic valuable or security critical data are stored on independent treasury units TE₁, . . . , TEₜₑ, to which clients have no direct access.

In systems according to one of the claims 83 to 90 it is especially advantageous, to locate the treasury program(s) T resp. TP₁ to TPₜₚ in analogy to FIG. 28 in network segment N1, and to locate all clients in a different network segment N completely separated from N1 and not to physically route any messages between networks N and N1, so that no client obtains the technical possibility to directly access any treasury program(s) T resp. TP₁ to TPₜₚ resp. any treasury data TD stored on a treasury unit TE.

After establishment of connection VC between client C and service S the protocol(s) in systems according to one of the claims 80 to 82 between client C and service S resp. in systems according to one of the claims 83 to 90 between client C and treasury T can be chosen arbitrarily and in particular can be any part of a standard protocol—like Telnet, HTTP, FTP, DNS, SMTP/POP(3), DHCP, NFS, SMTP, NTP, NNTP, IMAP, RLogin, RSH, SSH, SMP, X-Windows u.a.—or any proprietary protocol. Systems according to one of the claims 80 to 82 have the advantage of maximum speed, because client C communicates directly with service S, while systems according to one of the claims 83 to 90 are better suited for systems with special security requirements, because service S has the possibility to check each message to resp. from treasury T.

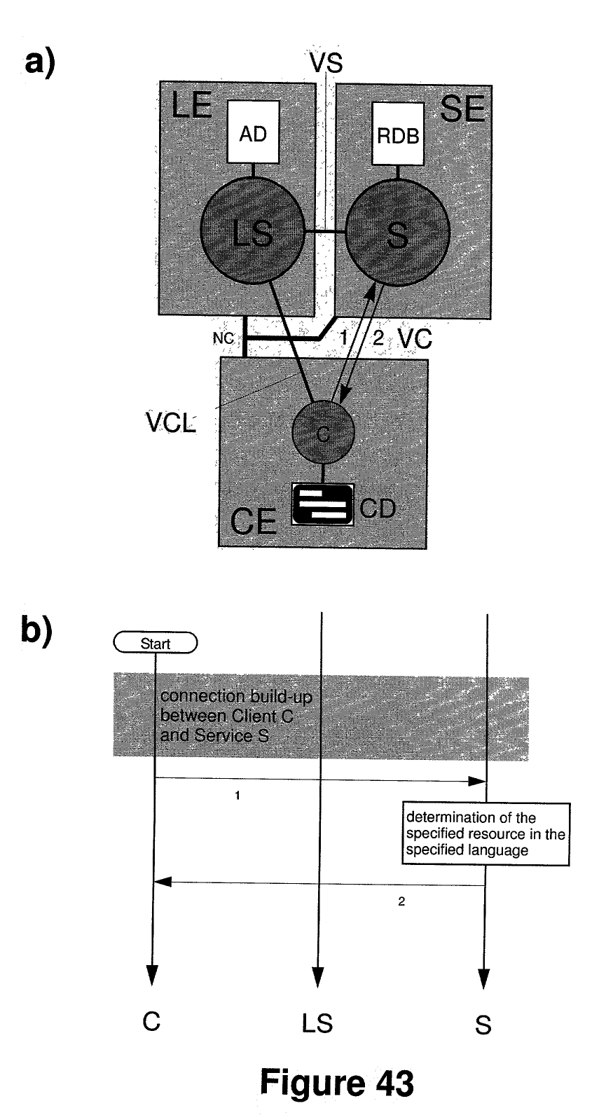

FIG. 43a illustrates the system topology and FIG. 43b the timing of one transaction in an incarnation in a network with communication system according to claim 80, where logon unit LE, service unit SE and client unit CE are physically connected via network connection NC, and where resource data base RDB is stored on service unit SE, and where service S comprises means to build-up connection VS to logon service LS and logon service LS comprises means to accept connection VS from service S, and where to build-up connection VC between client C and service S according to claim 43—client C comprises means to build-up connection VCL to logon service LS and to send via connection VCL logon data AMDC to logon service LS, logon service LS comprises means to receive via connection VCL logon data AMDC from client C,—after a positive validation of logon data AMDC against authorization data AD—to create access data ZDC, to send access data ZDC together with request AC, to connect to connection endpoint VEPC provided by client C, via connection VS to service S and to send access data ZDC via connection VCL to client C, client C comprises means to receive access data ZDC via connection VCL from logon service LS and to provide connection endpoint VEPC for service S in dependence of at least one part of access data ZDC, service S comprises means to receive access data ZDC together with request AC via connection VS from logon service LS and to build-up in dependence of at least one part of access data ZDC connection VC to connection endpoint VEPC provided by client C, and client C comprises means to accept connection VC from service S, and all participating programs comprise means to perform—after establishment of connection VC—at least one transaction T₁ between client C and service S, and—for transaction T₁—client C comprises means to send via connection VC in message (1) request CA together with a specification of a language-ID and a resource-ID of a system resource SR to service S, service S comprises means to receive via connection VC message (1) together with request CA from client C, to determine system resource SR with the specified language-ID and resource-ID in the specified language from resource data base RDB and to send via connection VC in message (2) system resource SR to client C, client C comprises means to receive via connection VC message (2) together with system resource SR from service S, and finally all participating programs comprise means to perform eventually further transaction between client C and service S according to the described scheme.

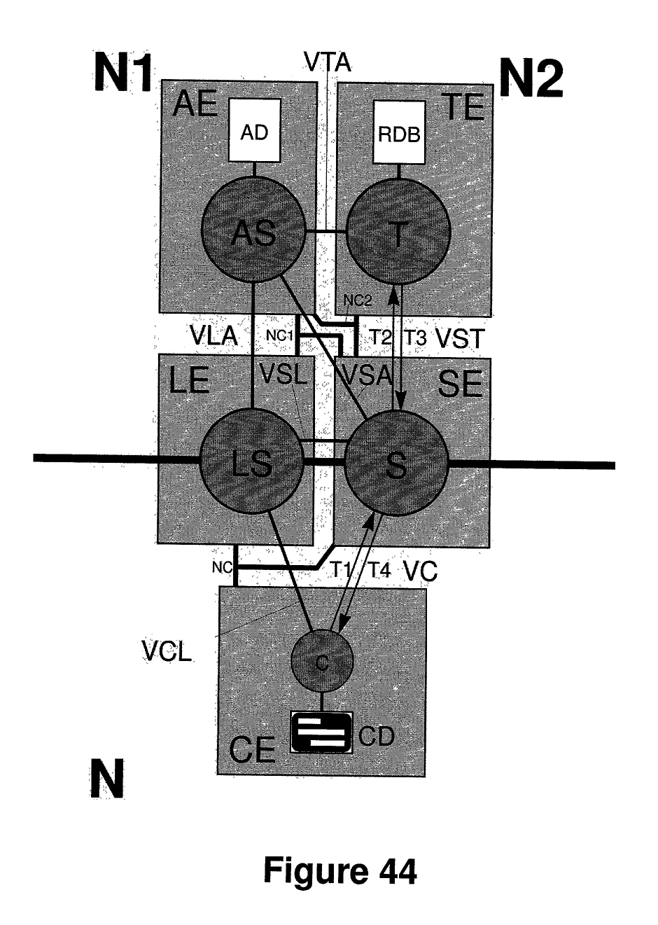

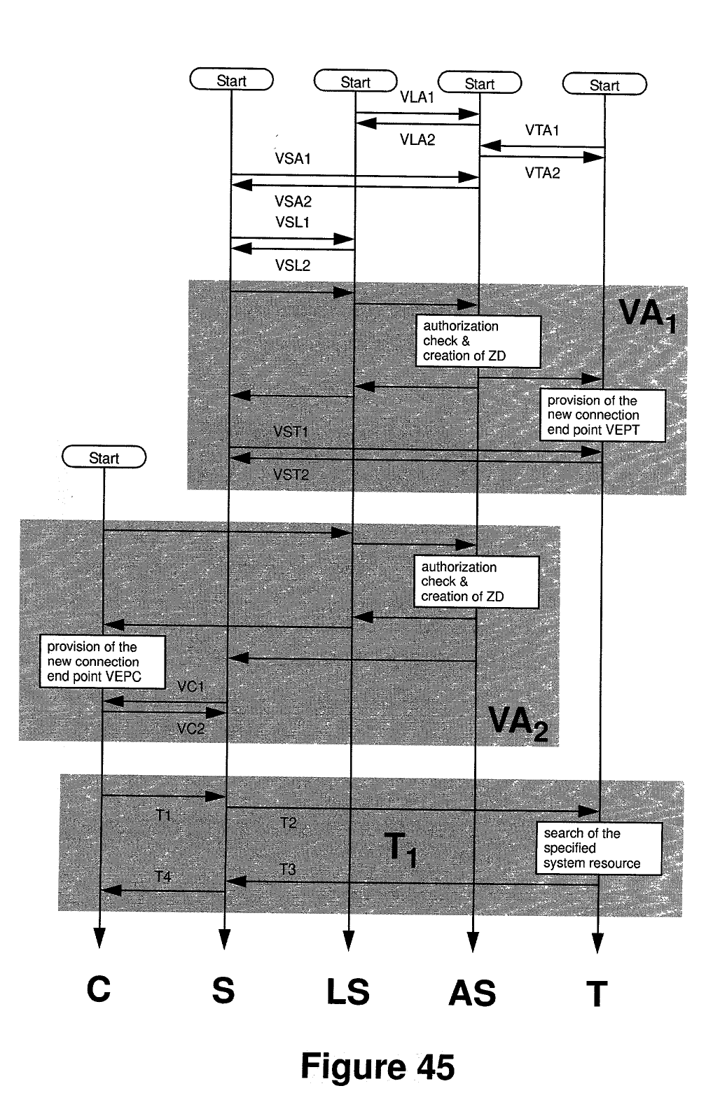

FIG. 44 illustrates the system topology and FIG. 45 the timing of the connection build-ups as well as one transaction T₁ in an incarnation of a network with communication system according to claim 87 using the same protocol as in example of FIG. 43, where logon unit LE, authorization unit AE and service unit SE are physically connected via network connection NC1 of network segment N1, authorization unit AE, service unit SE and treasury unit TE are physically connected via network connection NC2 of network segment N2 and logon unit LE, service unit SE and client unit CE are physically connected via network connection NC of network segment N and no messages are physically routed between the network segments N, N1 and N2, and where resource data base RDB is stored on treasury unit TE and cannot be directly reached by client C, and where logon service LS comprises means to build-up connection VLA to authorization service AS (VLA1) and authorization service AS comprises means to accept connection VLA from logon service LS (VLA2), treasury T comprises means to build-up connection VTA to authorization service AS (VTA1) and authorization service AS comprises means to accept connection VTA from treasury T (VTA2), service S comprises means to build-up connection VSA to authorization service AS (VSA1) and authorization service AS comprises means to accept connection VSA from service S (VSA2), service S comprises means to build-up connection VSL to logon service LS (VSL1) and logon service LS comprises means to accept connection VSL from service S (VSL2), and where—to build-up (VA₁) connection VST between service S and treasury T according to claim 87 together with claim 58, where claim 58 is applied in such a way, that service S plays the role of client C in claim 58, treasury T the role of service S in claim 58 and logon service LS and authorization service AS the same roles as in claim 58—service S comprises means to send, after establishment of connection VSL to logon service LS, via connection VSL logon data AMDS to logon service LS, logon service LS comprises means to receive logon data AMDS via connection VSL from service S and to forward logon data AMDS via connection VLA to authorization service AS, authorization service AS comprises means to receive logon data AMDS via connection VLA from logon service LS, to create—after a positive validation of logon data AMDS against authorization data AD—access data ZDT, to send access data ZDT via connection VTA together with request AT, to provide a new open connection endpoint VEPT for service S, to treasury T and to send access data ZDT via connection VLA to logon service LS, logon service LS comprises means to receive via connection VLA access data ZDT from authorization service AS and to send access data ZDT via connection VSL to service S, treasury T comprises means to receive access data ZDT together with request AT via connection VTA from authorization service AS and to provide in dependence of at least one part of access data ZDT connection endpoint VEPT for service S, service S comprises means to receive access data ZDT via connection VSL from logon service LS and to build-up in dependence of at least one part of access data ZDT connection VST to connection endpoint VEPT provided by treasury T (VST1) and treasury T comprises means to accept connection VST from service S (VST2), and where—to build-up (VA₂) between client C and service S according to claim 58, where claim 58 is applied in such a way, that client C, service S, logon service LS and authorization service AS play the same roles as in claim 58, and where connection VLA corresponds to connection VA in claim 58 and connection VSA corresponds to connection VS in claim 58—client C comprises means to build-up connection VCL to logon service LS and to send via connection VCL logon data AMDC to logon service LS, logon service LS comprises means to receive via connection VCL logon data AMDC from client C and to forward logon data AMDC via connection VLA to authorization service AS, authorization service AS comprises means to receive via connection VLA logon data AMDC from logon service LS, to create—after a positive validation of logon data AMDC against authorization data AD—access data ZDC and to send access data ZDC together with request AC, to connect to connection endpoint VEPC provided by client C, via connection VSA to service S and via connection VLA to logon service LS, logon service LS comprises means to receive access data ZDC via connection VLS from authorization service AS and to forward access data ZDC via connection VCL to client C, client C comprises means to receive access data ZDC via connection VCL from logon service LS and to provide connection endpoint VEPC for service S in dependence of at least one part of access data ZDC, service S comprises means to receive via connection VSA access data ZDC together with request AC from authorization service AS and to build-up in dependence of at least one part of access data ZDC connection VC to connection endpoint VEPC provided by client C (VC1), and client C comprises means to accept connection VC from service S (VC2), and all participating programs comprise means to perform—after establishment of connection VST between service S and treasury T and of connection VC between client C and service S—at least one transaction T₁ between client C and treasury T, and—for transaction T₁—client C comprises means to send via connection VC in message T1 request CA together with the specification of a language-ID and a resource-ID of a system resource SR to service S, service S comprises means to receive via connection VC message T1 from client C and to forward message T1 via connection VST in form of message T2 to treasury T, treasury T comprises means to receive via connection VST message T2 from service S, to determine system resource SR with the specified language-ID and resource-ID in the specified language from resource data base RDB and to send via connection VST system resource SR in message T3 to service S, service S comprises means to receive message T3 via connection VST from treasury T and to send system resource SR in form of message T4 via connection VC to client C, client C comprises means to receive message T4 via connection VC from service S, and finally all participating programs comprise means to eventually perform further transactions between client C and treasury T according to the described scheme.

If in the incarnation examples shown in FIGS. 43 to 45 the system resource specified by the language- and resource-ID is not available in the specified language, service S resp. treasury T can return the specified system resource in a predefined default language or, if the specified system resource is neither available in the default language, a predefined standard resource in the specified or the default language or an error message. Using this technique client C can display a language independent desktop CD, in which all elements—in particular all control elements like icons, menus, buttons, lists and trees, dialogs, windows, keyboard layouts, date and currency formats, but also the content of dialogs and windows—can be switched at run-time into another language. At the same time, resource data base RDB can be maintained independently of client C, such that for example all resources can be loaded in a new language into resource data base RDB and client C can display desktop CD in the new language without modifications of the source code of client C.

In systems according to one of the claims 1 to 90 it is not important, via how many programs the messages between logon service LS and service S have to be send and/or forwarded. Systems can be realized according to one of the present claims, in which an arbitrary number of further logon services LS₁, . . . , LS_{Is} are logically connected in series between logon service LS and service S, where two or more logon services create at least one part of access data ZD and send resp. forward access data ZD directly or indirectly to service S and client C, and/or two or more logon services validate at least one part of logon data AMD and request A is only send to service S, if at least one of the logon services, at least a required minimal number of logon services or all logon services positively validated logon data AMD against their respective local authorization data AD₁, . . . , AD_{Is}. The same principle can be applied to systems with authorization services to realize systems, in which an arbitrary number of authorization services AS₁, . . . , ASₐₛ are logically connected in series between logon service LS and service S, where two or more authorization services create at least one part of access data ZD and send resp. forward access data ZD directly or indirectly to service S and client C, and/or two or more authorization services validate at least one part of logon data AMD and request A is only send to service S, if at least one of the authorization services, at least a required minimal number of authorization services or all authorization services positively validated logon data AMD against their respective local authorization data AD₁, . . . , ADₐₛ.

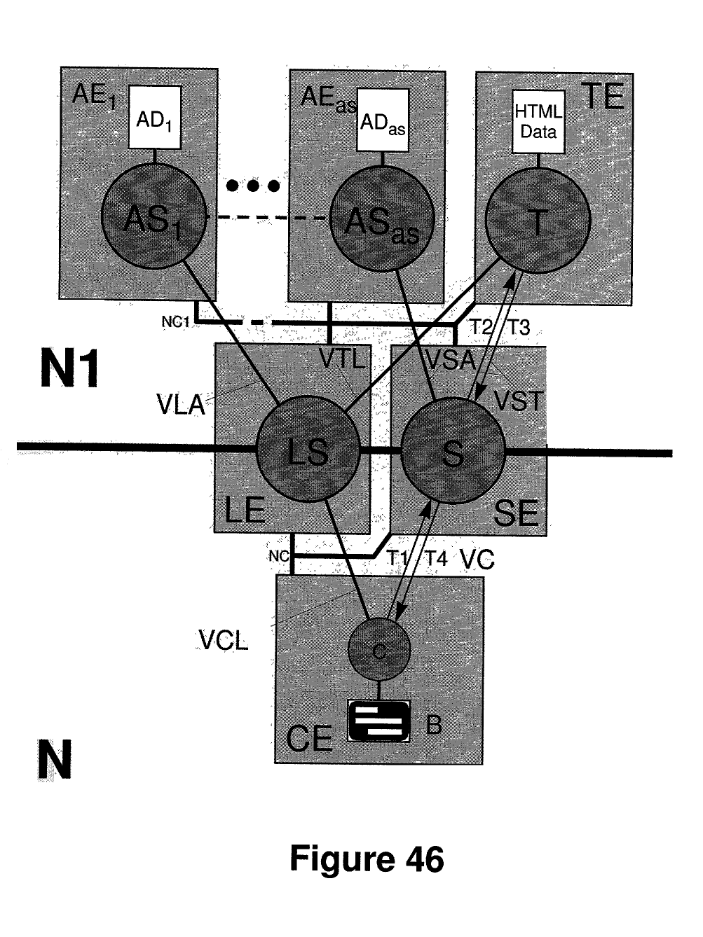

FIG. 46 illustrates a network with communication system and several logically in series connected authorization services, in which service unit SE executes service S, logon unit LE executes logon service LS, an arbitrary number as (as integer and as>1) of authorization units AE₁, . . . , AEₐₛ each execute one authorization service of the authorization services AS₁, . . . , ASₐₛ, treasury unit TE executes treasury T and client unit CE executes client C with browser B, where units AE₁ to AEₐₛ, TE, LE, SE are physically connected via network connection NC1 of network segment N1 and client unit CE, logon unit LE and service unit SE are physically connected via network connection NC of network segment N and no messages are physically routed between network segments N1 and N, and where logon service LS comprises means to build-up connection VLA to authorization service AS₁ and authorization service AS₁ comprises means to accept connection VLA from logon service LS, for each integer i with 0<i<as authorization service ASᵢ comprises means to build-up or accept one reliable standing logical bidirectional communication connection VAᵢ to resp. from authorization service ASᵢ₊₁ and for each integer j with 1<j<as+1 authorization service ASⱼ comprises means to accept or build-up connection VAⱼ₋₁ from resp. to authorization service ASⱼ₋₁, service S comprises means to build-up connection VSA to authorization service ASₐₛ and authorization service ASₐₛ comprises means to accept connection VSA from service S, and where—to build-up connection VST between treasury T and service S—treasury T comprises means to build-up logical connection VTL to logon service LS, logon service LS comprises means to accept connection VTL from treasury T, treasury T comprises means to send via connection VTL logon data AMDT to logon service LS, logon service LS comprises means to receive logon data AMDT via connection VTL from treasury T, to create access data ZDT, to send access data ZDT via connection VTL to treasury T and to send access data ZDT together with logon data AMDT via connection VLA to authorization service AS₁, for each integer i with 0<i<as authorization service ASᵢ comprises means to receive access data ZDT and logon data AMDT for i=1 via connection VLA from logon service LS and for i>1 via connection VAᵢ₋₁ from authorization service ASᵢ₋₁ and—after a positive validation of logon data AMDT against authorization data ADᵢ—to send logon data AMDT together with access data ZDT via connection VAᵢ to authorization service ASᵢ₊₁, authorization service ASₐₛ comprises means to receive access data ZDT and logon data AMDT via connection VAₐₛ₋₁ from authorization service ASₐₛ₋₁ and—after a positive validation of logon data AMDT against authorization data ADₐₛ—to send access data ZDT together with request AT, to connect to connection endpoint VEPT provided by treasury T, via connection VSA to service S, treasury T comprises means to receive access data ZDT via connection VTL from logon service LS and to provide in dependence of at least one part of access data ZDT a new open connection endpoint VEPT for service S, service S comprises means to receive access data ZDT together with request AT via connection VSA from authorization service ASₐₛ and to build-up in dependence of at least one part of access data ZDT connection VST to connection endpoint VEPT provided by treasury T, and treasury T comprises means to accept connection VST from service S, and where—to build-up connection VC between client C and service S—client C comprises means to build-up logical connection VCL to logon service LS, logon service LS comprises means to accept connection VCL from client C, client C comprises means to send logon data AMDC via connection VCL to logon service LS, logon service LS comprises means to receive logon data AMDC via connection VCL from client C, to create access data ZDC, to send access data ZDC via connection VCL to client C and to send access data ZDC together with logon data AMDC via connection VLA to authorization service AS₁, for each integer i with 0<i<as authorization service ASᵢ comprises means to receive access data ZDC and logon data AMDC for i=1 via connection VLA from logon service LS and for i>1 via connection VAᵢ from authorization service ASᵢ₋₁ and to send, after a positive validation of logon data AMDC against authorization data ADᵢ, logon data AMDC together with access data ZDC to authorization service ASᵢ₊₁, authorization service ASₐₛ comprises means to receive access data ZDC and logon data AMDC via connection VAₐₛ₋₁ from authorization service ASₐₛ₋₁ and to send, after a positive validation of logon data AMDC against authorization data ADₐₛ, access data ZDC together with request AC, to connect to connection endpoint VEPC provided by client C, via connection VSA to service S, client C comprises means to receive access data ZDC via connection VCL from logon service LS and to provide in dependence at least one part of access data ZDC a new open connection endpoint VEPC for service S, service S comprises means to receive access data ZDC together with request AC via connection VSA from authorization service ASₐₛ and to build-up in dependence of at least one part of access data ZDC connection VC to connection endpoint VEPC provided by client C, client C comprises means to accept connection VC from service S, and—after successful establishment of connection VST between service S and treasury T as well as connection VC between client C and service S—all participating programs comprise means to perform at least one transaction T₁ between client C and treasury T, and—for transaction T₁—client C comprises means to send in transaction request T1 at least one URL via connection VC to service S, service S comprises means to receive transaction request T1 via connection VC from client C and to forward the URL received with request T1 via connection VST in form of transaction request T2 to treasury T, treasury T comprises means to receive transaction request T2 via connection VST from service S, to load from a data base of HTML-data and/or dynamically generate—if necessary, in dependence of at least one result of at least one transaction with at least one secondary service—HTML-data D corresponding to the specified URL, and to send HTML-data D in form of transaction result T3 via connection VST to service S, service S comprises means to receive transaction result T3 via connection VST from treasury T and to forward it in form of transaction result T4 via connection VC to client C, client C comprises means to receive transaction result T4 via connection VC from service S and to display HTML-data D in Browser B, and finally all participating programs comprise means to perform eventually further transactions according to the described scheme between client C and treasury T. It is obvious to a reader skilled in the art, that the given examples are not limited to HTML-data and can be applied to any kind of data format and/or functionality using at least one transaction request as input and at least one transaction result as output.

The examples of FIGS. 44 to 46 illustrate impressively, how service S opens the possibility for client C to communicate with treasury T, without opening at any time any connection endpoint, while client C obtains at no time the technical possibility to directly connect to treasury unit TE or to access resource data base RDB stored on treasury unit TE bypassing service S and treasury T.

In systems according to one of the claims 1 to 90 it is neither important via how many programs messages between treasury T and client C are being send and/or forwarded. Systems can be realized, in which on top of service S an arbitrary number of further services S₁, . . . , Sₛ are logically connected in series between treasury T and client C, where all services forward the communication between client C and treasury T between each other, such that on the bottom line client C effectively communicates treasury T. It is obvious, that each of the services can check and eventually block the communication between client C and treasury T according to own rules.

Systems with multiple authorization checks or multiple forwarding can be applied in high security systems in politics, defence, finance or military, where connection build-ups and/or transactions between clients and important services resp. treasuries are only permitted after agreement of two or more independent authorization instances.

In all claims of the present patent each program can be implemented and executed as part of an (on-chip-) microcode of an arbitrary processing unit, as well as part of the control firmware of an arbitrary machine, as well as part of a thread of a single- or multitasking operating system, as well as part of a process of a single- or multitasking operating system, as well as an independent thread within a process of a single- or multitasking operating system, as well as an independent process of a single- or multitasking operating system, as well as multiple communicating threads within a process of a single- or multitasking operating systems, as well as multiple communicating processes of a single- or multitasking operating systems.

The integration of existing user data bases or authorization mechanisms is easily possible into systems according to one of the claims 1 to 90, if at least one logon service LS or at least one authorization service AS, after reception of a connection request of a new client C, communicates with at least one secondary service (for example: with a LDAP- or PKI-server or proprietary user data bases), to authenticate and authorize client C, and send request A, to open a new connection endpoint for client C resp. to connect to a connection endpoint provided by client C, to service S only in dependence of at least one result of at least one transaction with at least one secondary service.

The integration of existing proprietary data bases is easily possible into systems according to one of the claims 1 to 90, if at least one service S or at least one treasury T, after reception of a transaction request from client C, communicates at least with one secondary service to determine the transaction result in dependence of at least one result of at least one transaction with at least one secondary service.

Standard TCP/IP-clients, like for example HTTP- or FTP-clients can be integrated into a System according to one of the claims 1 to 90 for example by a replacement of the standard communication programs (TCP/IP-Stack, like Winsock.dll under Windows) on the client side. Alternatively it is also possible, not to replace the existing standard communication programs on the client side, and instead, to introduce an additional software layer PS between the standard socket-interface and the standard applications, which software layer PS on one hand provides versus the application programs the same socket-interface as the standard TCP/IP-stack, intercepts the standard communication via the standard socket-interface from standard applications, if necessary transforms the intercepted standard communication, and sends the transformed communication using the libraries of systems according to the present invention via the standard TCP/IP-stack to systems and/or invisible services according to the present inventions and on the other hand receives via the standard-TCP/IP-stack the communication from systems and invisible services according the present invention using the libraries of systems according to the present invention, if necessary transforms the received communication into standard format, and forwards the transformed communication via the Socket-interface to the existing standard applications, and thereby

allows standard TCP/IP-applications to communicate without source code modifications via the normal Socket-interface with INVISIBLE SERVICES according to the present invention.

I claim:

1. Network with communication system comprising an arbitrary number se (se integer and se>0) service units SE₁, . . . , SEₛₑ, an arbitrary number Ie (Ie integer and Ie≧0) logon units LE₁, . . . , LE_{Ie} and an arbitrary number ce (ce integer and ce≧0) client units CE₁, . . . , CE_{ce}, where units SE₁, . . . , SEₛₑ, LE₁, . . . , LE_{Ie} and CE₁, . . . , CE_{ce} each are physically connected via at least one network interface NISE₁, . . . , NISEₛₑ, NILE₁, . . . , NILE_{Ie} and NICE₁, . . . , NICE_{ce} with at least one network N in such a way, that at least all described communication connections can be established, and where service units SE₁, . . . . , SEₛₑ execute an arbitrary number sp (sp integer and sp>0) service programs SP₁, . . . , SPₛₚ, and where units SE₁, . . . , SEₛₑ, LE₁, . . . , LE_{Ie} execute an arbitrary number Ip (Ip integer and Ip>0) logon programs LP₁, . . . , LP_{Ip}, and where units SE₁, . . . , SEₛₑ, LE₁, . . . , LE_{Ie} and CE₁, . . . , CE_{ce} execute an arbitrary number cp (cp integer and cp>0) client programs CP₁, . . . , CP_{cp}, whereby
i. at least one logon service LS of the logon programs LP₁, . . . , LP_{Ip} comprises means to provide at least one open connection endpoint VEPCL for at least one client C of the client programs CP₁, . . . , CP_{cp}, and
ii. at least logon service LS comprises means to build-up or accept at least one reliable standing logical bidirectional inter process communication connection VS to resp. from at least one service S of the service programs SP₁, . . . , SPₛₚ, and
iii. at least service S comprises means to build-up or accept at least said connection VS from resp. to logon service LS, and
iv. at least client C comprises means—to build-up a connection to service S—to initially establish a logical communication connection VCL to said open connection end point VEPCL of logon service LS;
logon service LS comprises means first to accept connection VCL from client C, and second to send via connection VS request A, to provide a new open connection endpoint for client C, to service S;
service S comprises means first to receive via connection VS request A from logon service LS and second to provide after the reception of request A a new open connection endpoint VEPS;
client C comprises means to build-up a reliable standing logical bidirectional inter thread or inter process communication connection VC to connection endpoint VEPS;
service S comprises means to accept the connection request to connection endpoint VEPS from client C.

2. Network with communication system according to claim 1 comprising at least two different units LE and SE, whereby
at least logon service LS is running on unit LE and at least service S is running on unit SE.

3. Network with communication system according to one of the previous claims, whereby
i. at least logon service LS comprises means to access authorization data AD,
ii. at least client C comprises means to send after establishment of connection VCL to logon service LS via connection VCL logon data AMD to logon service LS,
iii. at least logon service LS comprises means first to receive via connection VCL logon data AMD from client C and second to send request A, to provide a new open connection endpoint VEPS, to service S only after a positive authorization validation of logon data AMD versus authorization data AD.

4. Network with communication system according to claim 3, whereby
i. at least client C comprises means to send at least part TAMD of logon data AMD via connection VCL in an encrypted format to logon service LS,
ii. at least logon service LS comprises means to receive logon data AMD via connection VCL from client C and to decrypt said part TAMD of logon data AMD.

5. Network with communication system according to one of the previous claims, whereby
i. at least client C does not know access data ZD to connection endpoint VEPS before build-up of connection VCL to logon service LS, and
ii. at least logon service LS comprises means to send access data ZD first via connection VCL to client C and second via connection VS to service S, and
iii. at least service S comprises means first to receive access data ZD via connection VS from logon service LS and second to provide in dependence of at least one part of access data ZD connection endpoint VEPS for client C, and
iv. at least client C comprises means first to receive access data ZD via connection VCL from logon service LS and second to build-up in dependence of at least one part of access data ZD connection VC to connection endpoint VEPS provided by service S.

6. Network with communication system according to claim 5, whereby
i. at least logon service LS comprises means to create at least one part LTZD of access data ZD, and
ii. at least all participating programs comprise means to transmit part LTZD of access data ZD from logon service LS via connection VCL to client C as well as via connection VS to service S.

7. Network with communication system according to one of the claims 5 to 6, whereby
i. at least service S comprises means to create at least one part STZD of access data ZD, and
ii. at least all participating programs comprise means to transmit part STZD of access data ZD from service S via connection VS, logon service LS and connection VCL to client C.

8. Network with communication system according to one of the claims 5 to 7, whereby
i. at least client C comprises means to create at least one part CTZD of access data ZD, and
ii. at least all participating programs comprise means to transmit part CTZD of access data ZD from client C via connection VCL, logon service LS and connection VS to service S.

9. Network with communication system according to one of the claims 5 to 8, whereby
i. at least logon service LS comprises means to select at least one service S, and
ii. at least all participating programs comprise means to transmit within access data ZD at least one physical address of at least one network interface of the service unit, which executes said selected service S, from logon service LS via connection VCL to client C.

10. Network with communication system according to one of the claims 5 to 9, whereby
i. at least one logon service LS comprises means to select at least one local identification LK for at least one connection endpoint VEPS to be provided by service S, and
ii. at least all participating programs comprise means to transmit local identification LK from logon service LS via connection VCL to client C and from logon service LS via connection VS to service S.

11. Network with communication system according to one of the claims 5 to 10, whereby
i. at least one service S comprises means to select at least one local identification LK for at least one connection endpoint VEPS to be provided by service S, and
ii. at least all participating programs comprise means to transmit local identification LK from service S via connection VS, logon service LS and connection VCL to client C.

12. Network with communication system according to one of the claims 5 to 11, whereby
i. at least client C comprises means to select at least one local identification LK for at least one connection endpoint VEPS to be provided by service S, and
ii. at least all participating programs comprise means to transmit local identification LK from client C via connection VCL, logon service LS and connection VS to service S.

13. Network with communication system according to one of the claims 5 to 12, whereby
i. at least logon service LS comprises means to send via connection VCL at least one part VTZD of access data ZD in an encrypted format to client C, and
ii. at least client C comprises means to receive via connection VCL the encrypted part VTZD of access data ZD from logon service LS and to decrypt said part VTZD.

14. Network with communication system according to one of the claims 5 to 13, whereby
i. at least logon service LS comprises means to send via connection VS at least one part VTZD2 of access data ZD in an encrypted format to service S, and
ii. at least service S comprises means to receive via connection VS the encrypted part VTZD2 of access data ZD from logon service LS and to decrypt said part VTZD2.

15. Network with communication system comprising an arbitrary number se (se integer and se>0) service units SE₁, . . . , SEₛₑ, an arbitrary number Ie (Ie integer and Ie≧0) logon units LE₁, . . . , LE_{Ie}, an arbitrary number ae (ae integer and ae≧0) authorization units AE₁, . . . , AEₐₑ and an arbitrary number ce (ce integer and ce≧0) client units CE₁, . . . , CE_{ce}, where units SE₁, . . . , SEₛₑ, LE₁, . . . , LE_{Ie}, AE₁, . . . , AEₐₑ and CE₁, . . . , CE_{ce} each are physically connected via at least one network interface NISE₁, . . . , NISEₛₑ, NILE₁, . . . , NILE_{Ie}, NIAE₁, . . . , NIAEₐₑ and NICE₁, . . . , NICE_{ce} with at least one network N in such a way, that at least all described communication connections can be established, and where service units SE₁, . . . , SEₛₑ execute an arbitrary number sp (sp integer and sp>0) service programs SP₁, . . . , SPₛₚ, and where units SE₁, . . . , SEₛₑ, LE₁, . . . , LE_{Ie} execute an arbitrary number Ip (Ip integer and Ip>0) logon programs LP₁, . . . , LP_{Ip}, and where units SE₁, . . . , SEₛₑ, AE₁, . . . , AEₐₑ execute an arbitrary number ap (ap integer and ap>0) authorization programs AP₁, . . . , APₐₚ, and where units SE₁, . . . , SEₛₑ, LE₁, . . . , LE_{Ie} and CE₁, . . . , CE_{ce} execute an arbitrary number cp (cp integer and cp>0) client programs CP₁, . . . , CP_{cp}, whereby
i. at least one logon service LS of the logon programs LP₁, . . . , LP_{Ip} comprises means to provide at least one open connection endpoint VEPCL for at least one client C of the client programs CP₁, . . . , CP_{cp}, and
ii. at least logon service LS comprises means to build-up or accept at least one reliable logical bidirectional inter thread or inter process communication connection VA to resp. from at least one authorization service AS of the authorization programs AP₁, . . . , APₐₚ, and
iii. at least authorization service AS comprises means to accept or build-up at least said connection VA from resp. to logon service LS, and
iv. at least authorization service AS comprises means to build-up or accept at least one reliable standing logical bidirectional inter thread or inter process communication connection VS to resp. from at least one service S of the service programs SP₁, . . . , SPₛₚ, and
v. at least service S comprises means to accept or build-up at least said connection VS from resp. to authorization service AS, and
vi. at least client C comprises means—to build-up a connection to service S—to initially establish a logical communication connection VCL to an open connection end point VEPCL of logon service LS;
logon service LS comprises means to first accept the connection VCL from client C and second to send via connection VA message N, that client C wants to build-up a connection to service S, to authorization service AS;
authorization service AS comprises means first to receive via connection VA message N from logon service LS and second to send via connection VS request A to provide a new open connection endpoint for client C, to service S;
service S comprises means to receive via connection VS request A from authorization service AS and second to provide a new open connection endpoint VEPS for client C;
client C comprises means to build-up a reliable standing logical bidirectional inter thread or inter process communication connection VC to connection endpoint VEPS provided by service S;
service S comprises means to accept the connection request to connection endpoint VEPS from client C.

16. Network with communication system according to claim 15 comprising at least two different units, whereby
at least one of the programs logon service LS, authorization service AS or service S is running on a different unit than the two others of said programs LS, AS and S.

17. Network with communication system according to one of the claims 15 to 16, whereby
i. at least authorization service AS comprises means to access authorization data AD, and
ii. at least client C comprises means to send after establishment of connection VCL logon data AMD via connection VCL to logon service LS, and
iii. at least logon service LS comprises means first to receive via connection VCL logon data AMD from client C and second to send logon data AMD via connection VS to authorization service AS, and
iv. at least authorization service AS comprises means first to receive logon data AMD via connection VS from logon service LS and second to send request A, to provide a new open connection endpoint, to service S only after a positive authorization validation of logon data AMD against authorization data AD.

18. Network with communication system according to claim 17, whereby
i. at least client C comprises means to send at least part TAMD of logon data AMD in an encrypted format via connection VCL to logon service LS, and
ii. at least logon service LS comprises means first to receive part TAMD of logon data AMD via connection VCL from client C and second to send part TAMD of logon data AMD via connection VA to authorization service AS, and
iii. at least authorization service AS comprises means to receive part TAMD of logon data AMD via connection VA from logon service LS and to decrypt said part TAMD.

19. Network with communication system according to one of the claims 15 to 18, whereby
i. at least client C does not know access data ZD to connection endpoint VEPS before build-up of connection VCL to logon service LS, and
ii. at least logon service LS comprises means to send access data ZD via connection VCL to client C, and
iii. at least authorization service AS comprises means to send access data ZD via connection VS to service S, and
iv. at least service S comprises means first to receive access data ZD via connection VS from authorization service AS and second to provide in dependence of at least one part of access data ZD a new open connection endpoint VEPS for client C, and
v. at least client C comprises means first to receive access data ZD via connection VCL from logon service LS and second to build-up in dependence of at least one part of access data ZD connection VC to connection endpoint VEPS provided by service S.

20. Network with communication system according to claim 19, whereby
i. at least logon service LS comprises means to create at least one part LTZD of access data ZD, and
ii. at least all participating programs comprise means to transmit part LTZD of access data ZD from logon service LS via connection VCL to client C as well as via connection VA, authorization service AS and connection VS to service S.

21. Network with communication system according to one of the claims 19 to 20, whereby
i. at least authorization service AS comprises means to create at least one part ATZD of access data ZD, and
ii. at least all participating programs comprise means to transmit part ATZD of access data ZD from authorization service AS via connection VS to service S as well as via connection VA, logon service LS and connection VCL to client C.

22. Network with communication system according to one of the claims 19 to 21, whereby
i. at least service S comprises means to create at least one part STZD of access data ZD, and
ii. at least all participating programs comprise means to transmit part STZD of access data ZD from service S via connection VS, authorization service AS, connection VA, logon service LS and connection VCL to client C.

23. Network with communication system according to one of the claims 19 to 22, whereby
i. at least client C comprises means to create at least one part CTZD of access data ZD, and
ii. at least all participating programs comprise means to transmit part CTZD of access data ZD from client C via connection VCL, logon service LS, connection VA, authorization service AS and connection VS to service S.

24. Network with communication system according to one of the claims 19 to 23, whereby
i . at least logon service LS comprises means to select at least one service S, and
ii. at least all participating programs comprise means to transmit within access data ZD at least one physical address of at least one network interface of the service unit, which executes said selected service S, from logon service LS via connection VCL to client C.

25. Network with communication system according to claims 19 to 24, whereby
i. at least authorization service AS comprises means to select at least one service S, and
ii. at least all participating programs comprise means to transmit within access data ZD at least one physical address of at least one network interface of the service unit SE executing service S from authorization service AS via connection VA, logon service LS and connection VCL to client C.

26. Network with communication system according to one of the claims 19 to 25, whereby
i. at least logon service LS comprises means to select at least one local identification LK for at least one connection endpoint VEPS to be provided by service S, and
ii. at least all participating programs comprise means to transmit said local identification LK from logon service LS via connection VCL to client C and from logon service LS via connection VA, authorization service AS and connection VS to service S.

27. Network with communication system according to one of the claims 19 to 26, whereby
i. at least authorization service AS comprises means to select at least one local identification LK for at least one connection endpoint VEPS to be provided by service S, and
ii. at least all participating programs comprise means to transmit said local identification LK from authorization service AS via connection VS to service S and from authorization service AS via connection VA, logon service LS and connection VCL to client C.

28. Network with communication system according to one of the claims 19 to 27, whereby
i. at least service S comprises means to select at least one local identification LK for at least one connection endpoint VEPS to be provided by service S, and
ii. at least all participating programs comprise means to transmit said local identification LK from service S via connection VS, authorization service AS, connection VA, logon service LS and connection VCL to client C.

29. Network with communication system according to one of the claims 19 to 28, whereby
i. at least client C comprises means to select at least one local identification LK for at least one connection endpoint VEPS to be provided by service S, and
ii. at least all participating programs comprise means to transmit said local identification LK from client C via connection VCL, logon service LS, connection VA, authorization service AS and connection VS to service S.

30. Network with communication system according to one of the claims 19 to 29, whereby
i. at least logon service LS comprises means to send via connection VCL at least one part VTZD of access data ZD in an encrypted format to client C, and
ii. at least client C comprises means to receive via connection VCL the encrypted part VTZD of access data ZD from logon service LS and to decrypt said part VTZD.

31. Network with communication system according to one of the claims 19 to 30, whereby
i. at least authorization service AS comprises means to send via connection VS at least one part VTZD2 of access data ZD in an encrypted format to service S, and
ii. at least service S comprises means to receive via connection VS the encrypted part VTZD2 of access data ZD from authorization service AS and to decrypt said part VTZD2.

32. Network with communication system according to one of the claims 5 to 14 and 19 to 31, whereby
i. at least client C comprises means to send at least one key ZSC, received within access data ZD, via connection VC to service S, and
ii. at least service S comprises means first to receive said key ZSC via connection VC from client C, second to validate said key ZSC against access data ZD and third to leave client C connected only after a positive result of said validation of key ZSC.

33. Network with communication system according to one of the claims 5 to 14 and 19 to 32, whereby
i. at least service S comprises means to send at least one key ZSS, received within access data ZD, via connection VC to client C, and
ii. at least client C comprises means first to receive said key ZSS via connection VC from service S, second to validate said key ZSS against access data ZD and third to let connection VC to service S remain connected only after a positive result of said validation of key ZSS.

34. Network with communication system according to one of the claims 5 to 14 and 19 to 33, whereby
at least one part of access data ZD is created pseudo or absolutely randomly.

35. Network with communication system according to one of the previous claims, where at least service S executing service unit SE in addition executes at least one local firewall LF, and where logon programs LP₁, . . . , LP_{Ip} are exclusively running on logon units LE₁, . . . , LE_{Ie}, and where client programs CP₁, . . . , CP_{cp} are exclusively running on client units CE₁, . . . , CE_{ce}, whereby
local firewall LF allows at most the build-up of at least one connection from at least one of the client programs CP₁, . . . , CP_{cp} to service S as well as the connection oriented bidirectional communication between service S and the client programs connected to service S as well as the build-up of connection VS and the bidirectional communication via connection VS between service S and logon service LS resp. authorization service AS, and
local firewall LF in particular blocks all connection less messages send from and to service unit SE, as well as all connection build-ups from service unit SE to one of the client units CE₁, . . . , CE_{ce}, as well as all connection build-ups to any program running on service unit SE except service S.

36. Network with communication system according to one of the previous claims, where at least one firewall F is located between at least service S executing service unit SE and at least client C executing client unit CE of client units CE₁, . . . , CE_{ce}, and where client programs CP₁, . . . , CP_{cp} are exclusively running on client units CE₁, . . . , CE_{ce}, whereby
firewall F allows at most the build-up of at least one connection from at least client C to service S, the connection oriented bidirectional communication between service S and the client programs connected to service S, as well as the build-up of connection VS and the bidirectional communication via connection VS between service S and logon service LS resp. authorization service AS, and
firewall F in particular blocks all connection less messages send from and to service unit SE, as well as all connection build-ups from service unit SE to one of the client units CE₁, . . . , CE_{ce}, as well as all connection build-ups to any programs running on service unit SE except service S.

37. Network with communication system according to one of the previous claims, whereby
service S comprises means to provide open connection endpoints only after prior request of a logon service or an authorization service and to provide at least one open connection endpoint VEPS for client C only for an arbitrarily selectable time interval T and, if client C does not connect within said time interval T to connection endpoint VEPS, to close connection endpoint VEPS after time interval T elapsed.

38. Network with communication system comprising an arbitrary number se (se integer and se>0) service units SE₁, . . . , SEₛₑ, an arbitrary number Ie (Ie integer and Ie≧0) logon units LE₁, . . . , LE_{Ie} and an arbitrary number ce (ce integer and ce≧0) client units CE₁, . . . , CE_{ce}, where units SE₁, . . . , SEₛₑ, LE₁, . . . , LE_{Ie} and CE₁, . . . , CE_{ce} each are physically connected via at least one network interface NISE₁, . . . , NISEₛₑ, NILE₁, . . . , NILE_{Ie} and NICE₁, . . . , NICE_{ce} with at least one network N in such a way, that at least all described communication connections can be established, and where service units SE₁, . . . , SEₛₑ execute an arbitrary number sp (sp integer and sp>0) service programs SP₁, . . . , SPₛₚ, and where units SE₁, . . . , SEₛₑ, LE₁, . . . , LE_{Ie} execute an arbitrary number Ip (Ip integer and Ip>0) logon programs LP₁, . . . , LP_{Ip}, and where units SE₁, . . . , SEₛₑ, LE₁, . . . , LE_{Ie} and CE₁, . . . , CE_{ce} execute an arbitrary number cp (cp integer and cp>0) client programs CP₁, . . . , CP_{cp}, whereby
i. at least one logon service LS of the logon programs LP₁, . . . , LP_{Ip} comprises means to provide at least one open connection endpoint VEPCL for at least one client C of the client programs CP₁, . . . , CP_{cp}, and
ii. at least logon service LS comprises means to build-up or accept at least one reliable standing logical bidirectional inter process communication connection VS to resp. from at least one service S of the service programs SP₁, . . . , SPₛₚ, and
iii. at least service S comprises means to accept or build-up at least said connection VS from resp. to logon service LS, and
iv. at least one client C of the client programs CP₁, . . . , CP_{cp} comprises means—to build-up the connection between service S and client C—first to build-up at least one logical communication connection VCL to an open connection endpoint VEPCL of the logon service LS, second to provide an open connection endpoint VEPC for service S, and third to send connection parameters VP via connection VCL to logon service LS;
logon service LS comprises means first to accept connection VCL from client C and second to receive via connection VCL connection parameters VP from client C and third to send via connection VS connection parameters VP together with request A, to build-up a connection VC to connection endpoint VEPC of client C, to service S;
service S comprises means first to receive via connection VS connection parameters VP and request A from logon service LS and second to build-up a reliable standing logical bidirectional inter thread or inter process communication connection VC to connection endpoint VEPC of client C, and
client C comprises means to accept the connection request from service S to connection endpoint VEPC.

39. Network with communication system according to claim 38 comprising at least two different units LE and SE, whereby
at least logon service LS is running on unit LE and at least service S is running on unit SE.

40. Network with communication system according to one of the claims 38 to 39, whereby
i. at least logon service LS comprises means to access authorization data AD, and
ii. at least client C comprises means to send—after establishment of connection VCL to logon service LS—via connection VCL logon data AMD to logon service LS, and
iii. at least logon service LS comprises means first to receive via connection VCL logon data AMD from client C and second to send request A, to connect to connection endpoint VEPC provided by client C, to service S only after a positive authorization validation of logon data AMD versus authorization data AD.

41. Network with communication system according to claim 40, whereby
i. at least client C comprises means to send at least part TAMD of logon data AMD via connection VCL in an encrypted format to logon service LS,
ii. at least logon service LS comprises means to first receive logon data AMD via connection VCL from client C and second to decrypt said part TAMD of logon data AMD.

42. Network with communication system according to one of the claims 38 to 41, whereby
i. at least service S does not know access data ZD of connection endpoint VEPC before build-up of connection VCL between client C and logon service LS, and
ii. at least logon service LS comprises means to send access data ZD first via connection VS to service S and second via connection VCL to client C, and
iii. at least client C comprises means first to receive access data ZD via connection VCL from logon service LS and second to provide in dependence of at least one part of access data ZD connection endpoint VEPC for service S, and
iv. at least service S comprises means first to receive access data ZD via connection VS from logon service LS and second to build-up in dependence of at least one part of access data ZD connection VC to connection endpoint VEPC provided by client C.

43. Network with communication system according to claim 42, whereby
i. at least logon service LS comprises means to create at least one part LTZD of access data ZD, and
ii. at least all participating programs comprise means to transmit part LTZD of access data ZD from logon service LS via connection VCL to client C as well as via connection VS to service S.

44. Network with communication system according to one of the claims 42 to 43, whereby
i. at least service S comprises means to create at least one part STZD of access data ZD, and
ii. at least all participating programs comprise means to transmit part STZD of access data ZD from service S via connection VS, logon service LS and connection VCL to client C.

45. Network with communication system according to claim 42 to 44, whereby
i. at least client C comprises means to create at least one part CTZD of access data ZD, and
ii. at least all participating programs comprise means to transmit part CTZD of access data ZD from client C via connection VCL, logon service LS and connection VS to service S.

46. Network with communication system according to one of the claims 42 to 45, whereby
i. at least logon service LS comprises means to select at least one service S, and
ii. at least all participating programs comprise means to transmit within access data ZD at least one physical address of at least one network interface of the service unit, which executes said selected service S, from logon service LS via connection VCL to client C.

47. Network with communication system according to one of the claims 42 to 46, whereby
i. at least logon service LS comprises means to select at least one local identification LK of at least one connection endpoint VEPC to be provided by client C, and
ii. at least all participating programs comprise means to transmit local identification LK from logon service LS via connection VCL to client C and from logon service LS via connection VS to service S.

48. Network with communication system according to one of the claims 42 to 47, whereby
i. at least service S comprises means to select at least one local identification LK of at least one connection endpoint VEPC to be provided by client C, and
ii. at least all participating programs comprise means to transmit local identification LK from service S via connection VS, logon service LS and connection VCL to client C.

49. Network with communication system according to one of the claims 42 to 48, whereby
i. at least client C comprises means to select at least one local identification LK of at least one connection endpoint VEPS to be provided by client C, and
ii. at least all participating programs comprise means to transmit local identification LK via connection VCL, logon service LS and connection VS to service S.

50. Network with communication system according to one of the claims 42 to 49, whereby
i. at least logon service LS comprises means to send via connection VCL at least one part VTZD of access data ZD in an encrypted format to client C, and
ii. at least client C comprises means to receive via connection VCL the encrypted part VTZD of access data ZD from logon service LS and to decrypt said part VTZD.

51. Network with communication system according to one of the claims 42 to 50, whereby
i. at least logon service LS comprises means to send via connection VS at least one part VTZD2 of access data ZD in an encrypted format to service S, and
ii. at least service S comprises means to receive via connection VS the encrypted part VTZD2 of access data ZD from logon service LS and to decrypt said part VTZD2.

52. Network with communication system comprising an arbitrary number se (se integer and se>0) service units SE₁, . . . , SEₛₑ, an arbitrary number Ie (Ie integer and Ie≧0) logon units LE₁, . . . , LE_{Ie}, an arbitrary number ae (ae integer and ae≧0) authorization units AE₁, . . . , AEₐₑ and an arbitrary number ce (ce integer and ce≧0) client units CE₁, . . . , CE_{ce}, where units SE₁, . . . , SEₛₑ, LE₁, . . . , LE_{Ie}, AE₁, . . . , AEₐₑ and CE₁, . . . , CE_{ce} each are physically connected via at least one network interface NISE₁, . . . , NISEₛₑ, NILE₁, . . . , NILE_{Ie}, NIAE₁, . . . , NIAEₐₑ and NICE₁, . . . , NICE_{ce} with at least one network N in such a way, that at least all described communication connections can be established, and where service units SE₁, . . . , SEₛₑ execute an arbitrary number sp (sp integer and sp>0) service programs SP₁, . . . , SPₛₚ, and where units SE₁, . . . , SEₛₑ, LE₁, . . . , LE_{Ie} execute an arbitrary number Ip (Ip integer and Ip>0) logon programs LP₁, . . . , LP_{Ip}, and where units SE₁, . . . , SEₛₑ, AE₁, . . . , AEₐₑ execute an arbitrary number ap (ap integer and ap>0) authorization programs AP₁, . . . , APₐₚ, and where units SE₁, . . . , SEₛₑ, LE₁, . . . , LE_{Ie} and CE₁, . . . , CE_{ce} execute an arbitrary number cp (cp integer and cp>0) client programs CP₁, . . . , CP_{cp}, whereby
i. at least one logon service LS of the logon programs LP₁, . . . , LP_{Ip} comprises means to provide at least one open connection endpoint VEPCL for at least one client C of the client programs CP₁, . . . , CP_{cp}, and
ii. at least logon service LS comprises means to build-up or accept at least one reliable standing logical bidirectional inter thread or inter process communication connection VA to resp. from at least one authorization service AS of the authorization programs AP₁, . . . , APₐₚ, and
iii. at least authorization service AS comprises means to accept or build-up at least said connection VA from resp. to logon service LS, and
iv. at least authorization service AS comprises means to build-up or accept at least one reliable standing logical bidirectional inter thread or inter process communication connection VS to resp. from at least one service S of said service programs SP₁, . . . , SPₛₚ, and
v. at least service S comprises means to accept or build-up at least said connection VS from resp. to authorization service AS, and
vi. at least client C comprises means—to build-up the connection between service S and client C—first to build-up at least one logical communication connection VCL to an open connection endpoint VEPCL of logon service LS, second to provide an open connection endpoint VEPC for service S and third to send connection parameters VP via connection VCL to logon service LS;
logon service LS comprises means first to accept connection VCL from client C, second to receive via connection VCL connection parameters VP from client C and third to send connection parameters VP via connection VA to authorization service AS;
authorization service AS comprises means first to receive connection parameters VP via connection VA from logon service LS, and second to send connection parameters VP together with request A, to connect to connection endpoint VEPC provided by client C, to service S;
service S comprises means first to receive connection parameters VP together with request A via connection VA from authorization service AS and second to build-up in dependence of connection parameters VP a reliable standing logical bidirectional inter thread or inter process communication connection VC to connection endpoint VEPC provided by client C, and
client C comprises means to accept the connection request from service S to connection endpoint VEPC.

53. Network with communication system according to claim 52 comprising at least two different service-, logon- and authorization units, whereby
at least one of the programs logon service LS, authorization service AS or service S are running on a different unit, than the two others of said programs LS, AS and S.

54. Network with communication system according to one of the claims 52 to 53, whereby
i. at least authorization service AS comprises means to access authorization data AD, and
ii. at least client C comprises means to send logon data AMD—after establishment of connection VCL to logon service LS—via connection VCL to logon service LS, and
iii. at least logon service LS comprises means to receive logon data AMD via connection VCL from client C and to send logon data AMD via connection VA to authorization service AS, and
iv. at least authorization service AS comprises means to receive logon data AMD via connection VA from logon service LS and to send request A, to connect to connection endpoint VEPC provided by client C, to service S only after a positive authorization validation of logon data AMD versus authorization data AD.

55. Network with communication system according to claim 54, whereby
i. at least client C comprises means to send at least part TAMD of logon data AMD in an encrypted format via connection VCL to logon service LS, and
ii. at least logon service LS comprises means first to receive part TAMD of logon data AMD via connection VCL from client C and second to send part TAMD of logon data AMD via connection VA to authorization service AS, and
iii. at least authorization service AS comprises means to receive part TAMD of logon data AMD via connection VA from logon service LS and to decrypt said part TAMD.

56. Network with communication system according to one of the claims 52 to 55, whereby
i. at least service S does not know access data ZD to connection endpoint VEPC before build-up of connection VCL between logon service LS and client C, and
ii. at least logon service LS comprises means to send access data ZD via connection VCL to client C, and
iii. at least authorization service AS comprises means to send access data ZD via connection VS to service S, and
iv. at least client C comprises means to receive access data ZD via connection VCL from logon service LS and to provide in dependence of at least one part of access data ZD connection endpoint VEPC for service S, and
v. at least service S comprises means to receive via connection VS access data ZD from authorization service AS and to build-up in dependence of at least one part of access data ZD connection VC to connection endpoint VEPC provided by client C.

57. Network with communication system according to claim 56, whereby
i. at least logon service LS comprises means to create at least one part LTZD of access data ZD, and
ii. at least all participating programs comprise means to transmit part LTZD of access data ZD from logon service LS via connection VCL to client C as well as via connection VA, authorization service AS and connection VS to service S.

58. Network with communication system according to one of the claims 56 to 57, whereby
i. at least authorization service AS comprises means to create at least one part ATZD of access data ZD, and
ii. at least all participating programs comprise means to transmit part ATZD of access data ZD from authorization service AS via connection VS to service S as well as via connection VA, logon service LS and connection VCL to client C.

59. Network with communication system according to one of the claims 56 to 58, whereby
i. at least service S comprises means to create at least one part STZD of access data ZD, and
ii. at least all participating programs comprise means to transmit part STZD of access data ZD from service S via connection VS, authorization service AS, connection VA, logon service LS and connection VCL to client C.

60. Network with communication system according to claim 56 to 59, whereby
i. at least client C comprises means to create at least one part CTZD of access data ZD, and
ii. at least all participating programs comprise means to transmit part CTZD of access data ZD from client C via connection VCL, logon service LS, connection VA, authorization service AS and connection VS to service S.

61. Network with communication system according to one of the claims 56 to 60, whereby
i. at least logon service LS comprises means to select at least one service S, and
ii. at least all participating programs comprise means to transmit within access data ZD at least one physical address PASE of at least one network interface of service S executing service unit SE from logon service LS via connection VCL to client C, such that client C can check said physical address PASE during the build-up of connection VC and can accept connection VC only, if service S builds-up connection VC via the network interface with physical address PASE.

62. Network with communication system according to claims 56 to 61, whereby
i. at least authorization service AS comprises means to select at least one service S, and
ii. at least all participating programs comprise means to transmit within access data ZD at least one physical address PASE of at least one network interface of service S executing service unit SE from authorization service AS via connection VA, logon service LS and connection VCL to client C, such that client C can check said physical address PASE during the build-up of connection VC and can accept connection VC only, if service S builds-up connection VC via the network interface with physical address PASE.

63. Network with communication system according to one of the claims 56 to 62, whereby
i. at least logon service LS comprises means to select at least one local identification LK of at least one connection endpoint VEPC to be provided by client C, and
ii. at least all participating programs comprise means to transmit local identification LK from logon service LS via connection VCL to client C and from logon service LS via connection VA, authorization service AS and connection VS to service S.

64. Network with communication system according to one of the claims 56 to 63, whereby
i. at least authorization service AS comprises means to select at least one local identification LK of at least one connection endpoint VEPC to be provided by client C, and
ii. at least all participating programs comprise means to transmit local identification LK from authorization service AS via connection VS to service S and from authorization service AS via connection VA, logon service LS and connection VCL to client C.

65. Network with communication system according to one of the claims 56 to 64, whereby
i. at least service S comprises means to select at least one local identification LK of at least one connection endpoint VEPC to be provided by client C, and
ii. at least all participating programs comprise means to transmit local identification LK from service S via connection VS, authorization service AS, connection VA, logon service LS and connection VCL to client C.

66. Network with communication system according to one of the claims 56 to 65, whereby
i. at least client C comprises means to select at least one local identification LK of at least one connection endpoint VEPC to be provided by client C, and
ii. at least all participating programs comprise means to transmit local identification LK from client C via connection VCL, logon service LS, connection VA, authorization service AS and connection VS to service S.

67. Network with communication system according to one of the claims 56 to 66, whereby
i. at least logon service LS comprises means to send via connection VCL at least one part VTZD of access data ZD in an encrypted format to client C, and
ii. at least client C comprises means to receive via connection VCL the encrypted part VTZD of access data ZD from logon service LS and to decrypt said part VTZD.

68. Network with communication system according to one of the claims 56 to 67, whereby
i. at least authorization service AS comprises means to send via connection VS at least one part VTZD2 of access data ZD in an encrypted format to service S, and
ii. at least service S comprises means to receive via connection VS the encrypted part VTZD2 of access data ZD from authorization service AS and to decrypt said part VTZD2.

69. Network with communication system according to one of the claims 42 to 51 and 56 to 68, whereby
i. at least client C comprises means to send at least one key ZSC, received within access data ZD, via connection VC to service S, and
ii. at least service S comprises means first to receive said key ZSC via connection VC from client C, second to validate said key ZSC against access data ZD and third to leave client C connected only after a positive result of said validation of key ZSC.

70. Network with communication system according to one of the claims 42 to 51 and 56 to 69, whereby
i. at least service S comprises means to send at least one key ZSS, received within access data ZD, via connection VC to client C, and
ii. at least client C comprises means first to receive said key ZSS via connection VC from service S, second to validate said key ZSS against access data ZD and third to let connection VC to service S remain connected only after a positive result of said validation of key ZSS.

71. Network with communication system according to one of the claims 42 to 51 and 56 to 70, whereby
at least one part of access data ZD is created pseudo or absolutely randomly.

72. Network with communication system according to one of the claims 38 to 71, where at least service S executing service unit SE additionally executes a local firewall LF, and where logon programs LP₁, . . . , LP_{Ip} are exclusively running on logon units LE₁, . . . , LE_{Ie}, and where client programs CP₁, . . . , CP_{cp} are exclusively running on client units CE₁, . . . , CE_{ce}, whereby
local firewall LF allows at most the build-up of at least one connection from service S to at least one of the client programs CP₁, . . . , CP_{cp} as well as the connection oriented bidirectional communication between service S and the connected client programs as well as the build-up of connection VS and the bidirectional communication via connection VS between service S and logon service LS resp. authorization service AS,
local firewall LF in particular blocks all connection less messages send from and to service unit SE as well as all connection build-ups from one of the client units CE₁, . . . , CE_{ce} to service unit SE as well as all connection build-ups from any program running on service unit SE except service S.

73. Network with communication system according to one of the claims 38 to 72, where at least one firewall F is located between service S executing service unit SE and at least client C executing client unit CE of client units CE₁, . . . , CE_{ce}, and where client programs CP₁, . . . , CP_{cp} are exclusively running on client units CE₁, . . . , CE_{ce}, whereby firewall F allows at most the build-up of at least one connection from service S to at least client C as well as the connection oriented bidirectional communication between service S and the connected client programs as well as the build-up of connection VS and the bidirectional communication via connection VS between service S and logon service LS resp. authorization service AS,
firewall F in particular blocks all connection less messages send from and to service unit SE as well as all connection build-ups from one of the client units CE₁, . . . , CE_{ce} to service unit SE as well as all connection build-ups from any program running on service unit SE service S.

74. Network with communication system according to one of the claims 38 to 73, whereby
client C comprises means to provide at least one connection endpoint VEPC for service S only for an arbitrary selectable time interval T, and, if service S does not connect to connection endpoint VEPC within said time interval T, to close connection endpoint VEPC after said time interval T elapsed.

75. Network with communication system according to one of the claims 38 to 74, whereby
after establishment of connection VS to resp. from service S no program running on service unit SE—including service S—provides an open connection endpoint at any time.

76. Network with communication system according to one of the claims 38 to 75, whereby
at least one service S initiates the build-up of connection VS and no program running on service unit SE—including service S—provides an open connection endpoint at any time.

77. Network with communication system according to one of the previous claims, whereby
no program running on service unit SE—including service S—sends connection less messages at any time.

78. Network with communication system according to one of the previous claims, whereby
at least one program running on service unit SE comprises means to block all connection less messages send to service unit SE.

79. Network with communication system according to one of the previous claims, whereby
service S builds-up to resp. accepts from at least one client C of the client programs CP₁, . . . , CP_{cp} at least two reliable standing logical bidirectional inter thread or inter process communication connections VC₁ and VC₂, such that after their establishment both connections VC₁ and VC₂ exist absolutely simultaneously.

80. Network with communication system according to one of the previous claims, whereby
after establishment of at least one connection VC between service S and client C,
i. at least client C comprises means first to send at least one request CA via connection VC to service S and second to wait for at least one result CR via connection VC from service S, and
ii. at least service S comprises means first to wait for at least one request from at least one of the clients connected to service S, second to receive via connection VC at least said request CA from client C, if necessary, to perform a predefined action in dependence of at least request CA, and third to send at least one result CR via connection VC to client C, and
iii. at least client C comprises means to receive at least said result CR via connection VC from service S.

81. Network with communication system according to claim 80, whereby
i. at least one reliable standing logical bidirectional inter thread or inter process communication connection between at least one service S and each client of the client programs CP₁, . . . , CP_{cp} can be established, and
ii. service S comprises means to perform the steps described in claim 80 for each client connected to service S independent of all other clients connected to service S.

82. Network with communication system according to one of the claims 80 to 81, whereby
service S comprises means to repeat the steps described in claim 80 for each client Cᵢ (i integer and 0<i<cp+1) connected to service S independent from all other clients connected to service S until either connection VCᵢ to client Cᵢ breaks or client Cᵢ closes connection VCᵢ or service S closes connection VCᵢ.

83. Network with communication system according to one of the previous claims, additionally comprising an arbitrary number te (te integer and te>0) of treasury units TE₁, . . . , TEₜₑ physically connected via at least one network NT with at least one service unit SE of the service units SE₁, . . . , SEₛₑ, and where treasury units TE₁, . . . , TEₜₑ execute an arbitrary number tp (tp integer and tp>0) of treasury programs TP₁, . . . , TPₜₚ, and where between at least one treasury T of the treasury programs TP₁, . . . , TPₜₚ—running on treasury unit TE—and at least one service S of the service programs SP₁, . . . , SPₛₚ—running on service unit SE—at least one reliable standing logical bidirectional inter process communication connection VT can be established, whereby
after successful establishment of at least one connection VC between service S and client C, and after successful establishment of at least connection VT between service S and treasury T,
i. at least client C comprises means first to send at least one request CA via connection VC to service S and second to wait for at least one result CR via connection VC from service S, and
ii. at least service S comprises means first to wait for at least one request from at least one of the clients connected to service S, second to receive at least request CA from client C via connection VC, third, if necessary, to check request CA and fourth to send request CA in suitable form as at least one request SA via connection VT to treasury T, and fifth to wait for at least one result TR via connection VT from treasury T, and
iii. at least treasury T comprises means first to wait for at least one request of service S connected to treasury T, second to receive at least request SA via connection VT from service S, third, if necessary, to perform in dependence of at least request SA a predefined action, and fourth to send at least one result TR via connection VT to service S, and
iv. at least service S comprises means first to receive at least said result TR via connection VT from treasury T, second, if necessary, to check the result TR and third to send result TR in suitable form as at least one result CR via connection VC to client C, and
v. at least client C comprises means to receive at least said result CR via connection VC from service S.

84. Network with communication system according to claim 83, whereby
i. between at least one service S and each client of the client programs CP₁, . . . , CP_{Ip} at least one reliable standing logical bidirectional inter thread or inter process communication connection can be established, and
ii. service S and treasury T comprise means to perform the steps described in claim 83 for each connected client independent of all other clients connected to service S.

85. Network with communication system according to one of the claims 83 to 84, whereby
service S and treasury T comprise means to repeat the steps described in claim 83 for each client Cᵢ (i integer and 0<i<cp+1) connected to service S independent from all other clients connected to service S until either connection VCᵢ to client Cᵢ breaks, or the connection VT between service S and treasury T breaks, or client Cᵢ closes connection VCᵢ, or treasury T or service S closes connection VT, or service S closes connection VCᵢ.

86. Network with communication system according to one of the claims 83 to 85, where at least one service S1 and at least one treasury T1 comprise means to build-up at least one connection VT1 between service S1 and treasury T1 according to one of the claims 1 to 82, whereby
for the build-up of connection VT1 treasury T1 plays the role of client C and service S1 plays the role of service S.

87. Network with communication system according to one of the claims 83 to 86, where at least one service S2 and at least one treasury T2 comprise means to build-up at least one connection VT2 between service S2 and treasury T2 according to one of the claims 1 to 82, whereby
for the build-up of connection VT2 treasury T2 plays the role of service S and service S2 plays the role of client C.

88. Network with communication system according to one of the claims 83 to 87, whereby
at least one service S comprises means to assign at least one logical identification LKVT to at least one connection to at least one treasury T, so that at least one client C connected to service S can communicate only with the knowledge of said logical identification(s) LKVT indirectly via service S with at least one member of a uniquely by said logical identification(s) LKVT determined group of treasuries.

89. Network with communication system according to one of the claims 83 to 88, whereby
at least one service S comprises means to assign at least one logical identification LKVT to at least one connection of at least one connected treasury T, so that at least one client C connected to service S can communicate only with the knowledge of said logical identification(s) LKVT indirectly via service S with at least one member of a uniquely by said logical identification(s) LKVT determined group of treasury connections.

90. Network with communication system according to one of the claims 83 to 89, whereby
service S comprises means to assign at least one logical identification LKVT uniquely to exactly one connection VT of exactly one treasury T, so that at least one client C connected to service S can communicate only with the knowledge of said logical identification(s) LKVT indirectly via service S with exactly one uniquely determined by said logical identification(s) LKVT connection VT of treasury T.
